(19) United States
(12) Patent Application Publication
(10) Pub. No.: US 2011/0270780 A1
(43) Pub. Date: Nov. 3, 2011

(54) METHODS AND SYSTEMS FOR ASSESSING FINANCIAL PERSONALITY

(76) Inventors: Gregory Bryn Davies, London (GB); Daniel Pollard Egan, London (GB); Peter Brooks, Singapore (SG); Mitchell Cox, Towaco, NJ (US)

(21) Appl. No.: 13/071,415

(22) Filed: Mar. 24, 2011

Related U.S. Application Data
(60) Provisional application No. 61/317,078, filed on Mar. 24, 2010.

(51) Int. Cl. G06Q 40/00

(52) U.S. Cl. 705/36 R

(57) ABSTRACT

One or more aspects comprise a computer system comprising one or more servers that: (a) provide a financial personality assessment questionnaire to a user; and (b) receive data describing said user's responses to one or more questions in said questionnaire; and one or more processors in communication with said one or more servers that: (a) based on said data describing said user's responses, assess said user's investment-related attitudes across a plurality of scales and produce a multi-dimensional financial personality identifier for said user; and (b) construct a user risk profile for said user derived from said multi-dimensional financial personality identifier.

### CROSS REFERENCE TO RELATED APPLICATIONS

This application claims priority to U.S. Provisional Patent Application No. 61/317,078, filed Mar. 24, 2010. The entire contents of that application are incorporated herein by reference.

### INTRODUCTION

Accurately assessing the psychological risk tolerance and financial risk capacity of clients is one of the biggest challenges facing financial institutions. The consequences of not accurately assessing client needs and attitudes to risk have been starkly highlighted in many financial mis-selling cases in recent years.

An exemplary embodiment comprises a “Financial Personality Assessment” (“FPA”) questionnaire that provides a psychometric tool for establishing the degree to which clients are comfortable with financial risk. The responses that a client gives are used to create a risk score that then maps the client into one of several risk profiles—ranging from low risk tolerance to high risk tolerance. Other dimensions of the financial personality can then be considered to create a customized investment recommendation.

This description focuses on risk tolerance, but other dimensions have been and may be developed using the same approach and principles.

Preferably, a risk tolerance score is not affected by other confounding influences, such as the stage of the economic cycle that profiling takes place in or by the personal influence of the advisor. However, this does not exclude the possibility that an investor's risk tolerance could change if the investor's circumstances significantly alter (for example, by the birth of a child).

Research on which one or exemplary embodiments were based comprised testing over 250 questions from an original candidate pool of 450 which had been found in existing academic and industry literature. Great importance was placed on the questions selected to determine risk tolerance. Of particular importance was not confounding risk tolerance with other independent investment objectives, such as the investment time horizon and the knowledge of the investor.

As an example of how including questions on the investor's time horizon can confuse the results, imagine a situation that is fairly common with existing “risk tolerance” questionnaires: the questionnaires consist of a number of questions that relate specifically to risk tolerance, but also include questions that ask about the investor's time horizon, income requirements, liquidity requirements, future investment plans, and responses to future gains or losses. These are then all combined into a single scale, which purports to be a measure of “risk tolerance,” but in fact is a measure that jumbles together all these aspects in proportions that are arbitrarily determined. Using this scale means one loses the ability to actually differentiate between investors.

For example, one investor may have high risk tolerance, but a very short time horizon, and would therefore come out looking ‘Moderate’ on one of these scales. A very different investor may have low risk tolerance, but a very long time horizon—this investor would also have a resulting score of ‘Moderate’. Clearly, these scales are not a measure of risk tolerance, but of some complex construction which is both difficult to interpret and glosses over highly important distinctions between different investors. An exemplary embodiment is based on psychometric techniques that ensure that scales measure pure psychological traits and do not confound independent factors. The complete profile enables a view of the investor that encompasses the important aspects of the investor's financial personality and investment objectives, but retains the ability to distinguish between each of these independently.

Existing internal and external risk tolerance questionnaires also often confound investment time horizon with risk tolerance within individual questions, which makes them complex, lengthy, and difficult to answer. A risk tolerance questionnaire used in an exemplary embodiment aims to remove these confounds and create a pure and objective risk tolerance measure. It is also possible that confounding risk tolerance with time horizon will bias responses. Imagine an investor who is willing to take on some risk being presented with the following question:
Think of the average rate of return you would expect to earn on an investment portfolio over the next ten years. How does this compare with what you think you would earn if you invested the money in bank deposits?

Now consider the same investor receiving the same question, except that the time frame is now the next five years. This subtle change in the question could completely change the response of the investor.

Also consider two investors with the same psychological tolerance to risk are presented with this question. The only difference between the investors is that one has experienced a fall in their portfolio value and the other a gain over the past two years. Do they both give the same response? Probably not. The investor that suffered falls is likely to appear much more cautious. It is likely that these investors would receive vastly different investments even though their tolerance to risk is the same. This problem is created because the question allows many external thoughts and experiences to influence the response. The questions preferably used in an exemplary embodiment do not have this problem because they do not refer to current market conditions, or to respondents' beliefs about future market performance.

Questions used in an exemplary embodiment were designed to be non-numeric, simple, non-confounding, to not refer to specific investments or instruments, and to not refer to market conditions. It is important to avoid questions that place numerical demands on individuals because different levels of numeracy can bias the responses. Questions that refer to specific investment types and market conditions are susceptible to biases caused by differences between individuals' knowledge, past experiences, or current media coverage. If an investor has no knowledge of Treasury Bills, then they will not understand the risks and returns associated with them. By avoiding these pitfalls, one can develop a scale that measures only risk tolerance and not any interactions with knowledge, past experiences or media bias.

A risk tolerance scale of an exemplary embodiment preferably is developed using large representative populations so that one can consistently match clients and products.

An exemplary embodiment comprises a financial personality assessment tool that: (a) uses a risk tolerance measurement that is efficient, discriminating, and stable across time and market cycles, and (b) reveals a plurality of distinct financial personality traits. A particular exemplary embodiment has more than 16,000 unique profile outcomes, is based on nine research-driven surveys; has been calibrated on over 4,000 individuals from the UK and Asia; and is based on a theoretically and statistically robust analysis of over 450 candidate questions.

An exemplary embodiment comprises a psychometric tool for establishing, along with other financial personality traits, a degree to which potential investors are comfortable taking on higher financial risk in exchange for higher expected returns. Responses are used to create, inter alta, a risk tolerance score that then maps the potential investor into one of a plurality of risk profiles. Questions used to create the score (and profile) are the product of extensive research. The questionnaire represents the latest in psychometric analysis, behavioral decision-making, and client profiling, resulting in an industry-leading tool that provides consistent, accurate, and precise information about risk tolerance and other financial personality traits.

An exemplary embodiment uses questionnaire responses and innovative analysis techniques to create one or more financial personality profile reports. A report sent to a financial advisor may be used (typically with other information) to create a recommended portfolio allocation for the subject of the questionnaire.

An exemplary embodiment provides a thorough, high-resolution personality assessment that identifies a subject's individuality on six dimensions relevant to financial decision-making. This assessment is then matched with a set of investment opportunities to create a recommended investment strategy for the subject. The result is a customized investment portfolio designed to produce performance that matches the subject's financial goals and personality.

Software used in an exemplary embodiment considers the diverse characteristics of a subject's financial situation and objectives, including, for example, liquidity needs, planned withdrawals, income requirements, and tax considerations. The goal is to recommend a portfolio that the subject will be comfortable with both in the short and long term, and that rewards the subject for taking the appropriate amount of risk given the subject's investment philosophy.

One or more aspects comprise a computer system comprising one or more servers that: (a) provide a financial personality assessment questionnaire to a user; and (b) receive data describing said user's responses to one or more questions in said questionnaire; and one or more processors in communication with said one or more servers that: (a) based on said data describing said user's responses, assess said user's investment-related attitudes across a plurality of scales and produce a multi-dimensional financial personality identifier for said user; and (b) construct a user risk profile for said user derived from said multi-dimensional financial personality identifier.

In various embodiments: (1) constructing said user risk profile comprises mapping said user to one of a plurality of profiles; (2) said one or more processors further adjust said user risk profile, based on said user's current financial circumstances; (3) said adjusting further comprises analyzing factors comprising one or more of: income, expenditures, externally held wealth, or liabilities; (4) said one or more processors adjust a portfolio risk profile for an investment portfolio of said user, based on said user risk profile; (5) said one or more processors generate a financial personality assessment report based on said user risk profile; (6) said financial personality assessment report comprises one or more single dimension texts and one or more interaction texts; (7) said financial personality assessment report further comprises one or more distinguishing features texts, said one or more distinguishing features texts based on all dimension scores; (8) said plurality of scales comprises risk tolerance and one or more of: composure, market engagement, perceived financial expertise, delegation, or belief in skill; and (9) each scale in said plurality of scales is associated with a corresponding subset of said questions.

One or more aspects comprise a system comprising one or more servers that receive and store data describing responses to a plurality of questionnaire questions related to risk tolerance; and one or more processors that: (a) identify, in said data, one or more personality dimensions related to financial personality, said one or more personality dimensions comprising a risk tolerance dimension; (b) identify a first subset of said plurality of questionnaire questions related to risk tolerance as being associated with said risk tolerance dimension; (c) identify a second subset of said plurality of questionnaire questions, which is a subset of said first subset, and which has a similar predictive power as said first subset; and (d) construct, with said processing system, a questionnaire comprising said second subset of said plurality of questionnaire questions.

In an embodiment, said one or more servers: provide said questionnaire to a user; and receive data describing said user's responses to one or more questions in said questionnaire; and said one or more processors: based on said data describing said user's responses, assess said user's investment-related attitudes across a plurality of scales and produce a multi-dimensional financial personality identifier for said user; and construct a user risk profile for said user derived from said multi-dimensional financial personality identifier.

One or more aspects comprise a system comprising one or more servers that: receive data describing a user risk profile for a user, said user risk profile derived from a multi-dimensional financial personality identifier; and receive data describing financial circumstances and investment objectives of said user; and one or more processors that: calculate a portfolio risk profile for a current investment portfolio of said user; calculate a recommended risk profile for said portfolio, based at least in part on said financial circumstances and investment objectives and on said user risk profile derived from said multidimensional financial personality identifier; and construct a portfolio allocation recommendation based on said recommended risk profile for said portfolio.

One or more aspects comprise an article of manufacture storing software in a non-transitory computer readable medium, said software configured to direct one or more processors to perform at least the following steps: providing a financial personality assessment questionnaire to a user; receiving data describing said user's responses to one or more questions in said questionnaire; based on said data describing said user's responses, assessing with a processing system said user's investment-related attitudes across a plurality of scales and producing a multi-dimensional financial personality identifier for said user; and constructing, with said processing system, a user risk profile for said user derived from said multi-dimensional financial personality identifier; wherein said processing system comprises one or more processors.

In various embodiments: (1) constructing said user risk profile comprises mapping said user to one of a plurality of profiles; (2) the article of manufacture further comprises software for adjusting said user risk profile, based on said user's current financial circumstances; (3) said step of adjusting further comprises analyzing factors comprising one or more of: income, expenditures, externally held wealth, or liabilities; (4) the article of manufacture further comprises software for adjusting a portfolio risk profile for an investment portfolio of said user, based on said user risk profile; (5) the article of manufacture further comprises software for generating, with said processing system, a financial personality assessment report based on said user risk profile; (6) said financial personality assessment report comprises one or more single dimension texts and one or more interaction texts; (7) said financial personality assessment report further comprises one or more distinguishing features texts, said one or more distinguishing features texts based on all dimension scores; (8) said plurality of scales comprises risk tolerance and one or more of: composure, market engagement, perceived financial expertise, delegation, or belief in skill; and (9) each scale in said plurality of scales is associated with a corresponding subset of said questions.

One or more aspects comprise an article of manufacture storing software in a non-transitory computer readable medium, said software configured to direct one or more processors to perform at least the following steps: receiving and storing data describing responses to a plurality of questionnaire questions related to risk tolerance; identifying, with a processing system, in said data, one or more personality dimensions related to financial personality, said one or more personality dimensions comprising a risk tolerance dimension; identifying a first subset of said plurality of questionnaire questions related to risk tolerance as being associated with said risk tolerance dimension; identifying a second subset of said plurality of questionnaire questions, which is a subset of said first subset, and which has a similar predictive power as said first subset; and constructing, with said processing system, a questionnaire comprising said second subset of said plurality of questionnaire questions.

In an embodiment, the article of manufacture further comprises software for: providing said questionnaire to a user; receiving data describing said user's responses to one or more questions in said questionnaire; based on said data describing said user's responses, assessing with a processing system said user's investment-related attitudes across a plurality of scales and producing a multi-dimensional financial personality identifier for said user; and constructing, with said processing system, a user risk profile for said user derived from said multi-dimensional financial personality identifier.

One or more aspects comprise an article of manufacture storing software in a non-transitory computer readable medium, said software configured to direct one or more processors to perform at least the following steps: receiving data describing a user risk profile for a user, said user risk profile derived from a multi-dimensional financial personality identifier; receiving data describing financial circumstances and investment objectives of said user; calculating with a processing system a portfolio risk profile for a current investment portfolio of said user; calculating with said processing system a recommended risk profile for said portfolio, based at least in part on said financial circumstances and investment objectives and on said user risk profile derived from said multidimensional financial personality identifier; and constructing a portfolio allocation recommendation based on said recommended risk profile for said portfolio.

One or more aspects comprise a method comprising: providing a financial personality assessment questionnaire to a user; receiving data describing said user's responses to one or more questions in said questionnaire; based on said data describing said user's responses, assessing with a processing system said user's investment-related attitudes across a plurality of scales and producing a multi-dimensional financial personality identifier for said user; and constructing, with said processing system, a user risk profile for said user derived from said multi-dimensional financial personality identifier; wherein said processing system comprises one or more processors.

In various embodiments: (1) constructing said user risk profile comprises mapping said user to one of a plurality of profiles; (2) the method further comprises adjusting said user risk profile, based on said user's current financial circumstances; (3) said step of adjusting further comprises analyzing factors comprising one or more of: income, expenditures, externally held wealth, or liabilities; (4) the method further comprises adjusting a portfolio risk profile for an investment portfolio of said user, based on said user risk profile; (5) the method further comprises generating, with said processing system, a financial personality assessment report based on said user risk profile; (6) said financial personality assessment report comprises one or more single dimension texts and one or more interaction texts; (7) said financial personality assessment report further comprises one or more distinguishing features texts, said one or more distinguishing features texts based on all dimension scores; (8) said plurality of scales comprises risk tolerance and one or more of: composure, market engagement, perceived financial expertise, delegation, or belief in skill; and (9) each scale in said plurality of scales is associated with a corresponding subset of said questions.

One or more aspects comprise a method comprising: receiving and storing data describing responses to a plurality of questionnaire questions related to risk tolerance; identifying, with a processing system, in said data, one or more personality dimensions related to financial personality, said one or more personality dimensions comprising a risk tolerance dimension; identifying a first subset of said plurality of questionnaire questions related to risk tolerance as being associated with said risk tolerance dimension; identifying a second subset of said plurality of questionnaire questions, which is a subset of said first subset, and which has a similar predictive power as said first subset; and constructing, with said processing system, a questionnaire comprising said second subset of said plurality of questionnaire questions; wherein said processing system comprises one or more processors.

In an embodiment, the method further comprises: providing said questionnaire to a user; receiving data describing said user's responses to one or more questions in said questionnaire; based on said data describing said user's responses, assessing with a processing system said user's investment-related attitudes across a plurality of scales and producing a multi-dimensional financial personality identifier for said user; and constructing, with said processing system, a user risk profile for said user derived from said multi-dimensional financial personality identifier.

One or more aspects comprise a method comprising: receiving data describing a user risk profile for a user, said user risk profile derived from a multi-dimensional financial personality identifier; receiving data describing financial circumstances and investment objectives of said user; calculating with a processing system a portfolio risk profile for a current investment portfolio of said user; calculating with said processing system a recommended risk profile for said portfolio, based at least in part on said financial circumstances and investment objectives and on said user risk profile derived from said multidimensional financial personality identifier; and constructing a portfolio allocation recommendation based on said recommended risk profile for said portfolio; wherein said processing system comprises one or more processors.

### BRIEF DESCRIPTION OF THE DRAWINGS

FIG. 1 depicts an exemplary distribution of risk tolerance data obtained using industry standard questionnaires.

FIG. 2 depicts an exemplary distribution of risk tolerance data obtained using an exemplary embodiment.

FIG. 3 depicts an exemplary distribution of risk tolerance data obtained using industry standard questionnaires.

FIG. 4 depicts an exemplary distribution of risk tolerance data obtained using an exemplary embodiment.

FIG. 5 depicts stability over time of risk tolerance measurements of an exemplary embodiment.

FIG. 6 depicts stability with respect to market conditions of risk tolerance measurements of an exemplary embodiment.

FIGS. 7 and 8 depict exemplary charts that may be used to adjust a risk profile for a client.

FIG. 9 depicts an exemplary effect of varying risk tolerance thresholds.

FIG. 10 depicts data regarding an absolute portfolio proportion of a sample population.

FIG. 11 depicts exemplary effects of various traits on absolute allocation.

FIG. 12 depicts an exemplary computer system used in connection with one or more aspects and embodiments.

FIGS. 13-19 depict exemplary pages of a first exemplary questionnaire that may be used in connection with one or more aspects and embodiments.

FIGS. 20 and 21 depict exemplary pages of a second exemplary questionnaire.

FIG. 22 depicts an exemplary personality profile diagram.

### DETAILED DESCRIPTION OF CERTAIN EXEMPLARY EMBODIMENTS

A specific exemplary embodiment uses a Risk Tolerance measurement which is efficient; discriminating; stable across time and market cycles; reveals six distinct Financial Personality Traits; has more than 16,000 unique profile outcomes; is based on nine research-driven surveys over the course of a year; is calibrated on over 4,000 individuals from the UK and Asia; is based on theoretically and statistically robust analysis of over 450 candidate questions; and complements a complete review of industry and academic profiling tools and literature.

Nine surveys sampling over 4,000 individuals creating a demographically representative population, with emphasis on the wealthy. Candidate questions comprised 450 questions from academia and the finance industry. Questions had to be: easy to answer (preferably no dual clause statements, no numerical calculations, no probabilities, and no hypothetical options); statistically valid (preferably full response scale used, creates meaningful traits. intuitive interpretation, and differentiates individuals). Eventually 44 questions forming 6 Financial Personality Traits & Investment Objectives were selected, for this exemplary embodiment.

A Risk Tolerance Scale was constructed to be a major improvement over existing tools. One goal was to have a Risk Tolerance scale that discriminated consistently and clearly between low and high risk tolerance individuals. When a scale does not discriminate well, it implies that it is not measuring a coherent underlying trait on which individuals differ.

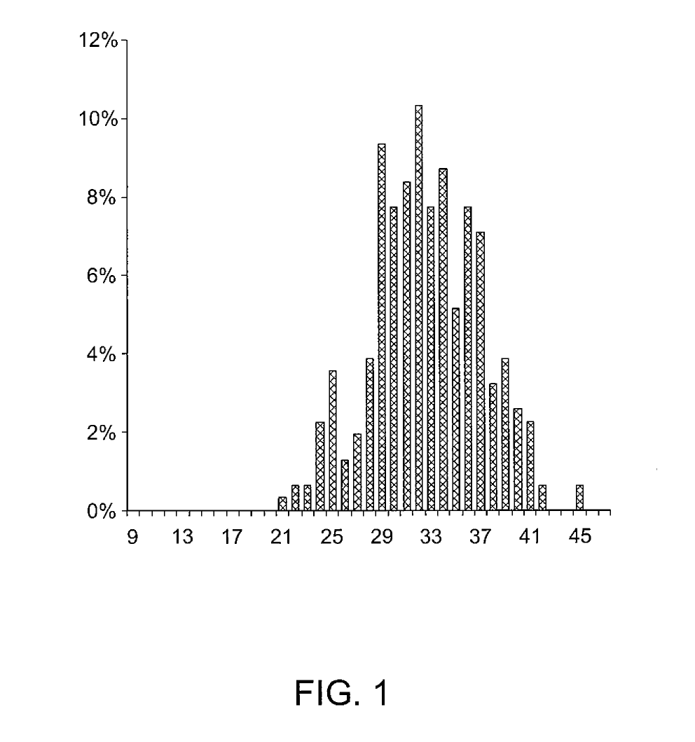

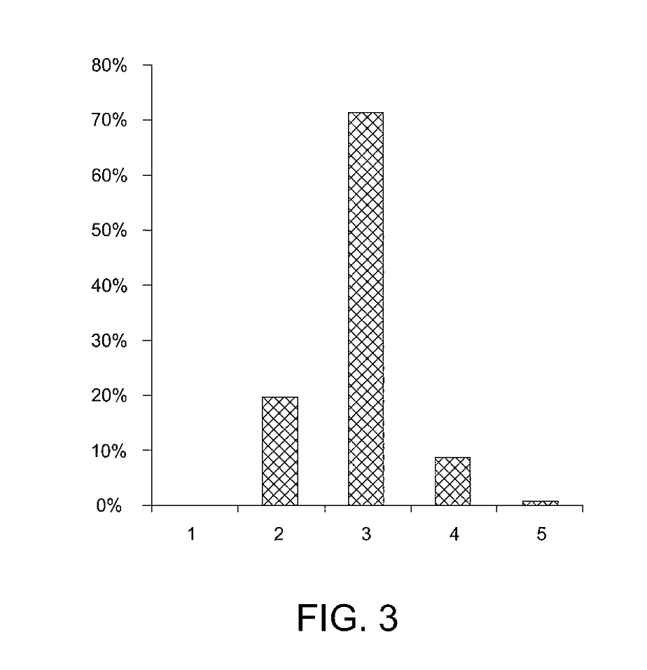

Industry standard questionnaires do a poor job of discriminating between individuals. The result is a centralized distribution with the extremes of the scale unused (see FIGS. 1 and 3).

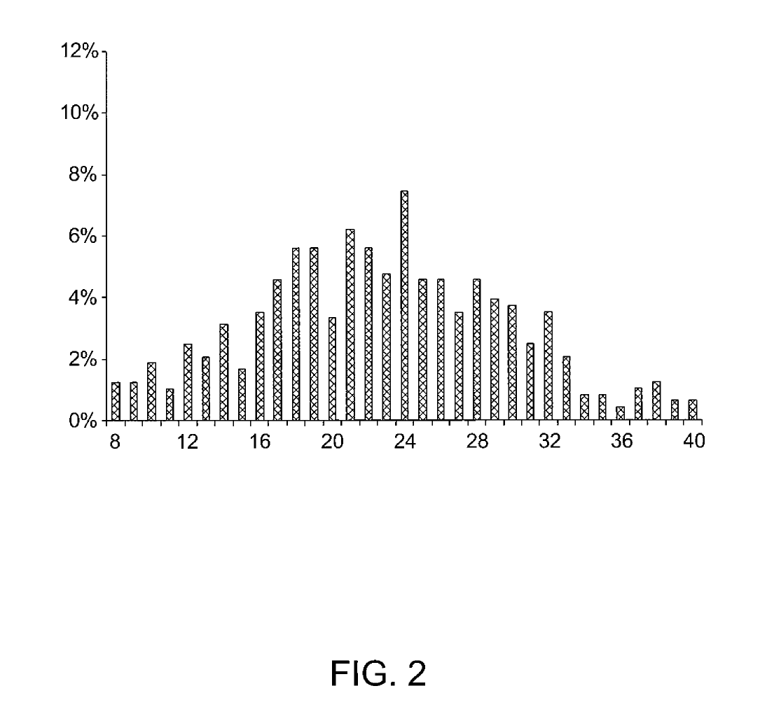

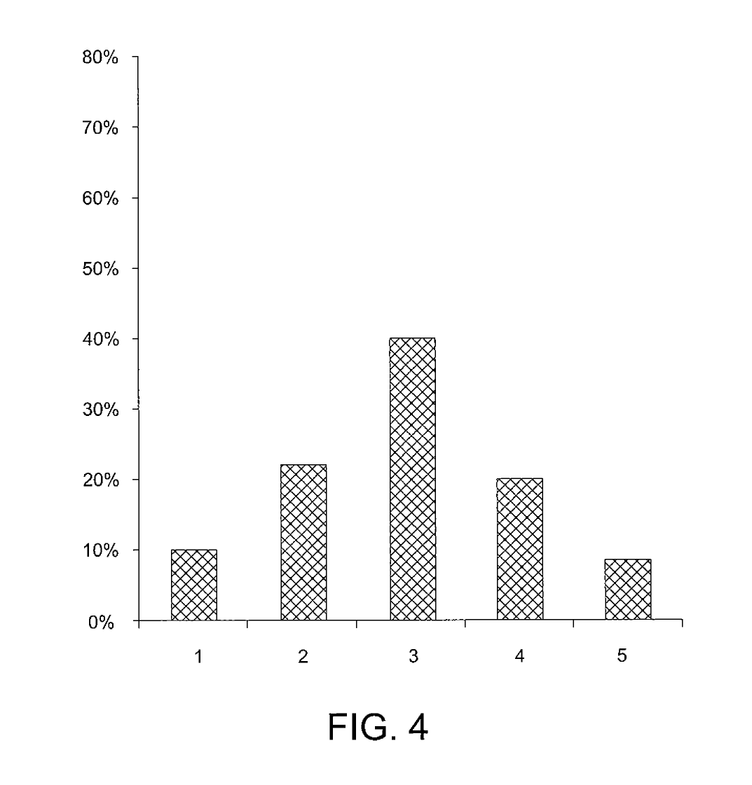

An exemplary embodiment uses a scale that has individuals in both highest and lowest profiles, indicating useful differentiation (see FIGS. 2 and 4).

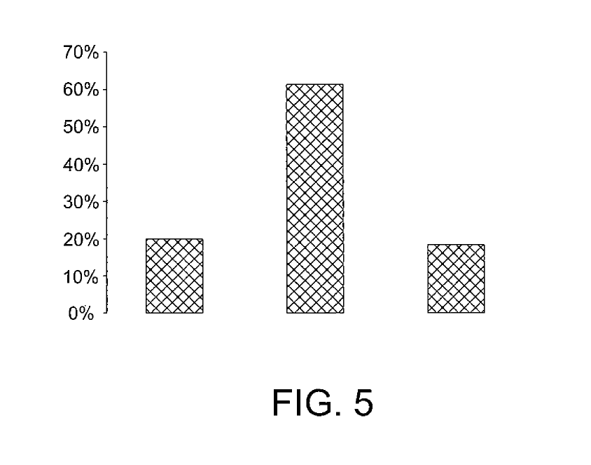

Risk Tolerance measurements may have some natural variance in them, but good Risk Tolerance scales are stable over time, and through market conditions. The scales of this embodiment performed extremely well, being stable both across time and changing market conditions. This implies measuring of a real underlying trait, rather than mood or sentiment. See FIG. 5. 62% of the sample had no change in their allocated Risk Profile over 4 months. No changes of more than 1 Profile. The majority who changed profiles in the second round were within 3 points of the profile boundary in the first round.

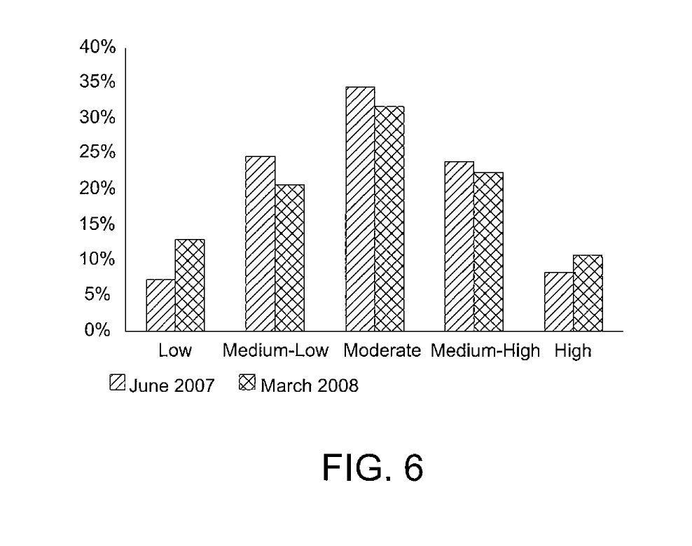

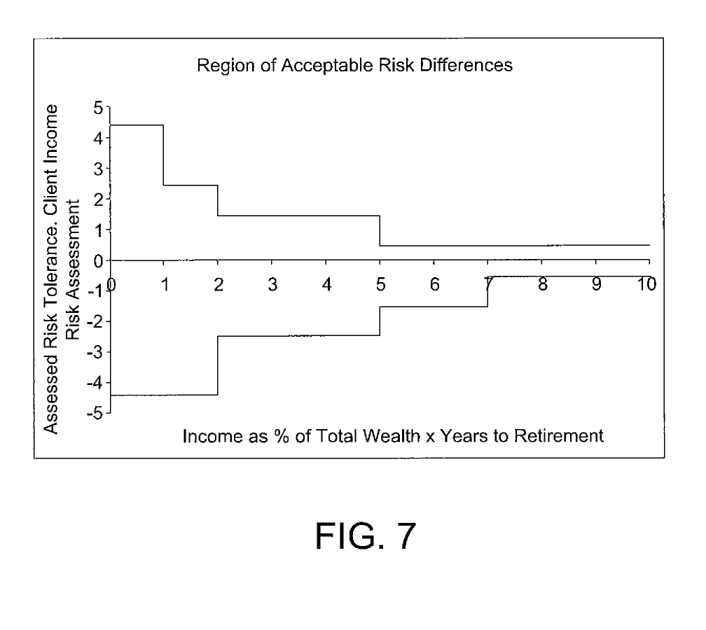

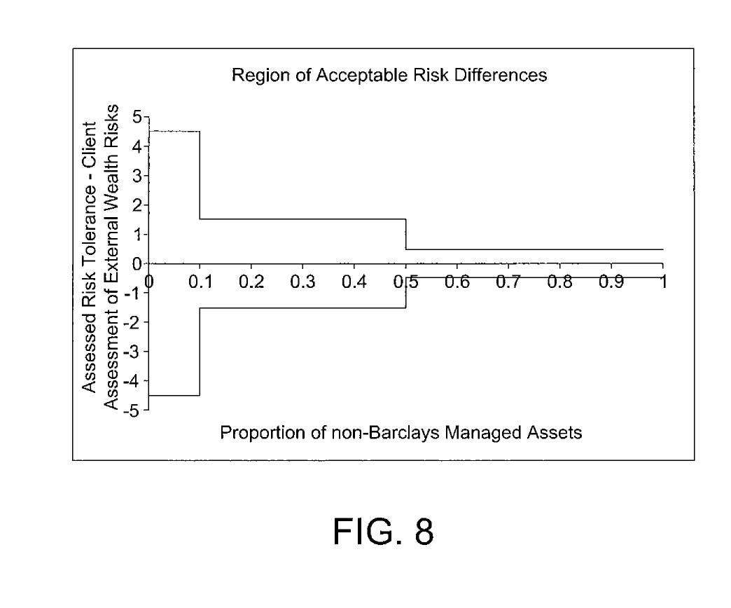

See FIG. 6. The downturn in markets in early 2008 allowed for testing the scale's sensitivity to market conditions. There was only a minor increase of 1.9% in the “Low” and “Medium-Low” Risk” profiles from June 2007.

More generally, a risk tolerance questionnaire of one or more exemplary embodiments is a psychometric tool for establishing the degree to which clients are comfortable taking on higher financial risk in exchange for higher expected returns. The responses that a client gives are used to create a risk tolerance score that then maps the client into one of several risk profiles (in some embodiments, five risk profiles). The questions which are used to create the score (and profile) are preferably the product of extensive research. The questionnaire preferably reflects the latest thinking in psychometric analysis, behavioral decision making, and client profiling, resulting in an industry leading-tool which provides consistent, accurate and precise information about clients' preferences. This section provides a short overview of an exemplary analysis which may be used to derive a Risk Tolerance Assessment scale.

As explained above, the vast majority of financial industry risk tolerance questionnaires are designed with little practitioner knowledge of behavioral decision theory. They frequently suffer from strong context effects, poor discrimination, and significant response imprecision. In addition, these questionnaires often conflate multiple risk-related dimensions into a single dimension risk tolerance score, ignoring the multi-dimensional complexity underpinning attitudes to investment performance. Typical questionnaires often confuse attitudes to risk and time, investment goals and objectives, financial expertise, aspiration levels and many other subtle aspects of financial attitudes. An embodiment preferably is based on exhaustive research resulting in a risk tolerance assessment free of these problems, which can be used to measure risk tolerance reliably.

One goal is to create a good profiling tool free of confounding factors. Good profiling tools are reasonable, reliable and differentiating. A profiling tool is reasonable if it is focused on the underlying psychological dimension and does not require any specialist knowledge to answer. The scale is reliable if the same person would receive the same profile when profiled on different occasions by different advisors. Finally, it is important that the scale is differentiating amongst the population. There is no benefit to a profiling tool that places all clients into a subset of the possible profile groups, leaving some profiles empty. Furthermore, extensive effort should be put into refining the questions to be intuitive to answer, and for the resulting scale to produce consistent results for the same individuals through time.

Research that led to a questionnaire used in one embodiment consisted of three large-scale surveys, conducted between March and June 2007, with roughly 1,500 individuals producing a representative sample of the UK population. The initial survey examined an exhaustive collection of 450 candidate questions from internal and external risk tolerance questionnaires and academic studies. Over 250 questions were tested and importance was placed on the questions selected to determine risk tolerance. Many direct portfolio choice and gambling tasks were included. These questions typically form the basis of many industry-standard financial risk questionnaires.

The first step was to reveal the inherent personality dimensions in the data. This exemplary embodiment relied on a technique called factor analysis to reveal eight personality dimensions, six of which were relevant for an individual's Financial Personality, including risk tolerance. This provided an encompassing list of 24 questions which systematically were associated with the risk tolerance dimension.

Each question was then evaluated for how well it worked independently and in tandem with other questions to produce a consistent, clean, and discriminating risk tolerance scale. The final eight questions were found to have 97% of the predictive power of the full 24 risk tolerance questions, and were as fully differentiating between individuals.

Following feedback on the initial launch of the FPA tool, a calibration exercise was conducted with representative samples from UK, Singapore, Hong Kong, Taiwan, China, Japan, and India. The FPA questions performed well globally.

The risk tolerance scale is highly fit for purpose. It has roughly normal distribution with significant numbers of individuals falling into each of the lower and upper ends. Technical tests of its discriminating ability indicate that it is high. The questions are all clear and intuitive to answer, and free of confounding aspects.

Also assessed was the stability of the scale through time, re-sampling a number of individuals after four months. Their scores were found to have changed on average within three points, or less than 10%. Statistical tests confirmed that the change was due to small statistical noise, not consistent changes. In addition, a further follow up survey in March 2008 confirmed that the scale is stable over the market cycle. The scale stability has subsequently been shown for all FPA dimensions in collected client data through 2008-9.

Survey questions of this embodiment employed a 5-point scale (‘strongly agree’ to ‘strongly disagree’) with a mid-point denoted ‘neither agree nor disagree.’ The following guidelines were followed:
No financial knowledge required
No quantitative or probabilistic reasoning and calculation required
No reference to market conditions
Simple language to facilitate ease of understanding
Absence of confounding influences
Avoiding multiple clauses in statements wherever possible
Exclusion of statements where (dis)agreement could be felt to be socially desirable

Analytic Approach

Three surveys were conducted to develop this exemplary financial personality questionnaire. A wide range of potential candidate questions were collected from internal and external risk tolerance questionnaires and academic studies.¹ Each of these questions were carefully examined to see whether any could be reworded for simplification or to reduce the influence of any confounding factors, such as time horizons. ¹Questions were used from Grable and Lytton (1999), Kapteyn and Teppa (2002), Weber, Blais and Betz (2002), Dorn and Huberman (2005) and Otto, Davies and Chater (2007).

It is important to note that many direct portfolio choice and gambling tasks were included. These questions typically form the basis of many financial risk questionnaires. However, they are not routinely free from the confounding influences discussed above. The example below is a typical kind of direct portfolio choice task. The question is looking for an explicit risk/return trade-off.
The table below shows the possible final values of £100,000 in five example portfolios for the long term (20 years), where portfolio income has been reinvested. Which of the following portfolios would you prefer?

TABLE 1

| | | Potential decline in | |
|---|---|---|---|
| | Potential value of | any single year | Number of years with |
| | £100,000 after 20 | during the same | negative returns during |
| | years | period | the same period |
| A | £220,000 | 3% | 2 |
| B | £280,000 | 8% | 3 |
| C | £320,000 | 12% | 4 |
| D | £360,000 | 16% | 5 |
| E | £410,000 | 27% | 6 |

Trade-offs on three dimensions (reward, downside risk and time) are particularly difficult for individuals. Questions similar to this did not perform well in the analysis. It is relatively easy to show that individuals often find it impossible to express the level of risk that they find comfortable in either percentage or currency terms, partly because this becomes a test of numeracy.

In an exemplary embodiment, respondents were recruited through an external market research vendor. The survey captured demographic information on each respondent that included their gross annual income and an estimate of their total wealth. It was deemed important to use a broad pool of respondents. One goal was to measure stable and fundamental psychological traits, and basic psychological dimensions would not be expected to differ between different groups of people. What may differ, however, is the spread of people across the dimension. To have a good understanding of the full range of personality types, one needs to develop scales on the broader population. In this embodiment, scales were developed based on a UK population and validated with representative population samples in Singapore, Hong Kong, Taiwan, China, Japan, and India. analysis. This is a known technique that is used in the analysis of large datasets. The analysis looks for groups of questions that represent a stable underlying attribute. Two questions would be grouped together if observing a particular response in one question would often lead to observing a particular response in another. Consider the two statements below that form part of a psychological excitement seeking factor. Responding with an agreement in one is likely to lead to an agreement in the other.
I seek action.
I act wild and crazy.

The close interrelation of these questions means that they would group together in factor analysis. There is no limit to the number of questions that can be grouped together. This allows for an examination of the relationships between groups of questions. It is then up to the researcher to interpret the underlying psychological trait that is expressed by each group of questions. This permits a reduction in the question set which helps to reduce the noise in the data and allows the analysis to produce strong independent dimensions.^{2 3} ² Exploratory Factor Analysis—book manuscript by Ledyard R. Tucker and Robert C. MacCallum.³ Costello, Anna B. and Jason W. Osborne (2005), “Best practices in Exploratory Factor Analysis: Four Recommendations for Getting the Most From Your Analysis,” Practical Assessment, Research & Evaluation, ISSN 1531-7714.

In addition to the factor analysis, the distributions of responses on each question were examined. Primarily this was to check that all of the possible responses are seen within the population and that the overall distributions of responses are reasonable.

Surveys
Four surveys (1, 2, 3, and 4)
Over 5000 respondents
Majority of respondents with declared gross annual income above £50,000 (or equivalent local income that places them in the top 10% of local earners
Over 250 questions investigated

The set of potential questions was refined through Surveys 1 (180 questions with 890 respondents) and 2 (100 questions with 789 respondents) so that a fairly concise set of candidate questions could be analyzed in Survey 3 (60 questions with 420 respondents). Survey 4 was a calibration exercise (90 questions with approximately 400 respondents in each of UK, Hong Kong, Singapore, Japan, China, Taiwan, and India). In each of the surveys the strongest factor could be interpreted as risk tolerance. For Survey 3 the final solution contained seven stable and interpretable factors. From this eight questions were selected to form a risk tolerance scale. The results of Survey 4 meant that 2 questions in the Risk Tolerance scale were switched (these were also questions disliked by European bankers). Other scales were unaffected other than to reduce the number of questions needed to get a stable measurement.

Risk Tolerance Questions

These eight questions formed a final psychometric scale of risk:
1. I am willing to risk a significant amount of my investable wealth in order to get a good return.
2. I enjoy making speculative investments in specific assets with portions of my wealth.
3. Even if I experienced a significant loss on an investment, I would still consider making risky investments.
4. Compared to other people I am prepared to take higher financial risks.
5. I have invested a large sum in a risky investment for the excitement of seeing whether it went up or down in value.
6. In order to achieve high returns I am willing to choose high risk investments.
7. I am a financial risk taker.
8. It is likely I would invest a significant sum in a high risk investment.

The eight questions that make up this exemplary psychometric risk tolerance scale look very similar when taken at face value. However, closer examination reveals the subtleties of these questions and that they can be placed into one of three sub-categories: risk/return trade-off, risk self-perception, and risky behaviors.

Risk Return Trade-Off Questions
I am willing to risk a significant amount of my investable wealth in order to get a good return.
In order to achieve high returns I am willing to choose high-risk investments.
I enjoy making speculative investments in specific assets with portions of my wealth.

Risk Self-Perception
Compared to other people I know, I am prepared to take higher financial risks.
I am a financial risk taker.

Risky Behaviors
I have invested a large sum in a risky investment for the excitement of seeing whether it went up or down in value.
Even if I experienced a significant loss on an investment, I would still consider making risky investments.
It is likely I would invest a significant sum in a high-risk investment.

Having more than one question in each of these sub-categories of risk tolerance allows for greater confidence in one's ability to reliably measure facets of a client's risk attitude. However, it should be noted that these questions do not confound investment time horizon or investment knowledge and as such constitute a pure risk tolerance scale. Survey consistency checks

In addition to the survey development used in this exemplary embodiment, a number of consistency checks were conducted upon the final question set, including a test of a single group of respondents answering the questions with a two month break in between. These showed that the risk tolerance scale passes standard tests of reliability and also tests on the concentration of scores.

One important question regarding the robustness of the personality measures is their sensitivity to the market cycle. Although, as described above, the questions preferably are designed to avoid specific references to current market conditions, or to respondents' belief about future market movements, it would nonetheless be reassuring to also have evidence that this stability is in fact the case. The development surveys mentioned above were all run between March and June 2007 in a period of generally benign and stable market conditions. The period of sub-prime crisis, equity market decline and greatly increased volatility that followed allowed for testing the stability of these scales under the most stringent conditions.

As part of a calibration exercise to determine how well the risk tolerance and other personality scales performed in Asian cultures, the full set of psychometric questions was rerun on an equivalent UK data set to those on which the scales were originally developed. The results were highly encouraging. The concern was that, even with market independent questions, the general bearish sentiment in the market would cause risk tolerance scores to be significantly depressed relative to the original distribution.

FIG. 6 shows that this was not the case. The distributions from June 2007 and March 2008 are highly similar. In addition, insofar as the distribution changed following the market downturn, this change does not consist in a reduction of risk tolerance across the board. Instead it appears that there is a slight shift towards both extremes—the extreme market conditions may have induced some previously moderate risk tolerance individuals to answer the questionnaire more tentatively, but also induced others to respond more aggressively. In either case, the changes are quite modest given the significance of the interim market upheaval.

Exemplary Risk Tolerance Profiles

In one or more exemplary embodiments, a psychological risk tolerance measure is an expression of the long term trade-off between risk and return in a portfolio. Higher risk tolerance indicates a higher risk, higher return portfolio, while low risk tolerance leads to a lower risk, lower return solution.

An exemplary psychological risk tolerance measure is an expression of the average level of returns required to make the customer comfortable with taking on the chance of future losses in the customer's portfolio. Whilst it is a natural instinct to avoid the possibility of something bad happening, a customer might be willing to take on more risk if the expected gains are higher. It is how the customer reconciles these two desires—the customer's desire to avoid losses and desire for gains—and how the customer trades them off that is measured by assessing the customer's risk tolerance.

Individuals with high risk tolerance are more likely to accept the possibility of losing some of their wealth so that they can access the types of investments which might also achieve very high returns. People with a low score on this scale are much more likely to be conservative in their trade-off between potential gains and losses. They will accept smaller potential gains so they can be confident of not losing a significant portion of their wealth—they sacrifice the chance of extremely high returns in exchange for secure and stable returns.

A customer's risk tolerance score indicates which goal it is rational for the customer to pursue for the long-run optimization of the customer's Investment Portfolio.

This provides guidance on how to construct a portfolio of assets on the customer's behalf that, at the end of the customer's investment horizon, will deliver to the customer the best possible expected returns, subject to the amount of psychological risk the customer is naturally comfortable with taking on.

It is important to note that the customer's risk tolerance score describes the customer's overall psychological tolerance to risk and is not specific to the assets the customer hold or plans to hold with Barclays Wealth. Customers may hold assets elsewhere which are more risky than their risk tolerance profile, or they may already be taking on financial risk in their day-today business or entrepreneurial activities. Conversely they may already be holding a large portion of their wealth in very safe assets and intend to keep it there, or they may have a very stable business income or salary for many years to come. When customers' investments are optimized, the risk characteristics are considered of the assets they hold with the broker/advisor and those they hold elsewhere, as well as their income stability. This means when investments are made for the customer, some assets may need to be placed above or below the customer's risk tolerance. This is appropriate in creating an overall portfolio to deliver the maximum potential returns for the customer's tolerance to risk.

These are exemplary definitions of risk profiles:

Low (Profile 1):

You are uncomfortable with investments which may put you at risk of losing money and spending power, and will accept a lower return over the long-term in exchange for minimizing the chance of negative outcomes. This does not mean you wish to stay away from market investments altogether or to hold your wealth solely in cash deposits. You may be happy to participate in the financial markets (see your score on the market engagement scale) but you have a strong preference for these investments to be carefully controlled with fairly certain future outcomes. You evaluate investments largely by how safe your money is and by the predictability of future returns. In particular you are keen to avoid any possibility of significant losses to the spending power of your capital and are comfortable this means your long-term level of return is unlikely to be very much higher than that offered by a bank savings account. But with rates of return this low there is a possibility that your wealth may not maintain its spending power due to inflation.

Medium-Low (Profile 2):

You are likely to be comfortable with making investments which may have limited potential for losses in exchange for higher returns. You want better returns than those offered by a bank or building society savings account and are prepared to put a part of your money in market investments to achieve this. While the possibility of small fluctuations in your wealth does not bother you, you are averse to investments with a possibility of falling substantially in value by the end of your intended investment period. You would be happier with a steadier but lower rate of growth than a higher but more volatile one. You accept this limits the potential for your money to grow, and there is a possibility your wealth may not maintain its spending power.

Moderate (Profile 3):

You are comfortable with investments which may lead to some fluctuations in the value of your portfolio in exchange for the opportunity to achieve above average increases in your wealth in the medium to long run. You want the real value of your investments to increase, or your income to maintain its spending power over time. You are happy to put some of your money into market investments with the aim of getting a better return, and accept you could make a loss on the money you invest.

Medium-High (Profile 4):

You are prepared to accept regular fluctuations in the value of your portfolio and are willing to take on higher risk than other people in exchange for the opportunity to increase your wealth in the long run. You are aware that to achieve higher returns you will need to put a significant part of your portfolio in market investments. Your money could be subject to significant short-term fluctuations in value, and the potential for long-term gain and loss are both greater.

High (Profile 5):

You are comfortable with significant short-term fluctuations in the value of your investments in exchange for superior returns over the long-term. You recognize your investments will be linked to various markets, possibly with some exposure to high risk/high returns markets (e.g., emerging economies). There is a possibility you may not get back as much money as you put in, but also a possibility that your wealth will increase substantially. This is a trade-off you accept and welcome.

Composure

An exemplary composure scale measures how the customer as an individual feels about, reacts to, and copes with uncertainty in financial situations.

Individuals with lower scores on this dimension will be more emotionally engaged with the short-term performance of their portfolio. They will appreciate more stable returns, as they place higher value on the emotional stability they get from certainty. Composure differs from risk tolerance in that it refers more to a customer's short-term and emotional reactions to uncertainty. A customer's risk tolerance score gives an indication of the customer's rational willingness to trade off an increased chance of losses for better possible returns in the long term. Composure, on the other hand, gives an indication of how the customer will feel about these fluctuations in the short term as the portfolio goes up or down.

Those with low composure are likely to experience more emotional stress from uncertainty, and also to worry more about short-term decreases in the value of their portfolio. They are likely to monitor their portfolio more frequently and thus perceive portfolio outcomes on an artificially short timeframe, which exaggerates the proportion of losses relative to what they would see if focused rationally on a longer-term time horizon. It is quite possible for two investors to have the same degree of risk tolerance for long-run portfolio outcomes, but that one feels far more day-to-day concern than the other in the interim periods. Some investors may therefore become stressed or anxious about the day-to-day fluctuations in the value of their portfolio despite being happy with the potential risk and return trade-off over their investment time horizon.

Another common tendency is for investors to focus quite narrowly on individual components of their portfolios, rather than monitoring the overall performance. This can lead one to focus on losses in parts of the portfolio, even while the overall portfolio is going up in value. Investors with lower composure are more likely to observe and worry about these component losses—again the proportion of losses is exaggerated, which leads to dissatisfaction with the performance of the portfolio as a whole, even if it is ideally suited to reaching your long-term objectives.

Keeping one's investment focus on the long term or overall portfolio can help to overcome the stress often associated with low composure. On the other hand if one monitor one's portfolio too frequently, expect results over too short a time horizon, or if one focuses very narrowly on individual components of your portfolio, one will be likely to observe a higher proportion of short-term losses than one would if one framed his investment focus more broadly.

The composure scale measures how emotionally engaged a customer tends to be with the investment journey—how much they feel and respond to short term month by month gains and losses.

Market Engagement

Market engagement measures the degree to which one is inclined to avoid or engage in financial markets. This scale acts as an indicator of whether one has a mental hurdle to investing in markets, usually due to a fear of the unknown or wrong timing.

Lower scores on this scale suggest higher mental and emotional hurdles to overcome before an individual will consider a market-linked investment. This barrier could arise from a number of sources:
someone could be a risk taker in other aspects of their professional lives, but be uncomfortable with financial markets (e.g., businesspeople or entrepreneurs in the non-financial sectors, investors in property markets, etc.);
people could feel their knowledge of financial instruments is insufficient for them to take on financial decisions with confidence; they could be concerned that, although they are happy to take on known risks, they would be worried that financial investing will expose them to unexpected or hidden risks ;
others could simply have insufficient time or personal incentives to undertake the effort they feel would be necessary before taking that first step into financial markets;
avoidance of financial markets could also be an indication of a negative outlook for markets in the near term.

Whatever the reason, if a customer has a low score it is likely they will be avoiding financial markets and will have too large a portion of their wealth in cash or very low risk investments for their level of risk tolerance. If this is the case their long-run returns will not achieve their investment objectives.

(i) Perceived Financial Expertise

The perceived financial expertise dimension assesses how familiar and informed one feels they are with current financial circumstances, and how confident they feel in their own financial knowledge and decision-making.

Just as not everyone has been through medical school but most people have a basic knowledge of how to be healthy, in an exemplary embodiment this scale is designed to assess how much financial familiarity a customer perceive herself to have compared to the general level in the population.

The customer may:
be more informed than most people on current financial events;
have worked in finance but have not personally traded before;
be very familiar with specific types of investment, such as property, but not familiar with the stock market.

However, in all cases, when it comes to making important decisions about their wealth they may still want some professional guidance.

Individuals who perceive their knowledge to be high are more comfortable expressing their financial preferences and experiences and making financial decisions than those who perceive their level of knowledge to be low. A greater intuitive understanding of risk is often associated with having made and experienced investments previously. On the other hand, low knowledge often means individuals keep their investments very simple.

Luckily, a low perception of one's financial knowledge is easy to address. At the customer's discretion a personalized program can crafted to help the customer gain familiarity and confidence in their financial expertise, leading to a better understanding of investments. This will help them express their preferences with more clarity, which will help in crafting a more sophisticated and appropriate wealth solution for the customer.

The two aspects are closely related. An exemplary embodiment measures them separately, although the majority of people have similar opinions on both of the subscales.

(ii) Delegation

The delegation scale assesses how much one believes one can benefit from delegating day-to-day portfolio management decisions to someone else. The higher one's delegation, the greater will be one's desire for advice and for someone to assume the effort of portfolio management.

The delegation and belief in skill scales assess how much an individual believes they can benefit from delegating aspects of their financial management to professionals and how much value they believe those professionals can add.

The two aspects are closely related. In an exemplary embodiment they are measured separately, although the majority of people have similar opinions on both of the subscales.

The first aspect is the belief that delegating the day-to-day decisions of managing one's portfolio to someone else is beneficial. A high score on this dimension indicates a desire to have the effort of managing one's investments taken out of one's hands, and also reflects a willingness to trust in one's investment manager to do the job effectively. A high scorer is also more likely to value independent investment advice. A low score on the other hand indicates an investor who wishes to take a hands-on role in their investments, and feels less need for investment advice. Interestingly, this scale is relatively unrelated to perceived financial expertise—people who have high perceived financial expertise are just about as likely on average to want to delegate their investment management and seek advice as they are to want to keep hold of the reins themselves.

The second aspect is the degree to which the investor believes it is worth paying for the ability of an investment professional to make above-market returns. People with a low score on this scale will be less interested in their investment manager using sophisticated techniques to try to beat the market and prefer a low-cost diversified basket of investments tracking the overall performance of the market. Their portfolio will therefore merely track the average market performance in either good or bad years. High scorers on the other hand tend to believe that the right investment manager can and will be able to outperform the market average in both good and bad years. They may also be interested in the use of investment skill to smooth market fluctuations throughout the cycle, therefore pursuing positive return goals regardless of how the market is performing. This is the goal of absolute return portfolios—delivering positive returns regardless of market performance.

In most cases an individual's desire to delegate their financial management and their belief in investment skill are closely related to one another—people tend to have similar scores on both. In a few people, however, opinions about these two dimensions differ, indicating the individual has a strong belief about one dimension or the other. Each of these two closely-related dimensions are shown on their own to aid comparison.

(iii) Belief in Skill

The belief in skill scale assesses how much one believes it is worth paying for an investment professional's potential to achieve above market returns.

(b) Secondary Characteristics→Portfolio characteristics

(i) Active Management

Belief in investment skill varies by individual, and an exemplary embodiment aims to implement a portfolio in a manner which reflects the customer's personal belief in active management. Clients with high belief in investment skill may benefit from research into fund managers and active solutions. Clients with low belief in investment skill can have their portfolio implemented passively through index-tracking products and structured notes.***

*** Strategies or investments of the type described herein may involve a high degree of risk and the value of such strategies or investments may be highly volatile

Low Belief in Skill implies passive management

High Belief in Skill implies active management

(ii) Downside Protection

Individuals often fear the large losses they periodically see, and so avoid investing altogether. Over the long run this is extremely costly. If suitable, advice may be provided regarding products or strategies which limit the extent of potential losses to overcome this fear and attain the maximum performance over the long term.

Low Market Engagement implies a need for downside protection

(iii) Liquidity

The correct liquidity allows one to take advantage of possible higher returns available in less liquid products, while remaining comfortable about ability to access one's wealth. The percentage of one's wealth in high and low liquidity products can be adjusted to ensure that they are taking advantage of the illiquidity premium, while remaining comfortable with their ability to access their wealth.

Low Composure implies a need for greater portfolio liquidity

High Composure implies an opportunity to capture the illiquidity premium

(iv) Smoothing

Some clients may benefit from month-by-month smoothing of returns. For these clients, smoothing returns from intelligent product choice may be suggested.

While one's Risk Tolerance is used to drive the long-term risk of one's portfolio, some individuals focus on short-term fluctuations in markets more than is advisable. As a result they may take on too little risk in the long run, or may increase risk taking at the top of the market and pull out at the bottom—all of these result in poor returns. To help one maintain a steady investment path an investment strategy may be recommended which can produce smoother month-to-month returns. However this adjustment comes at some cost to the long-term return and should only be used when necessary.

Low composure implies an emotional need for smoothing

(c) Customised Investment Implementation and Ongoing Management

(i) Phased Investment

As some clients are uncomfortable investing all of their wealth into their ideal asset allocation immediately, tailoring the speed with which one's optimal portfolio is implemented may be recommended such that one is not overly worried about making mistakes in timing the market.

Low Market Engagement implies a need for gradually phasing investments

(ii) Comfort

Clients differ in terms of how comfortable they are with making investment decisions, or with technical or complicated products and investment strategies.

Low Perceived Financial Expertise is implies low comfort with making investment decisions

(iii) Involvement

A customer's involvement with their portfolio—how often they are contacted, how much they want to delegate or take responsibility for investment decisions and how much information they want with what frequency—can be tailored to their personality.

Low delegation implies a high degree of involvement

(iv) Tactical Updating

Whether a customer wishes to continually update their portfolio to meet the latest tactical asset allocation calls, or steer a steady path with a stable, long-term allocation should relate to their belief in the value of investment manager skill.

High Belief in Skill implies a greater tendency to follow tactical updates

(d) Portfolio Construction

The Target Risk Profile (TRP) is the recommended risk level of the Investment

Portfolio. It is generated by the Portfolio Constructor, and uses the Risk Tolerance (derived from the FPA/RTQ/Client's own risk assessment) and Wealth Review information if provided. In most cases the Target Risk Profile will be the same as the FPA/RTQ Risk Profile, however it may be different if the client has a severe mis-balance of wealth across Personal Holdings, Investment Portfolio and Opportunistic Investments. A recommendation would be limited to moving the Target Risk Profile up or down by one level. Use the Client Pitch Book pages to articulate the findings produced by the PFC. (Note: Where the client has not provided Wealth Review information the PFC tool will provide a portfolio based on the FPA risk tolerance not the overall wealth).

Exemplary Definitions of Secondary Characteristics

Note on Assessment: in all cases, the secondary characteristics should be assessed compared to the weighted average of the asset class exposures an investment gives.

Smoothing (Composure)

Purpose: Individuals often perceive downside risk over short periods of time, and thus react to short-term volatility in markets. This results in taking on less risk than would be optimal over a long time period, and churning the portfolio through the market cycle, reducing performance. Smoothing links an individuals Composure to how much they should pay to avoid this performance drag.

Goal: Smoothing aims to reduce the probability of monthly losses in the portfolio, and thus reduce the tendency of the individual to churn their portfolio or reduce risk through the market cycle.

Definition: The probability of short-term losses relative to the underlying benchmark (index or indices).
Low: higher monthly probability of a loss compared to the benchmark.
Medium: similar probability of loss compared to the benchmark.
High: lower monthly probability of a loss compared to the benchmark.

Liquidity (Composure)

Purpose: Individuals can often earn a liquidity premium by investing in illiquid assets such as private equity and tax-wrappers. However, some low Composure individuals are more likely to be uncomfortable with this lack of liquidity and may take exit-fees or suffer price-discovery fees to exit positions during a downturn.

Goal: Liquidity will link Composure to the potential level of illiquidity in the portfolio—higher illiquidity allocations for higher Composure individuals. Note that illiquidity recommended is secondary to required liquidity for practical purposes.

Definition: General market liquidity (excludes worst and best case scenarios). Also takes into consideration withdrawal penalties in the form of fees and price concessions.
Low: Position can be entered or exited on a quarterly to annual basis. Premature selling may incur severe withdrawal penalties due to fees or price discovery cost.
Medium: Position can be entered or exited on a monthly basis. Premature selling may incur moderate withdrawal penalties due to fees or price discovery cost.
High: Position can be entered or exited on a daily to weekly basis. Premature selling may incur low or no withdrawal penalties due to fees or price discovery cost.

Downside Defence (Market Engagement)

Purpose: Individuals often perceive risk based on experience and feelings of control. Individuals may therefore perceive the risk in financial markets to be higher than other risks they take in their life and with their business.

Note that regulatory guidelines regarding counter-party risk influence the acceptable range of downside defence.

Goal: Downside Defence helps provide a measure of control and reduce the over-perception of risk in financial markets for individuals with low Market Engagement.

Definition: Is the investment structured to limit potential losses in the event of a market decline or explicitly hedged?
None: Maximum possible loss is not restricted by the structure (i.e., equities, bond funds, balanced funds)
Protected: by the structure or market-hedging (i.e., government and investment grade corporate debt, structured investments, some derivatives where losses can be explicitly hedged)

Active Management (Belief in Skill)

Purpose: Individuals vary in their belief in the value of investment manager skill, both in terms of the existence of skill, and the value of employing active managers after fees.

Goal: Active management gives an overall view of how actively managed the investment portfolio is, to ensure it agrees with the clients Belief in Skill.

Definition: Is the goal of the product to track or outperform the performance of the underlying index?
Low: (Passive) Goal is to track or replicate an underlying index as closely as possible.
Medium: Goal is to track an underlying index, with limited ability to diverge significantly.
Active: Goal is to beat an underlying index by diverging in performance significantly.

Exemplary Algorithm Details

The purpose of the Financial Personality Assessment (FPA) is to provide a profiling tool that permits the capture of the psychological attitudes to investing and a number of investment objectives. These details are used to produce one reports.

The report is the client facing document and contains descriptions of the psychological dimensions. It also shows where the client is scored on each dimension relative to the general population.

This report contains a large amount of guidance on building the portfolio.

The following descriptions details exemplary algorithms and rules that may be used in producing each part of the FPA reports.

Scale Calculation

In an exemplary embodiment, an FPA assesses an individual's attitudes across several scales. In an exemplary embodiment, these are:
Risk Tolerance
Composure
Market Engagement
Perceived Financial Expertise
Delegation
Belief in Skill

These scales are assessed from the responses to the questions in Section 1 of the

FPA Questionnaire (an exemplary FPA Questionnaire is provided in Appendix A). Responses to these questions are all assigned scores, preferably in the same way.
Strongly Disagree=1
Disagree=2
Neither Agree nor Disagree=3
Agree=4
Strongly Agree=5
Much less=1
Less=2
About the same=3
More=4
Much more=5

Unless otherwise indicated the score on each scale is obtained by summing the scores on the individual questions used in that scale.

Risk Tolerance

In an exemplary embodiment, there are 8 questions on the FPA questionnaire that are used to assess Risk Tolerance: Q04, Q11, Q14, Q17, Q21, Q28, Q32, and Q35.

This scale is split into 5 categories from Low up to High. See Table 2.

TABLE 2

| | Lowest Score | Highest Score |
|---|---|---|
| Low | 8 | 13 |
| Medium-Low | 14 | 19 |
| Moderate | 20 | 26 |
| Medium-High | 27 | 32 |
| High | 33 | 40 |

Composure

In an exemplary embodiment, there are 4 questions on the FPA questionnaire that are used to assess Composure: Q12, Q23, Q31, and Q18.

Q18 in this scale is posed in such a way that its response points in the opposite direction to the other questions in this set. The response to this question may be reversed in the scoring so that Strongly Disagree receives a score of 5 and Strongly Agree receives a score of 1.

This scale is split into 5 categories from Low up to High. See Table 3.

TABLE 3

| | Lowest Score | Highest Score |
|---|---|---|
| Low | 4 | 8 |
| Medium-Low | 9 | 11 |
| Moderate | 12 | 13 |
| Medium-High | 14 | 16 |
| High | 17 | 20 |

Market Engagement

In an exemplary embodiment, there are 3 questions on the FPA questionnaire that are used to assess Market Engagement: Q16, Q25, and Q29.

The questions in the Market Engagement scale all suggest that agreeing with the statement should give a low score. For this reason the responses to all the questions in the scoring may be reversed so that Strongly Disagree receives a score of 5 and Strongly Agree receives a score of 1.

This scale is split into 5 categories from Low up to High. See Table 4.

TABLE 4

| | Lowest Score | Highest Score |
|---|---|---|
| Low | 3 | 6 |
| Medium-Low | 7 | 9 |
| Moderate | 10 | 11 |
| Medium-High | 12 | 13 |
| High | 14 | 15 |

Perceived Financial Expertise

In an exemplary embodiment, there are 4 questions on the FPA questionnaire that are used to assess Perceived Financial Expertise: Q02, Q13, Q19, and Q30.

This scale is split into 5 categories from Low up to High. See Table 5.

TABLE 5

| | Lowest Score | Highest Score |
|---|---|---|
| Low | 4 | 10 |
| Medium-Low | 11 | 12 |
| Moderate | 13 | 15 |
| Medium-High | 16 | 17 |
| High | 18 | 20 |

Delegation

In an exemplary embodiment, there are 3 questions on the FPA questionnaire that are used to assess Delegation: Q09, Q27, and Q33.

This scale is split into 3 categories from Low up to High.

TABLE 6

| | Lowest Score | Highest Score |
|---|---|---|
| Low | 3 | 9 |
| Moderate | 10 | 11 |
| High | 12 | 15 |

Belief in Skill

In an exemplary embodiment, there are 3 questions on the FPA questionnaire that are used to assess Belief in Skill: Q03, Q06, and Q20.

This scale is split into 3 categories from Low up to High.

TABLE 7

| | Lowest Score | Highest Score |
|---|---|---|
| Low | 3 | 9 |
| Moderate | 10 | 11 |
| High | 12 | 15 |

Distinguishing Features Texts

The profiles in the categories above preferably are converted into a numerical identifier.

For Risk Tolerance:
Low=1
Medium-Low=2
Moderate=3
Medium-High=4
High=5

For Composure, Market Engagement and Perceived Financial Expertise:
Low=1
Medium-Low=1
Moderate=2
Medium-High=3
High=3

For Delegation and Belief in Skill:
Low=1
Moderate=2
High=3

These may then be combined to give an identifier for the client's personality: RT.3.CO.ME.FE.SK.DEL

This identifier may be used in the same way as described below in the section entitled Categorization and Text Allocation Methodology. The only difference is that one no longer measures the experience of volatility. To keep the technology change simple the volatility rating may be set at 3 and the texts rewritten to remove any reference to this scale that uses volatility. Other than this, the distinguishing features text is derived in the same way as described below in the section entitled Categorization and Text Allocation Methodology

Risk Adjustments

The FPA report recommends that the banker considers whether information on the client's circumstances would lead to delivery of a different risk profile. While the recommendation is clear and a direction is given, it is up to the banker to decide whether to take any action.

Multiple factors may be considered when considering whether to adjust the risk profile. Exemplary factors include income, externally held wealth, and liabilities. One goal is to stabilize a client's level of risk across the client's complete wealth

Income:

In an exemplary embodiment, it may be recommended the banker consider adjusting the risk profile of the portfolio if the client's future net savings is large relative to their current wealth level and is significantly different in risk level. This recommendation can be both to increase and decrease portfolio risk.

In an exemplary embodiment, one may take the client's current net savings and multiply this by the number of years up until retirement. This provides a proxy for total future earnings. One may divide this by the client's current total wealth to form a metric that describes how many times over the client will earn their current wealth up until retirement. This forms one input to an exemplary comparison algorithm.

Externally Held Wealth:

Advice to a client should flexibly incorporate externally held wealth. There are two main relevant distinctions: is the wealth “fixed”, i.e. not up for divestment/reallocation, and the second is the wealth held external to the advisors accounts. Fixed assets can be worked around in giving the client advice, and taken into account, however at certain levels an advisor will simply not be able to deliver the correct level of risk-return due to fixed assets. The fact that some assets are held external to the advisor should not influence the advice given, but it does need to be made clear that the advised investments take into account products or exposures which do not sit on the advisors platform. The asset allocation on the advisors platform may appear wrong unto itself, but not once external assets are taken into account.

Liabilities:

One may recommend that the banker consider adjusting the risk profile of the portfolio if the client's liabilities are large relative to their total wealth.

Portfolio Asset Allocation and Product Selection

Using the target risk profile for the investment portfolio, one can map this to an asset allocation model which delivers the appropriate level of risk in the portfolio through different risk-level asset classes.

However, one can also define a method of selecting both service options and specific investments and products criteria on the clients non-risk profile personality traits.
Composure can link to the degree of liquidity and smoothing of short-term volatility in the portfolio.
Market Engagement can link to the degree of downside protection (non-contingent structural capital protection) in the portfolio, and how quickly the portfolio is moved from cash to investments.
Perceived Financial Expertise can link to the appropriate complexity of strategies or products within the portfolio.
Delegation can link to the appropriateness of discretionary management versus execution only advice within the portfolio
Belief in Skill can link to the appropriateness of discretionary management, and how much of the portfolio should be actively managed, either by the advisor or fund managers.

### Exemplary Tailored Portfolio Construction

Once the system has identified an overall investment strategy that's right for the client, the portfolio may be fine-tuned to reflect the client's unique personality more closely. With a model asset allocation portfolios as a foundation, the client's investment can be truly customized. An understanding of the client's financial personality helps to find the best ways to implement their investment strategy.

### The Customized Asset Allocation

The most appropriate long-term investment strategy involves maximizing potential returns corresponding to the level of risk the client is willing to accept. The client's level of Risk Tolerance will determine the appropriate mix of assets for them—a higher tolerance indicates a higher risk, higher return portfolio, while low tolerance leads to a truly lower risk, lower return solution.

Complexity

Clients differ in terms of how comfortable they are with investment decisions, or with technical or complicated products and investment strategies.

Active vs. Passive

Smoothing Gradual phased investment Greater Belief in Skill signals a willingness to invest in actively managed solutions (e.g., Multi-Manager).

Lower Belief in Skill indicates a preference for passively managed products (e.g., Tracker funds, ETFs).

Involvement

Lower levels of delegation signal that the client will want to be more involved with managing your money and portfolio performance.

Smoothing

The process of smoothing returns aims to limit short-term losses, usually at the cost of sacrificing some upside in favor of comfort with the journey.

Gradual Phased Investment

Low Market Engagement means the client may be less comfortable committing to investing. The client benefits from phasing their investment over time to reduce timing risk.

A Unique Investment Strategy

An exemplary embodiment uses secondary characteristics of the client's financial personality to implement the client's investment solutions, enabling the system to refine the client's portfolio over time:

Liquidity—the right proportion of a liquid investment allows the client to take advantage of the higher returns available from less liquid investments, while still feeling comfortable about their ability to access their wealth.

Smoothing—some investments can help to offset the effects of market volatility, giving the client steadier, more consistent returns (though this may involve sacrificing some of the upside).

Downside protection—the system can suggest strategies and solutions that limit the extent of potential losses, helping to safeguard the client's capital and at minimal cost in terms of long-term performance.

Active management—the client's portfolio can be tailored to their own convictions about the importance of investment skill. Clients with high conviction in the power of active management can benefit from in-depth research into fund managers, while clients with low conviction can invest passively using index funds and structured notes.

Implementation and Ongoing Management

The system also may tailor the way it manages the client's investments in a way that's right for the client. Once the client's portfolio is up and running, the system will keep working to improve the client's returns, control risk and keep the client informed.

Fine-tuning the client's portfolio is the fourth step in a process designed to help the client get the investment results they want. By looking at every aspect of the client's wealth from a holistic perspective, the system can create a customized portfolio that matches the client's objectives and financial personality, with the correct level of risk. Through disciplined asset allocation, a coherent strategy and a ‘fine-tuned’ collection of investments, the system arrives at a solution that's exactly right for the client.

### Exemplary Risk Adjustment Algorithm

In an exemplary framework, clients can allocate specific holdings of their assets across three partitions—the Personal Holdings, the Investment Portfolio, and the Opportunistic Investments. The total holdings in these partitions may influence the appropriate risk in the Investment Portfolio.

The exemplary risk adjustment algorithm described below is not attempting to be an overly-precise metric, but rather to unearth pockets of stabilising or de-stabilising wealth exposures and see whether these are potentially large relative to the clients overall wealth. Only where they are large is a shift recommended, and then by no more than one level target risk profile in either direction. This is only a recommendation to flag further discussion by the banker. The goal is to provide guidance, not a mechanistic solution.
Personal Holdings tend to be consumptions assets which the client derives active enjoyment from, rather than assets they wish to see grow. As such, these assets tend to be low-risk holdings such as primary and secondary residences, cash balances for transactions and an emotional buffer, wine, art, durable goods (planes, cars) etc. As it is unlikely these assets will cause a significant negative effect in a client's life if they decrease in market value, they are assessed as being low risk. Thus if a client has a large percentage of their overall wealth in Personal Holdings, it may be appropriate to increase the Target Risk Profile in the Investment Portfolio.
Opportunistic Investments tend to be the opposite—concentrated, single positions which may experience significant fluctuations in value and expose the client to bankruptcy and complete loss of capital. These are considered high risk, and thus large percentages of a client's overall wealth in Opportunistic holdings may decrease the appropriate Target Risk Profile in the Investment Portfolio.
Borrowings/Leverage, and the Net Present Value of Savings: As would be expected from intuition, a young, high-earning, frugal individual has significantly greater capacity to take on risk than a retired individual living off their capital. Conversely, Borrowing/Leverage reduces it. Significant borrowings or leverage will decrease the appropriate Target Risk Profile.

As clients are advised on the Investment Portfolio portion of their assets, the system may adjust the amount or risk in the Investment Portfolio to reflect clients total wealth circumstances more holistically. The system therefore assesses whether a client has a significant mis-balance of wealth overall, and attempts to provide ballast or growth depending on their circumstances. The following factors may influence advice provided regarding adjusting the target risk profile of the Investment Portfolio:
A high percentage of the client's gross wealth in Personal Holdings may cause a recommendation for an increase in the target risk profile within the Investment Portfolio.
A high percentage of gross wealth in the Opportunistic Investments may cause a recommendation for decreasing the risk profile within the Investment Portfolio.
A higher percentage of liabilities (leverage or borrowings) in the clients overall gross wealth (across all partitions) may cause a recommendation for decreases in the appropriate risk profile of the client.
A higher net-present-value of savings may increase the appropriate risk profile of the client, where it is large compared to their present wealth level.

The exemplary algorithm provided below details exactly how these adjustments may be made:

Solve for Target Risk Profile in the Equation:

$$Target Risk Profile = \frac{\begin{matrix}\{ RT * ( Gross Assets - Total Liabilities + NPVS ) \} - \\ ( 1 * {PH}_{Gross} ) - ( 6 * {OI}_{Gross} )\end{matrix}}{{IP}_{Gross}}$$

Or, equivalently:

$$Target Risk Profile = X = \frac{\begin{matrix}\{ Risk Profile * ( {PH}_{Net} + NPVS + {OI}_{Net} ) \} - \\ ( 1 * {PH}_{Gross} ) - ( 6 * {OI}_{Gross} )\end{matrix}}{{IP}_{Gross}}$$

Where:

RT: The clients psychometric risk tolerance profile (1-5 scale)

PH_{Gross}: The sum of all “assets” in the Personal Holdings*0.8

PH_{Net}: \grave{P}\grave{H}_{Gross} MINUS the sum of all “liabilities” in Personal holdings

IP_{Gross}: The sum of all “assets” in the Investment Portfolio

IP_{Net}: IP_{Gross} minus the sum of all “liabilities” in the Investment Portfolio

OI_{Gross}: The sum of all “assets” in Opportunistic Investments

OI_{Net}: OI_{Gross} minus the sum of all “liabilities” in Opportunistic Investments

NPVS: (Annual Non-Investment Income−Annual Expenditures)*(1+0.02)*Years till retirement

Then:
If abs(RT−X)<1.5 Then no change in recommended target risk profile
If (RT−X)>=1.5 Then recommend decreasing target risk profile
If (RT−X)<=−1.5 Then recommend increasing target risk profile

Notes:

The 0.8 against Personal Holdings is a haircut to take a conservative estimate of Personal Holdings—these are treated as low risk by the algorithm, but may in fact fluctuate significantly in value. Since the market value of these assets is not reason the client holds them, the current value is not that important to optimising the investment portfolio. However, having wealth in personal holdings (if not mortgaged) does provide some stability to take on more risk elsewhere, relative to someone who doesn't own any of these assets. Ideally the assessment of the values in here should be conservative since over-estimating these will cause too much risk to be recommended elsewhere. Thus the 0.8 is simply to ensure a conservative estimate of these values.

The 2% is a combination of discounting the wealth over the earnings horizon, and assuming some interest accumulation and natural growth in earnings over the future. This is as a general rule quite conservative—so one is discounting the future slightly less to make up for the fact that one is not recognising any savings increases over life.

Exemplary Mathematical Derivations

X=The correct Target Risk Profile for the client overall

RP=(1*% PH_{Gross}+X*% IP_{Gross}+6*OI^{Gross})*(Gross Assets/(Net Assets+NPVS))

RP=((1*PH_{Gross}+X*IP_{Gross}+6*OI_{Gross})/Total Gross Assets)*(Gross Assets/(Net Assets+NPVS))

RP=((1*PH_{Gross}+X*IP_{Gross}+6*OI_{Gross})/((Net Assets+NPVS))

1*PH_{Gross}X*IP_{Gross}+6*OI_{Gross}=RP*(PH_{Net}+IP_{Net}+OI_{Net}+NPVS)

Thus:

$$Target Risk Profile = \frac{\begin{matrix}\{ RT * ( {PH}_{Net} + {IP}_{Net} + {OI}_{Net} + NPVS ) \} - \\ ( 1 * {PH}_{Gross} ) - ( 6 * {OI}_{Gross} )\end{matrix}}{{IP}_{Gross}}$$

### Exemplary Client Categorization and Text Allocation Methodology

This section describes how one may categorize individuals' financial personalities on the basis of a profile index (in this example, a seven-dimension profile index), and explains how these ‘single dimension’ descriptive texts may be written up for clients. Also discussed are ‘Distinguishing Features’ texts also supplied to clients, and then how financial personality may affect the division of investment between absolute and market return portfolios.

Categorizing individuals along personality dimensions requires a clear understanding of the structure of psychometric data, the personality traits measured by the data, and the purpose for which the categorization is being carried out. One goal may be to segment clients so that they will always receive meaningful and tailored feedback which will intuitively match their own perceptions of themselves. Another goal may be to help clients understand how these traits may interact with their financial decisions and preferences, and to base content on up-to-date literature reviews on the reported traits and their manifestations in financial psychology.

In an exemplary embodiment, there are two main types of text the client receives in their report. First, there are seven ‘single dimension’ texts, which describe the client's score on that dimension only. Second, there are two ‘interaction’ texts, which take three or more of the clients' scores into account when allocating a text. The first interaction text, ‘Distinguishing Features’, may be based on all seven of the clients dimension scores. The second, the Absolute/Market interaction texts, may take three of the traits as their basis, and report a suggested portfolio allocation between absolute and market returns portfolios.

Creating and allocating the Distinguishing Features texts may be achieved by writing a unique text for every possible combination of scores. But this would require writing an enormous number of texts and would also require a sound method for allocating these texts to clients. Moreover, the higher the level of specificity of each text, the more fragile they would become as a result of their precision—the higher the potential for a client to receive a text which is a slight misfit to their perception of themselves. There is therefore a trade-off of how general (vague) a text is, and having extremely specific texts allocated to specific profiles, which increases the potential for client misfit.

Surveys performed, and the analysis performed on the resulting data, have provided a reasonable means of determining how to both efficiently and reasonably link all the possibly outcomes with a text which will fit the client well. This section provides an overview of the methodology which may be used to make this link.

Profile Index

In this example, the basis of the client categorization scheme is a seven dimension Profile Index, which represents low, medium, or high scores on the seven psychological traits derived from the survey analysis. The psychometric part of the Client Profiling Questionnaire preferably has thirty questions, answerable on a 1 to 5 point scale, measuring degree of agreement with specific statements. The traits that may be constructed from these questions are:
Risk Tolerance (8 questions, scale ranges from 8 to 40)
Resilience to Volatility (3 questions, scale ranges from 3 to 15)
Composure {5 questions, scale ranges from 5 to 25)
Market Engagement (4 questions, scale ranges from 4 to 20)
Financial Expertise (4 questions, scale ranges from 4 to 20)
Desire for Delegation (3 questions, scale ranges from 3 to 15)
Belief in Skill (3 questions, scale ranges from 3 to 15)

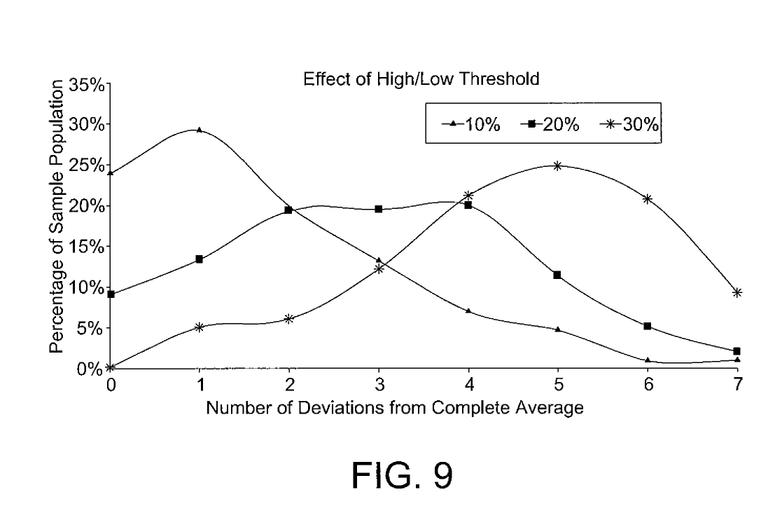

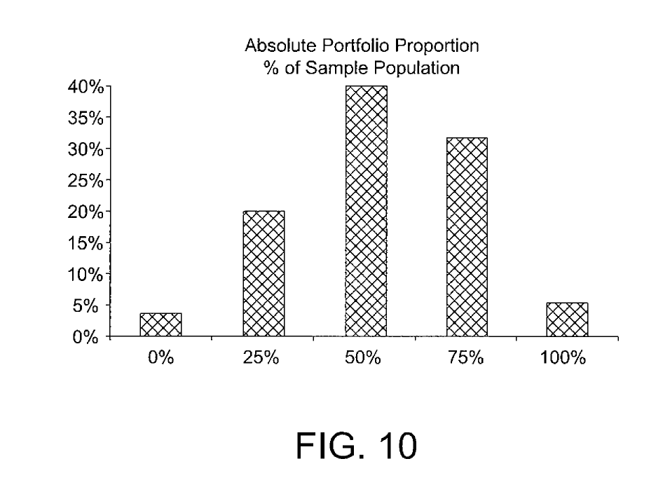

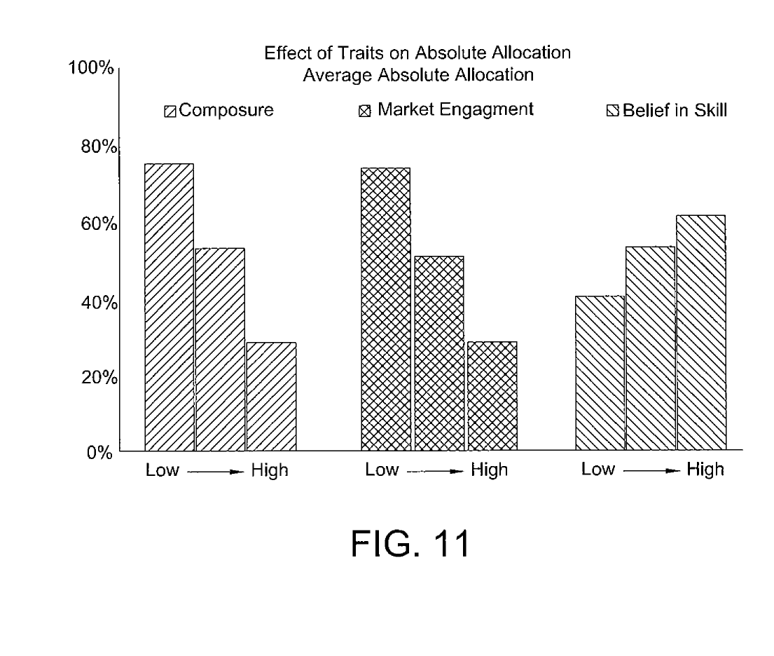

For each dimension one may determine cut-offs for low, medium, and high scores. Scores representing the lowest 30% of respondents on each dimension in a sample population were classified as ‘low’. The highest 30% of respondents within a dimension were classified as ‘high’, and the middle 40% as ‘moderate’. One may further divide the Risk Tolerance scale into medium-lows (representing, say, the 10th to 35th percentiles) and medium-highs (representing, say, the 65th to 90th percentiles). The percentile cut-offs within each dimension may be judged on how well a threshold split individuals into meaningful groups. Smaller cut-offs (lowest and highest 10% for all dimensions, for example) result in the vast majority of people being moderate on all dimensions. A 30% -40% -30% split may be felt to be the best after testing many different thresholds, as the resulting variations may allow one to efficiently write reasonable Distinguishing Features texts for a larger part of the population. See FIG. 9.

These low/medium/high categorizations may then be put into a numeric ordered index, with, for example, 1 representing a low, 2 representing moderate, and 3 representing high. The Risk Tolerance scale may be split into, say, five categories, with 1 representing low, 2 representing medium-low, 3 representing moderate, 4 representing medium-high, and 5 representing high. These numeric categorizations may be grouped to produce a unique profile index for each client. The order of the index may be: Risk Tolerance, Resilience to Volatility, Composure, Market Engagement, Financial Expertise, Delegation, and then Belief in Skill. These are delimited by a full-stop for clarity, and combined to make indices such as those below.

TABLE 11

| | |
|---|---|
| A completely moderate profile | 3.2.2.2.2.2.2 |
| A completely high profile | 5.3.3.3.3.3.3 |

A completely low profile would be 1.1.1.1.1.1.1. On this basis there are 3,645 possible Profile Index combinations to be allocated profile-specific text.

Single Dimension Texts

For each dimension, specific texts may be written and allocated to describe each category independently of others, and how such a character trait might manifest itself in financial decision making. For Risk Tolerance, Composure, Market Engagement, Financial Expertise, Delegation, and Belief in Skill, the low/medium/high categories may provide the means of allocating texts. A text may be allocated in specific circumstances based on Delegation and Belief in Skill. This exception is detailed below.

Delegation and Belief in Skill

Similarly, Delegation and Belief in Skill are highly correlated, but do form stable dimensions on their own. One may therefore report them separately, but allocate a specific text if the client's scores on these dimensions disagree with one another. For example, a client with high Delegation and low Belief in Skill may receive a specific text highlighting the unusual nature of their responses.

TABLE 12

| | | Delegation Category | |
|---|---|---|---|
| Belief-in-Skill Category | Low | Moderate | High |
| Low | 12.7% | 14.9% | 2.8% |
| Moderate | 3.8% | 24.1% | 7.8% |
| High | 1.9% | 16.0% | 16.0% |

Distinguishing Features Classification Scheme

Beyond the text a client may receive regarding their scores on any one dimension, they also may receive a Distinguishing Features text, which takes into account their scores on all of the dimensions. As noted above, the classification scheme may be designed to efficiently, reliably, and meaningfully distribute individuals across categories which would emphasize the most notable aspects of their financial personality. Thus, there is a method of a client receiving a text which allows one to give them the most specific text that one determines will fit their profile. As a profile index moves forward through the four-step scheme, the text it will receive may increase in specificity, superseding previous (and more general) texts. The most specific text a client may receive is a cluster text, which takes all seven of the traits directly into account when classifying a client. The general schema is simplified below in Table 13, where a profile index begins on the left, and moves to the right through a series of classification divisions.

TABLE 13

| | | | Delegation & | | |
|---|---|---|---|---|---|
| Step 1. | Step 2. | Step 3. | Composure/ | Delegation & | Step 4. |
| “Expected” | Tier 1 | Tier 2 | Market | Risk | Cluster Text |
| Classification | Division | Division | Engagement | Tolerance | (if allocated) |
| Unexpected | Single | | + | + | B, E, D, G |
| | Combination | | | | |
| | Two or More | Discordant | | + | B, E |
| | Combinations | Low | | | |
| | | Discordant | | + | B, D, G |
| | | High | | | |
| | | Conflicted | | + | B |
| Expected | Generally | Delegation | | | |
| | Low | Split | | | |
| | | Low | | | G, C, D |
| | | Moderate | | | A, B, G, C, D |
| | | High | | | C, D, G |
| | Generally | Low | | | B, E |
| | Moderate | Moderate | | | B, E, G, C, D, H |
| | | High | | | G, C, D, H |
| | Generally | Low | | | B, F |
| | High | Moderate | | | B, F, H |
| | | High | | | H |

+ denotes that a text is in addition to, not replacing, the previously allocated text.

Expected Versus Unusual Division

In this example, the first step of the analysis underlying the classification schema is based on the relationship between four traits. Risk Tolerance, Composure, Market Engagement, and Financial Expertise are all correlated with one another—i.e., higher (lower) scores on each tend to be associated with higher (lower) scores on the others. Belief in Skill and Delegation are likewise highly correlated with one another; however, neither of them is systematically correlated with the other five dimensions.

TABLE 14

| | | Resilience | | | Perceived | |
|---|---|---|---|---|---|---|
| | Risk | to | | Market | Financial | Belief in |
| Correlation of Factors | Tolerance | Volatility | Composure | Engagement | Expertise | Skill |
| Resilience to Volatility | 0.69 | | | | | |
| Composure | 0.31 | 0.31 | | | | |
| Market Engagement | 0.39 | 0.32 | 0.34 | | | |
| Financial Expertise | 0.46 | 0.36 | 0.35 | 0.43 | | |
| Belief in Skill | 0.23 | 0.16 | 0.04 | 0.01 | −0.01 | |
| Delegation | 0.09 | 0.00 | 0.05 | 0.08 | −0.11 | 0.55 |

One may divide the Profile Indices by whether or not they were expected by this pattern of scores on Risk Tolerance, Composure, Market Engagement, and Financial Expertise, or unusual. For the purposes of this division, one may ignore experience with volatility, as it is so highly correlated with Risk Tolerance. For example, a profile containing high values on all four is ‘expected’, as the four dimensions generally move together. Conversely, having low Risk Tolerance, high Composure, high Market Engagement, and low Perceived Financial Expertise is unusual, given how the traits usually move together. The result of this division is shown below in Table 15. Note that while Unusual profiles take up 62% of the possible profiles, these account for only 30% of our sample population, as they are unusual due to the correlations in the four traits.

TABLE 15

| | Number of Unique | Percent of |
|---|---|---|
| Classification | Profiles (%) | Sample Population |
| Expected | 1,395 (38%) | 70% |
| Unusual | 2,250 (62%) | 30% |

Expected Sub-Divisions

Within the Expected division, one may first further segment clients along how their scores are alike—generally high, generally moderate, or generally low. The result of this division may be further divided by the classification on the Delegation scale (low, moderate, or high). The result of these divisions is detailed below in Table 16.

TABLE 16

| | Number of | | | | Percent of |
|---|---|---|---|---|---|
| Expected | Profiles (%)/ | | Number of | | Sample |
| Classification | Percent of Sample | Delegation | Profiles - % | | Population |
| Generally | 495 (14%)/24% | Low | 55 | 2% | 2% |
| Low | | Moderate | 385 | 10% | 22% |
| | | High | 55 | 2% | 3% |
| Generally | 405 (11%)/21% | Low | 45 | 1% | 2% |
| Moderate | | Moderate | 315 | 8% | 16% |
| | | High | 45 | 1% | 4% |
| Generally | 495 (14%)/22% | Low | 55 | 2% | 4% |
| High | | Moderate | 385 | 10% | 14% |
| | | High | 55 | 2% | 4% |

### Unusual Sub-Divisions

The ‘unusual’ profiles can be given a similar breakdown structure as above. First, they may be categorized according to the number of combinations of high or low values they were given. For example, a profile consisting of average values except high Risk Tolerance and low Composure would have one combination. The same profile with low Market Engagement has two combinations.

TABLE 17

| Unusual | Number of Unique | Percent of |
|---|---|---|
| Classification | Profiles (%) | Sample Population |
| One combination | 540 (15%) | 9% |
| Two or more combinations | 1,710 (47%) | 21% |

An exemplary breakdown of single and two or more combination texts is detailed below in Table 18.

TABLE 18

| | | Sample |
|---|---|---|
| | Number of Unique | Population |
| Single combination | Profiles (%) | % |
| High Risk Tolerance/Low Composure | 45 (1%) | 0.5% |
| Low Risk Tolerance/High Composure | 45 (1%) | 0.7% |
| High Risk Tolerance/Low Market | 45 (1%) | 1.0% |
| Engagement | | |
| Low Risk Tolerance/High Market | 45 (1%) | 1.0% |
| Engagement | | |
| High Risk Tolerance/Low Financial | 45 (1%) | 1.7% |
| Expertise | | |
| Low Risk Tolerance/High Financial | 45 (1%) | 0.7% |
| Expertise | | |
| High Composure/Low Market | 45 (1%) | 0.5% |
| Engagement | | |
| Low Composure/High Market | 45 (1%) | 0.9% |
| Engagement | | |
| High Composure/Low Financial | 45 (1%) | 0.9% |
| Expertise | | |
| Low Composure/High Financial | 45 (1%) | 0.2% |
| Expertise | | |
| High Market Engagement/Low | 45 (1%) | 0.7% |
| Financial Expertise | | |
| Low Market Engagement/High | 45 (1%) | 0.0% |
| Financial Expertise | | |

Where there is more than a single high-low combination in Risk Tolerance, Composure, Market Engagement and Perceived Financial Expertise, one may can further dissect the possible profiles. First, the profile may be segmented along whether or not a single dimension was ‘discordant’—i.e., did not agree (one way or the other) with the other three. This produces eight categories—when a dimension is high (and the others are low), and when a dimension is low (and the others high), for the four dimensions.

There remain, in this example, a further six possible indices where there are more than one discordant combination. These profiles, which may be called ‘Conflicted’, have an index associated with them detailing their values for Risk Tolerance, Composure, Market Engagement, and then Financial Expertise. For example, someone with high Risk Tolerance, high Composure, low Market Engagement, and Low Financial Expertise would have a Conflicted index of 3.3.1.1. These Conflicted indices represent, in total, 2.4% of the sample population. See Table 19.

TABLE 19

| | Number | Sample |
|---|---|---|
| | of Unique | Population |
| Two or more combinations | Profiles (%) | % |
| Risk Tolerance discordant - Low (b21) | 180 (4%) | 1.4% |
| Risk Tolerance discordant - High (b31) | 180 (4%) | 1.9% |
| Composure discordant - Low (b22) | 180 (4%) | 2.4% |
| Composure discordant - High (b32) | 180 (4%) | 3.3% |
| Market Engagement discordant - Low (b23) | 180 (4%) | 1.9% |
| Market Engagement discordant - High (b33) | 180 (4%) | 1.4% |
| Financial Expertise discordant - Low (b24) | 180 (4%) | 0.7% |
| Financial Expertise discordant - High (b34) | 180 (4%) | 1.9% |
| Conflicted 1 - 1.1.3.3 (b25) | 45 (1%) | 0.9% |
| Conflicted 2 - 1.3.1.3 (b26) | 45 (1%) | 0.2% |
| Conflicted 3 - 1.3.3.1 (b27) | 45 (1%) | 0.7% |
| Conflicted 4 - 3.1.1.3 (b28) | 45 (1%) | 1.2% |
| Conflicted 5 - 3.1.3.1 (b29) | 45 (1%) | 0.0% |
| Conflicted 6 - 3.3.1.1 (b30) | 45 (1%) | 0.0% |

Thus far in the Unusual segment, the Delegation and Belief in Skill dimensions have been mostly ignored in determining text allocation. This may be remedied as described below, with two possible combination texts. First, if the profile has an extreme combination of Risk Tolerance, and Delegation and Belief in Skill are both extreme in the same direction, one may allocate a specific text, in addition to any pre-existing text. Second, if their Composure or Market Engagement value is low, and their Delegation score extreme in either dimension, one may allocate them an additional independent text. See Table 20.

TABLE 20

| Percent of | Risk | Risk | | Market |
|---|---|---|---|---|
| Sample | Tolerance | Tolerance | Composure | Engagement |
| Population | High^{†} | Low^{†} | Low | Low |
| Delegation - | 12% | 10% | 9% | 13% |
| High | | | | |
| Delegation - | 10% | 12% | 9% | 9% |
| Low | | | | |

In this example, the last iteration of text allocation addresses the allocation of Cluster texts. Through the course of this analysis, one may perform Cluster analysis on the dataset to diagnose the proto-typical groups which clients segment themselves into. These groups form distinct ‘clusters’, individuals with highly identifiable patterns of scores. The order in which they segmented themselves along dimensions may be informative, instructing one as to how the clients may be best broken down and generalized about. The first major division was on Risk Tolerance, the second on Delegation and Skill, and the remaining dimensions subsequently broke away within those two dimensions. The cluster analysis may result in the following clusters, with their respective identifying characteristics. Note that the clusters' percentage of sample population may be always much greater than the % of the possible profiles, a good indicator that the clusters are capturing distinctly similar groups of people.

TABLE 21

| | | | | Number of |
|---|---|---|---|---|
| Risk | Delegation | | | Profiles |
| Tolerance & | & | | | % Total |
| Resilience to | Belief in | | | Profiles |
| Volatility | Skill | | Cluster | % Sample |
| Split | Split^{‡} | Additional Criteria | Index | Population |
| Low^{‡} | Low | Low Composure | A | 20 |
| | | Low Market Engagement | (b51) | <0.0% |
| | | Low/Medium Financial | | 4.5% |
| | | Expertise | | |
| | | High/Med Composure | B | 80 |
| | | Low/Med Market | (b52) | 2.1% |
| | | Engagement | | 3.5% |
| | | Med/High Financial | | |
| | | Expertise | | |
| | High | Low/Med Composure | C | 60 |
| | | Low/Med Market | (b53) | 1.6% |
| | | Engagement | | 5.9% |
| | | Low Financial Expertise | | |
| | | Low/Med Market | D | 89 |
| | | Engagement | (b54) | 2.4% |
| | | Medium Financial | | 4.0% |
| | | Expertise | | |
| High^{‡} | Low | Low Composure | E | 60 |
| | | Med/High Market | (b55) | 1.6% |
| | | Engagement | | 2.1% |
| | | Med/High Financial | | |
| | | Expertise | | |
| | | High Composure | F | 15 |
| | | High Market | (b56) | <0.0% |
| | | Engagement | | |
| | | High Financial Expertise | | 3.1% |
| | High | Low/Med Composure | G | 30 |
| | | Low Market Engagement | (b57) | <0.0% |
| | | Medium Financial | | 3.8% |
| | | Expertise | | |
| | | Med/High Composure | H | 120 |
| | | Med/High Market | (b58) | 3.2% |
| | | Engagement | | 9.9% |
| | | Med/High Financial | | |
| | | Expertise | | |

^{‡}At least one dimension must have an extreme value, and the other dimensions value must not be of the opposite extreme.

The cluster texts typically supersede the previously allocated texts, as they are formed on the combination of all seven dimensions concurrently, and represent the clearest segmentation of the population. The clusters then supersede some of the expected texts, as well as the unusual texts, in the pursuit of matching texts to clients. Not surprisingly, the clusters represent a total of 37% of the sample population.

As can be seen below, the top ten unique profile indices account for 70% of the population.

TABLE 22

| | | Cumulative |
|---|---|---|
| | Individual | Percent of |
| | Percent of | Population |
| | Population | Allocated |
| Generally Moderate | 13.2% | 13.2% |
| Generally Low | 13.2% | 26.4% |
| Cluster H | 9.9% | 36.3% |
| Generally High | 8.7% | 45.0% |
| Cluster C | 5.9% | 50.9% |
| Cluster A | 4.5% | 55.4% |
| Cluster D | 4.0% | 59.4% |
| Cluster G | 3.8% | 63.2% |
| Cluster B | 3.5% | 66.7% |
| Financial Expertise | 3.1% | 69.8% |
| Discordant - High | | |

### APPENDICES

Appendix A provides two exemplary financial personality questionnaires.

Appendix B provides an exemplary financial personality profile report that would be provided to a subject of a questionnaire.

Appendix C provides an exemplary document comprising investment process and portfolio recommendations for a client.

Appendix D provides an exemplary financial personality assessment and recommended portfolio characteristics report.

Exemplary embodiments comprise computer components and computer-implemented steps that will be apparent to those skilled in the art. For example, calculations and communications can be performed electronically, and results can be displayed using a graphical user interface.

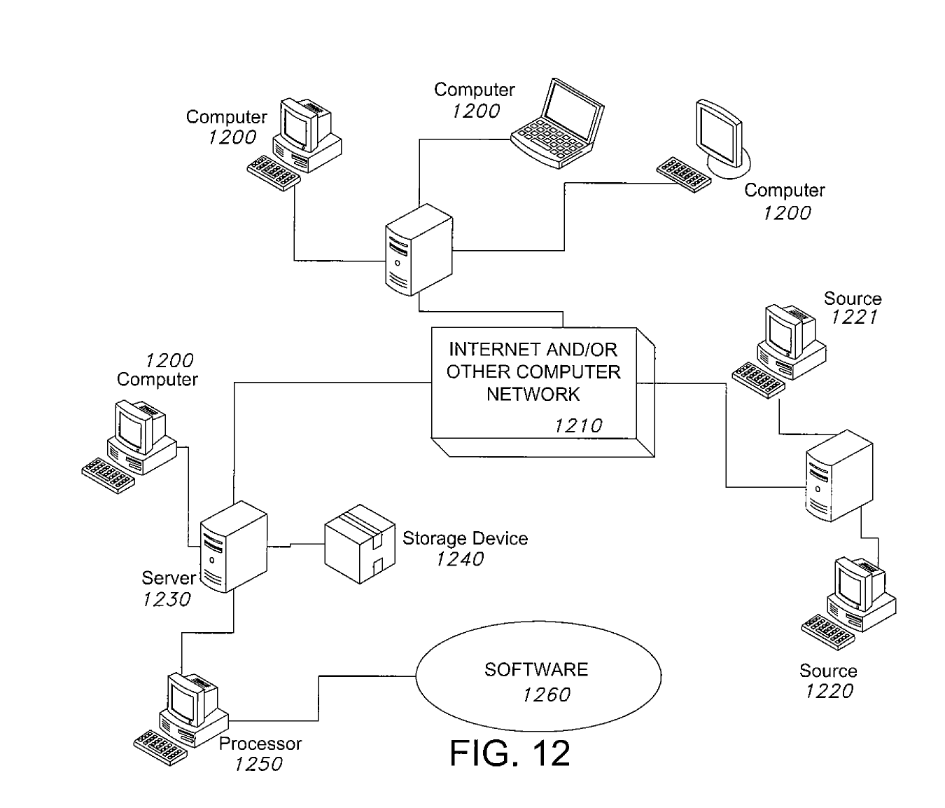

An exemplary such system is depicted in FIG. 12. Computers 1200 communicate via network 1210 with a server 1230. A plurality of sources of data 1220-1221 relating to, for example, questionnaire responses and related information, also communicate via network 1210 with a server 1230, processor 1250, and/or other components operable to calculate and/or transmit, for example, risk tolerance and other financial personality related information. The server 1230 may be coupled to one or more storage devices 1240, one or more processors 1250, and software 1260.

Other components and combinations of components may also be used to support processing data or other calculations described herein as will be evident to one of skill in the art. Server 1230 may facilitate communication of data from a storage device 1240 to and from processor(s) 1250, and communications to computers 1200. Processor 1250 may optionally include or communicate with local or networked storage (not shown) which may be used to store temporary or other information. Software 1260 can be installed locally at a computer 1200, processor 1250 and/or centrally supported for facilitating calculations and applications.

For ease of exposition, not every step or element of the present invention is described herein as part of a computer system, but those skilled in the art will recognize that each step or element may have a corresponding computer system or software component. Such computer system and/or software components are therefore enabled by describing their corresponding steps or elements (that is, their functionality), and are within the scope of the present invention.

Moreover, where a computer system is described or claimed as having a processor for performing a particular function, it will be understood by those skilled in the art that such usage should not be interpreted to exclude systems where a single processor, for example, performs some or all of the tasks delegated to the various processors. That is, any combination of, or all of, the processors specified in the description and/or claims could be the same processor. All such combinations are within the scope of the invention.

Alternatively, or in combination, processing and decision-making may be performed by functionally equivalent circuits such as a digital signal processor circuit or an application specific integrated circuit.

Many routine program elements, such as initialization of loops and variables and the use of temporary variables, are not described herein. Moreover, it will be appreciated by those of ordinary skill in the art that unless otherwise indicated, the particular sequence of steps described is illustrative only and can generally be varied without departing from the scope of the invention. Unless otherwise stated, the processes described herein are unordered—that is, the processes can be performed in any reasonable order.

All steps described herein will be understood by those skilled in the art as being capable of implementation by software, where feasible. Moreover, such software will be understood by those skilled in the art to be storable on a non-transitory computer readable medium and implementable by one or more computer processors.

### Appendix A

### Exemplary financial Personality Questionnaires

An optimal wealth management strategy requires a strong understanding of your circumstances, goals and personality. As financial advisors we aim to reflect the individuality of each client by providing the best recommendations and services possible. Here is how we can help.

We first explore your Financial Personality—personality traits which influence how you feel about risk, approach financial decisions and evaluate investment performance. These personality traits are subtle and complex, and have serious implications for your optimal investing strategy. Developed from proprietary psychometric research performed by Barclays Wealth's specialized Behavioral Finance team, the personality traits go beyond your attitudes toward risk and reward to give a high-resolution portrait of your individual, inherent responses to financial decision making.

The six personality dimensions are only part of the picture however—to ensure comprehensive wealth management we must also understand your circumstances and your investment objectives. Completing this questionnaire in full will accelerate your Investment Representative's understanding of how to create your individually tailored wealth management strategy.

Responding to the Questionnaire

Consider your entire wealth when answering: Your financial personality is about you, not your wealth. When responding to the questionnaire express how you feel as a person, regardless of what portion of your wealth we are managing.

Give your intuitive natural response: It is important that you answer each question honestly. The more accurate your responses are, the more meaningful our recommendations will be. There are no right or wrong answers so just respond in the way that feels most natural to you.

If your needs change over time, please let us know as soon as possible. Our ability to provide suitable recommendations, information or investment advice is dependent upon up-to-date information. The information you provide will not be sold to other organizations, and will be stored securely with your customer record/profile.

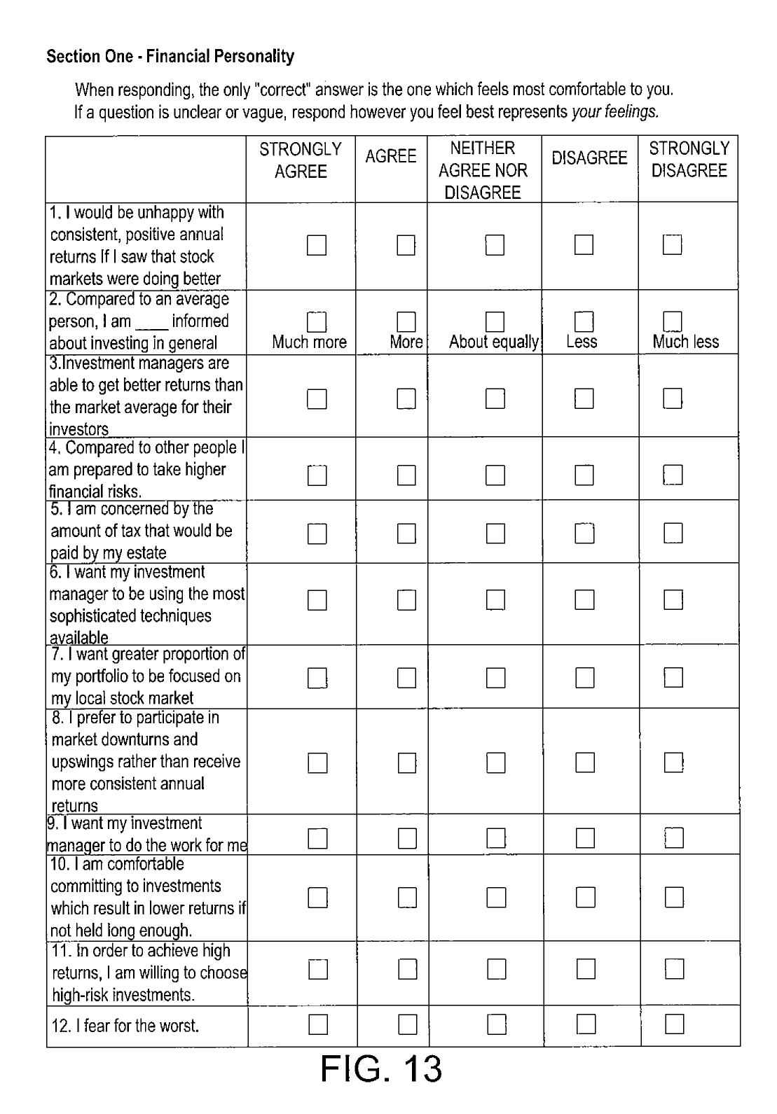

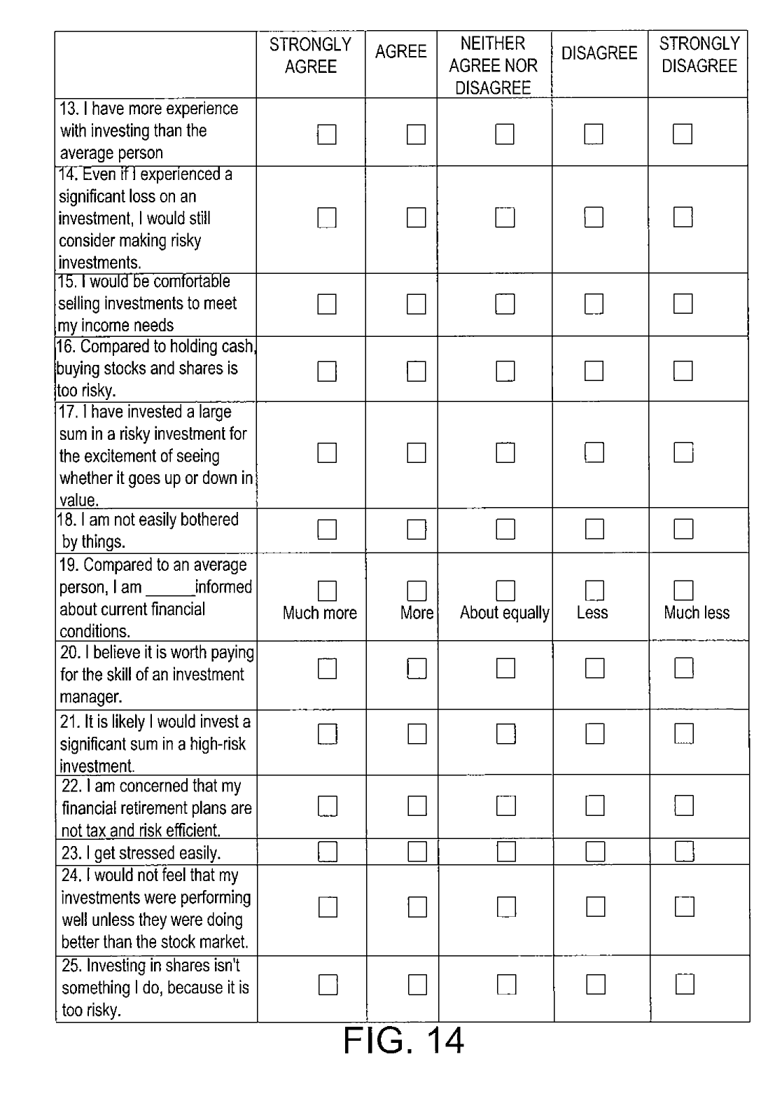

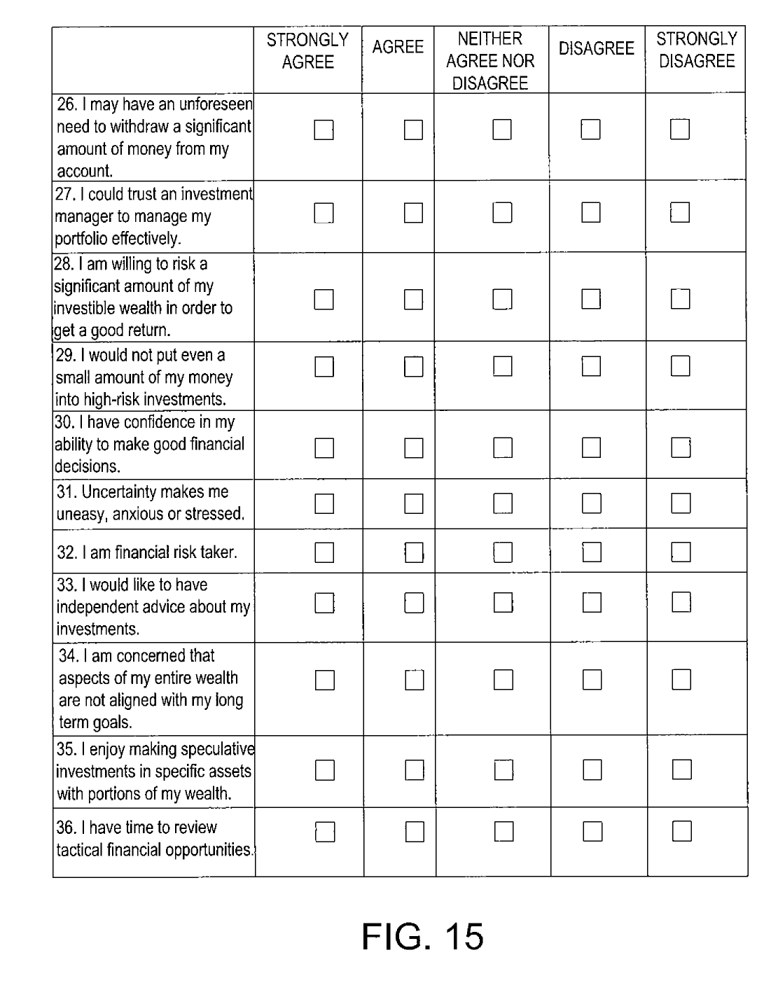

Please ensure that this document is returned to us through a reliable means of communication.

[FIGS. 13-19 depict exemplary pages of a first exemplary Questionnaire.

FIGS. 13-15 depict an exemplary Section One, which comprises 36 questions related to financial personality.

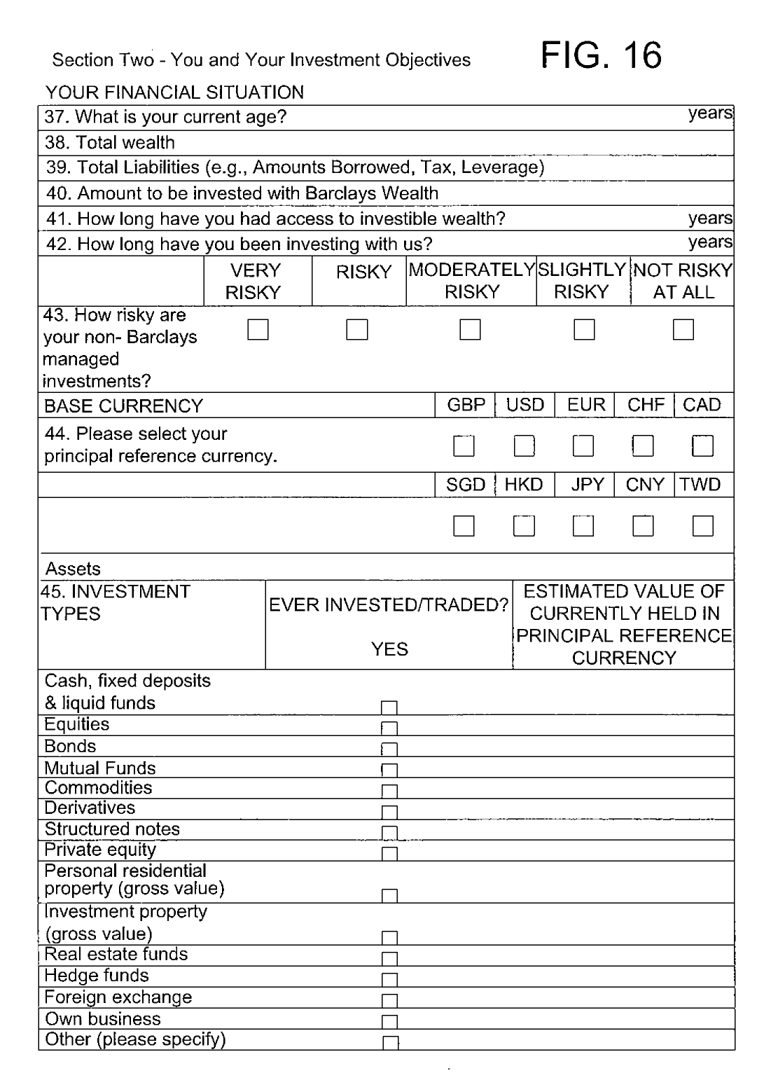

FIGS. 16-18 depict an exemplary Section Two, related to investment objectives.

FIG. 16 depicts a page comprising: Questions 37-42, related “Your Financial Situation”; Question 43, related to riskiness of non-Barclays managed investments (i.e., investments managed by another firm); Question 44, related to base currency, and Question 45, related to investment types.

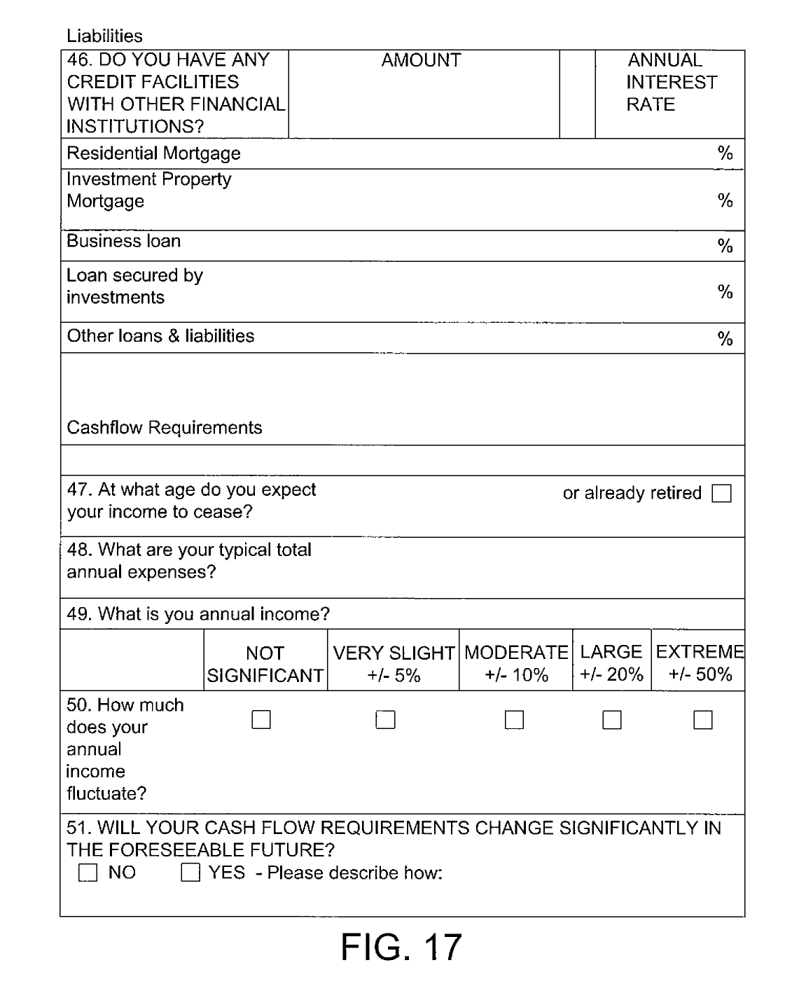

FIG. 17 comprises Question 46, related to Liabilities, and Questions 47-51, related to cash flow requirements.

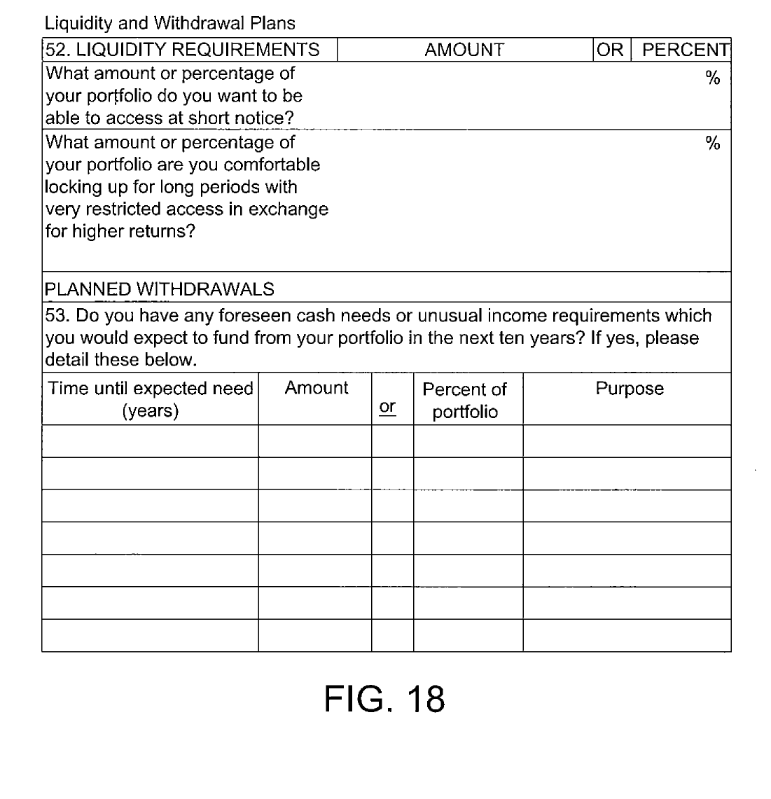

FIG. 18 comprises Questions 52 and 53, related to Liquidity and Withdrawal Plans.

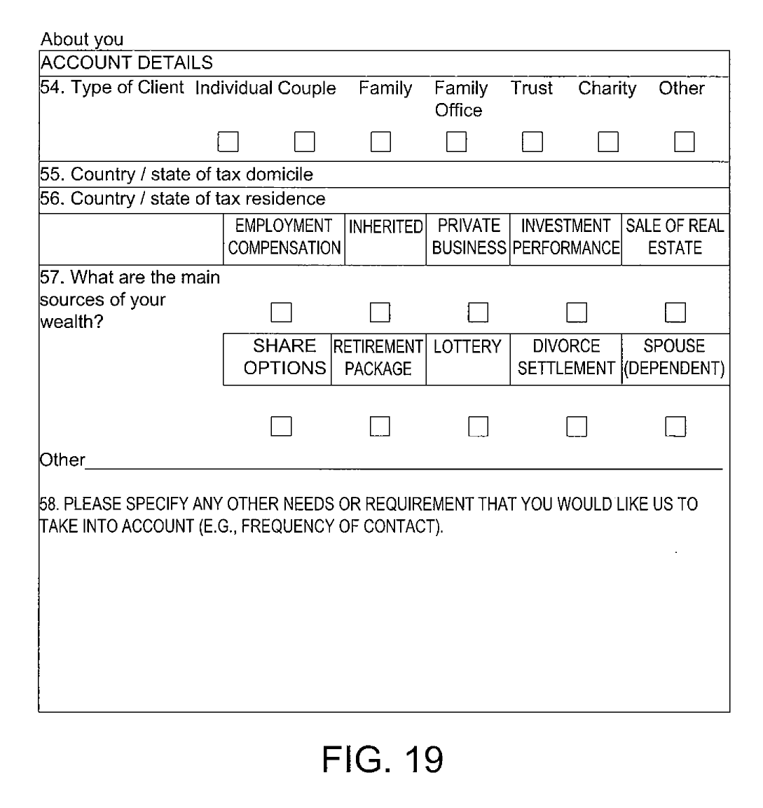

FIG. 19 comprises Questions 54-57, in an “About you” section.

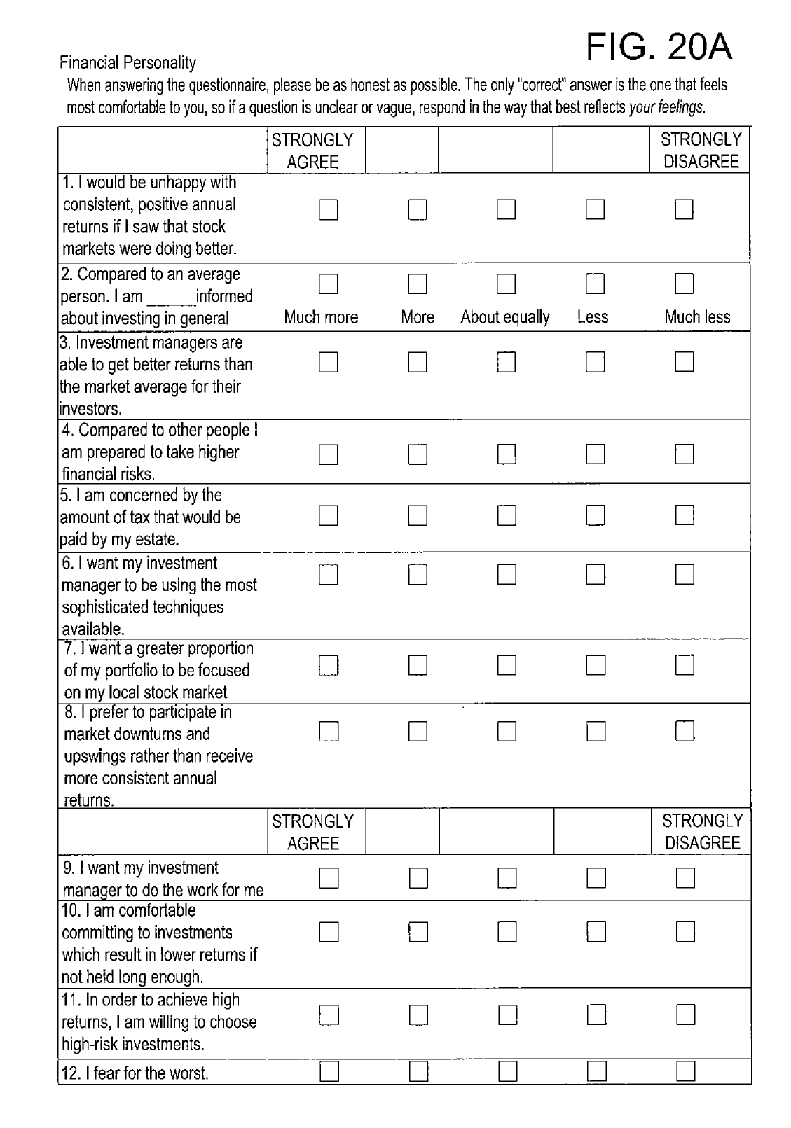

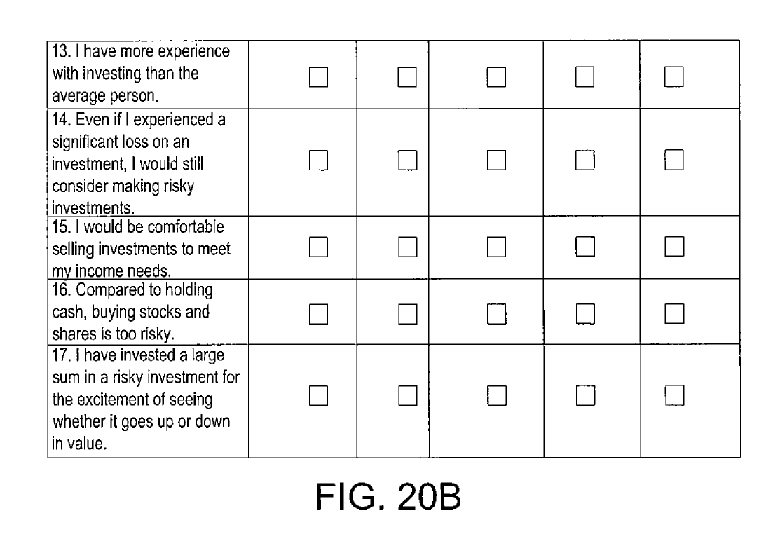

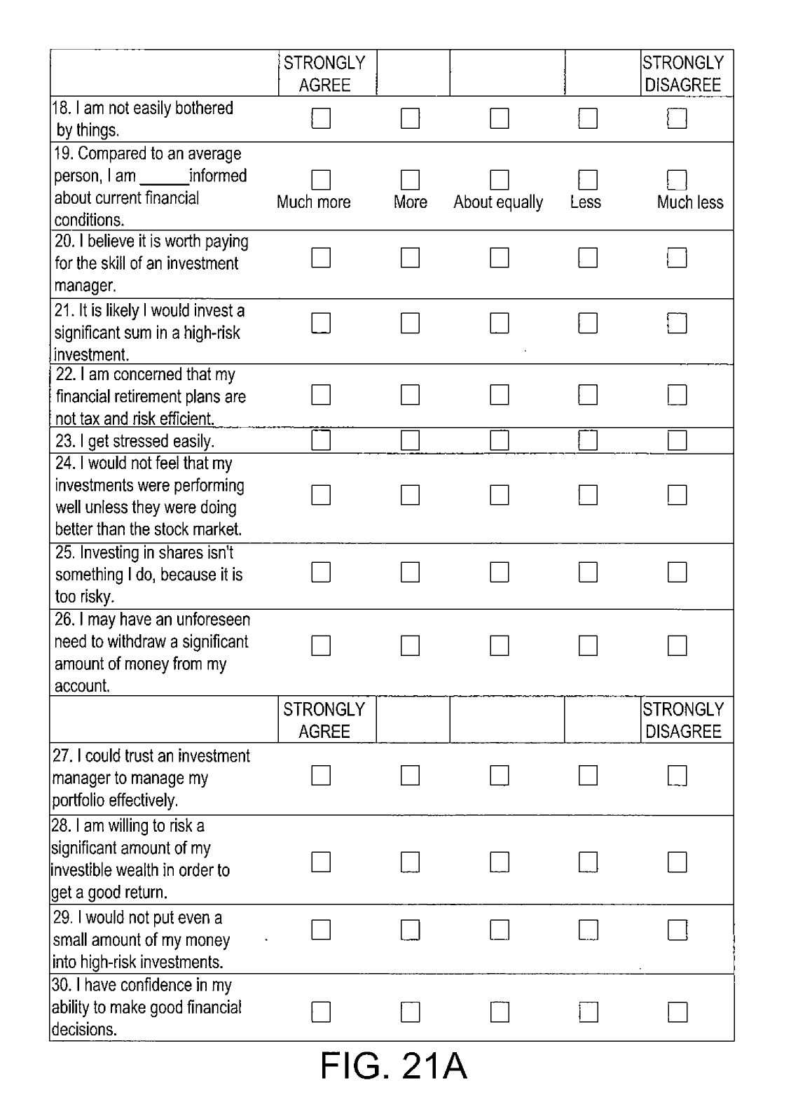

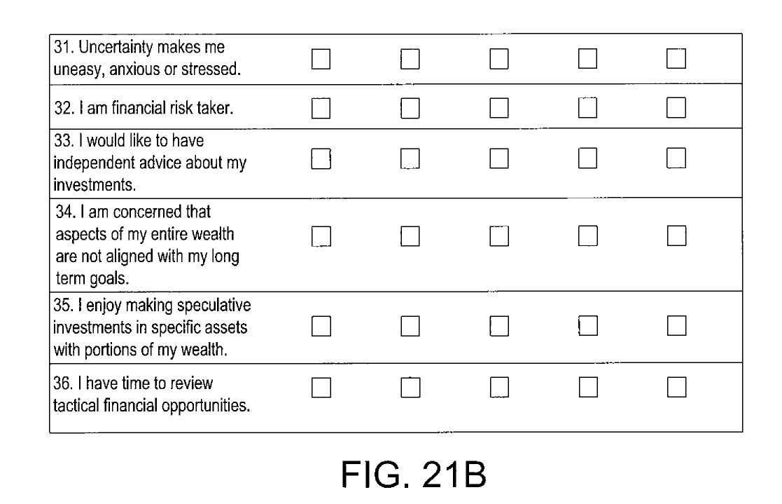

FIGS. 20 and 21 depict exemplary pages of a second exemplary Questionnaire.]

End of Appendix A

### Appendix B

### Exemplary Client Financial Personality Assessment Report [For Client]

Thank you for taking the time to complete the Barclays Wealth Financial Personality Questionnaire. The responses you provided have helped us to determine the characteristics your portfolio should have in order to match your financial personality and objectives. This profile measures six traits that describe your financial personality, and relates the implications of each of these to the optimal management of your portfolio.

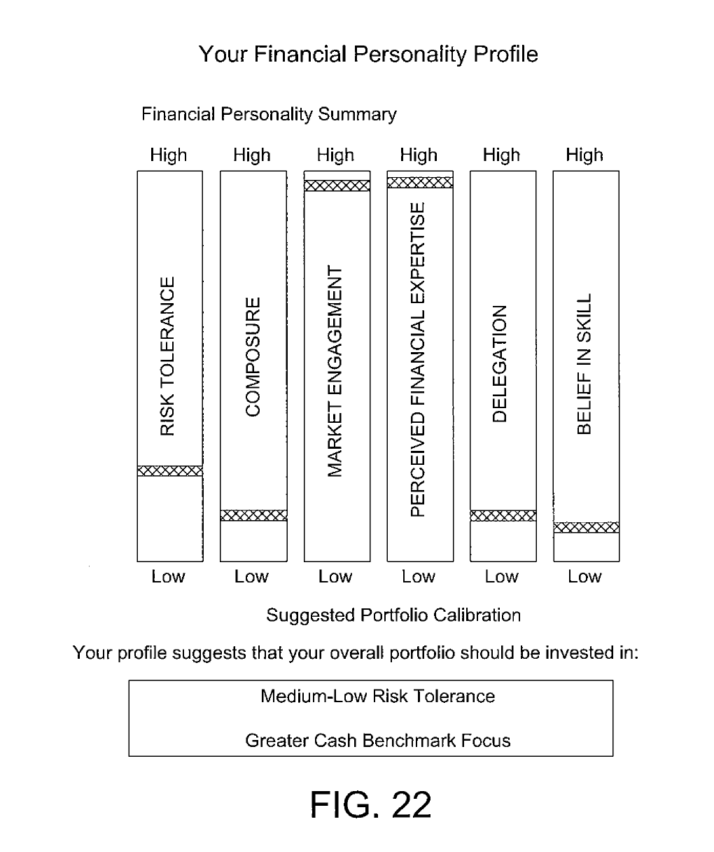

We present each of these key dimensions in turn, explaining for each the implications of scoring low or high on that dimension. Then we present your score on that dimension, which shows how you rate relative to the population as a whole, and discuss the implications of this for you personally. [See FIG. 22.]

Finally we use this information to make broad suggestions for your portfolio allocation which we believe will suit your financial personality. This profile should be taken as a guideline rather than a specific recommendation and should be viewed in the context of your complete financial circumstances and investment objectives.

Suggested Portfolio Calibration.

Your profile suggests that your overall portfolio should be invested in:

TABLE 23

Medium-Low Risk Tolerance
Greater Cash Benchmark Focus

What is Risk Tolerance?

In building your portfolio we try to think about risk in the way it is meaningful to you. Our psychological risk tolerance measure is an expression of the average level of returns required to make you comfortable with taking on the chance of future losses in your portfolio. While it is a natural instinct to avoid the possibility of something bad happening, you might be willing to take on more risk if the expected gains are higher. It is how you reconcile these two desires—your desire to avoid losses, and your desire for gains—and how you trade them off that we measure with your risk tolerance.

Individuals with high risk tolerance are more likely to accept the possibility of losing some of their wealth so that they can access the types of investments which might also achieve very high returns. People with a low score on this scale are much more likely to be conservative in their trade off between potential gains and losses. They will accept smaller potential gains so they can be confident of not losing a significant portion of their wealth—they sacrifice the chance of extremely high returns in exchange for secure and stable returns.

Your risk tolerance score indicates which goal it is rational for you to pursue for the long-run optimization of your portfolio. This guides us on how to construct a portfolio of assets on your behalf that, at the end of your investment horizon will deliver to you the best possible expected returns, subject to the amount of psychological risk you are naturally comfortable with taking on.

It is important to note that your risk tolerance score describes your overall psychological tolerance to risk and is not specific to the assets you hold or plan to hold with Barclays Wealth. You may hold assets elsewhere which are more risky than your risk tolerance profile, or you may already be taking on financial risk in your day-to-day business or entrepreneurial activities. Conversely you may already be holding a large portion of your wealth in very safe assets and intend to keep it there, or you may have a very stable business income or salary for many years to come. When we optimize your investments, we will consider the risk characteristics of the assets you hold with Barclays Wealth and those you tell us you hold elsewhere, as well as your income stability. This means when we invest for you, we may need to place some assets above or below the risk tolerance. This is appropriate in creating an overall portfolio to deliver the maximum potential returns for your tolerance to risk.

Your Risk Tolerance: Medium-Low

You are likely to be comfortable with making investments which may have limited potential for losses in exchange for higher returns. You want better returns than those offered by a bank or building society savings account and are prepared to put a part of your money in market investments to achieve this. While the possibility of small fluctuations in your wealth does not bother you, you are averse to investments with a possibility of falling substantially in value by the end of your intended investment period. You would be happier with a steadier but lower rate of growth than a higher but more volatile one. You accept this limits the potential for your money to grow, and there is a possibility your wealth may not maintain its spending power.

What is Composure?

Individuals with lower scores in this dimension will appreciate more stable returns, as they place higher value on the emotional stability they get from certainty. Composure differs from risk tolerance in that it refers more to your short-term and emotional reactions to uncertainty. Your risk tolerance score gives an indication of your rational willingness to trade off an increased chance of losses for better possible returns in the long-term. Composure, on the other hand, gives an indication of how you will feel about these fluctuations in the short-term as the portfolio goes up or down. Those with low composure are likely to experience more emotional stress from uncertainty, and also to worry more about short-term decreases in the value of their portfolio. They are likely to monitor their portfolio more frequently and thus perceive portfolio outcomes on an artificially short timeframe, which exaggerates the proportion of losses relative to that they would see if focused rationally on a longer term time horizon.

It is quite possible for two investors to have the same degree of risk tolerance for long-run portfolio outcomes, but that one feels far more day-to-day worry than the other in the interim periods. Some investors may therefore become stressed or anxious by the day-to-day fluctuations in the value of their portfolio despite being happy with the potential risk and return trade-off over their investment time horizon.

Another common tendency is for investors to focus quite narrowly on individual components of their portfolios, rather than monitoring the overall performance. This can lead one to perceive losses in parts of the portfolio, even while the overall portfolio is going up in value. Investors with lower composure are more likely to observe and worry about these component losses—again the proportion of losses is exaggerated, which leads to dissatisfaction with the performance of the portfolio as a whole, even if it is ideally suited to reaching your long-term objectives.

Keeping your investment focus on the long term or overall portfolio can help to overcome the stress often associated with low composure. On the other hand if you monitor your portfolio too frequently, expect results over too short a time horizon, or if you focus very narrowly on individual components of your portfolio, you will be likely to observe a higher proportion of short-term losses than you would if you frame your investments more broadly.

Your Composure: Medium-Low

You are more sensitive to uncertainty than many individuals, even when you can do little to influence future outcomes. While this is a very useful trait in helping us plan, prepare, and react more quickly to negative outcomes, it can cause a number of problems with the way we perceive investment performance. You may need to manage your own expectations and remind yourself investing is a long-term activity, and there will necessarily be downs as well as ups.

You will be more unsettled by short-term fluctuations in portfolio values than I most individuals. If you monitor your portfolio's performance more frequently than necessary, you may misperceive the risk you have taken on in your portfolio. You are not alone in this. It is common for individuals to over-monitor the performance of their portfolio, and as a result focus unduly on short-term fluctuations which are irrelevant for their investment performance in the longer run. This pushes them to take on less risk in their portfolio than is optimal for their time horizon, and their final portfolio values reflect this.

Similarly, individuals find it difficult to mentally aggregate all of the separate components of wealth. For example, if one particular component or investment is riskier than others, they tend to react disproportionately to losses in this part of the portfolio in isolation, rather than consider that these losses might be offset by gains in the wider portfolio. We do not suggest putting any component of your portfolio at higher risk levels than indicated by your risk profile, even if it is balanced by low risk investments elsewhere.

What is Market Engagement?

Market Engagement measures the degree to which an individual avoids or is comfortable with risk specifically in financial markets. This measure acts as an indicator of whether an individual has a stronger apprehension to investing in financial markets than others. Some individuals have a belief that investing in markets is not an activity for them even though it may be appropriate for their risk tolerance and long-term investment objectives. We can address fears of losing significant portions of your wealth by increasing the protective buffer in your investments, allowing you to take on the appropriate risk in your core portfolio.

Lower scores on this scale suggest higher emotional discomfort with market linked investments. This discomfort could arise from a number of sources:
you could be a risk taker in other aspects of your professional life, but be uncomfortable with financial markets (e.g., businesspeople or entrepreneurs in the non-financial sectors, or real estate investors);
you could feel your knowledge of financial instruments is insufficient to take on financial decisions with confidence; you could be worried that although you are happy to take on known risks, you would be worried that financial investing will expose you to unexpected or hidden risks;
you could simply have insufficient time or incentives to undertake the effort you feel would be necessary before taking that first step into financial markets;
avoidance of financial markets could also be an indication of a negative outlook for markets in the near term.

Whatever the reason, if you have a low score it is likely you will be avoiding financial markets. In order to invest you would require greater certainty that you won't suffer unexpectedly large losses. This can be achieved by structuring your investments to give you greater protection thereby limiting the potential for any unwelcome negative surprises.

If you have a high score on this dimension investing in financial markets does not appear significantly more risky to you than other activities, and you are likely already comfortable with the risks you are taking on by investing directly in financial markets.

Your Market Engagement: High

Your responses indicate you are willing to participate in markets, as long as the risk/return features of an investment are appropriate. You recognize that by investing, you can put your wealth at risk only up to the level that is appropriate for your level of risk tolerance. However, you are comfortable with this because you understand the benefits of accepting market fluctuations in exchange for the opportunity to increase your wealth in the long-term. You feel sufficiently comfortable with financial investing to engage with markets without worrying you might be taking on unseen risks beyond your risk tolerance levels.

What is Perceived Financial Expertise?

The perceived financial expertise dimension assesses how familiar and informed you feel with current financial circumstances, with how financial products work, and how confident you feel in your own financial knowledge relative to the average person.

Just as not everyone has been through medical school. but most people have a basic knowledge of how to be healthy, our scale is designed to assess how much financial familiarity you perceive yourself to have compared to the general level of the population. You may:
be more informed than most people on current financial events;
have worked in finance but have not personally traded before;
be very familiar with specific types of investment. such as property, but not familiar with the stock market.

However, in all cases, when it comes to making important decisions about your wealth you may still want some professional guidance.

Individuals who perceive their knowledge to be high are more comfortable expressing their financial preferences and experiences than those who perceive their level of knowledge to be low. A greater intuitive understanding of risk is often associated with having made and experienced investments previously. On the other hand, low knowledge often means individuals keep their investments very simple.

Luckily, having a low perception of your financial knowledge is also one of the easiest issues for you to address. A better understanding of investments will help you express your preferences with more clarity, which will help us craft a more sophisticated and appropriate wealth solution for you.

Your Perceived Financial Expertise: High

You are fairly familiar with financial markets and investments, and are likely to have already engaged with and experienced a range of market investment instruments, or have some knowledge about investing. As your perceived financial expertise is medium-high, your risk tolerance is likely to have already settled to a stable level. You are therefore better able to gauge and make informed decisions regarding the level of risk you are prepared to take on.

What are Delegation and Belief in Skill?

The delegation and belief in skill scales assess:
how much an individual believes they can benefit from delegating aspects of their financial management to professionals:
how much value those professionals can add.

The two aspects are closely related. We measure them separately, although the majority of people have similar opinions on both of the subscales.

The first aspect is the belief that delegating the day-to-day decisions of managing your portfolio to someone else is beneficial. A high score on this dimension indicates a desire to have the effort of managing your investments taken off your hands, and also reflects a degree of trust in your investment manager to do the job effectively. A high scorer is also more likely to value independent investment advice. A low score on the other hand indicates an investor who wishes to take a hands-on role in their investments, and feels less need for investment advice. Interestingly this scale is relatively unrelated to perceived financial expertise—people who have high perceived financial expertise are just about as likely on average to want to delegate their investment management and seek advice as they are to want to keep hold of the reins themselves.

The second aspect is the degree to which the investor believes it is worth paying for the ability of an investment professional to make above-market returns. People with a low score on this scale will be less interested in their investment manager using sophisticated techniques to try to beat the market and prefer a low cost diversified basket of investments tracking the overall performance of the market. Their portfolio will therefore merely track the average market performance in either good or bad years. High scorers on the other hand tend to believe that the right investment manager can and will be able to outperform the market average in both good and bad years. They may also be interested in the use of investment skill to smooth over market fluctuations throughout the cycle.

In most cases an individual's desire to delegate their financial management and their belief in investment skill are closely related to one another—people tend to have similar scores on both. In a few people, however, opinions about these two dimensions differ, indicating the individual has a strong belief about one dimension or the other. We show each of these two closely related dimensions on their own to aid comparison.

Your Delegation: Low

You have a low desire to delegate responsibility for your financial matters to someone else. You are likely to want to keep hands-on control of your investments, be continually informed of the performance of your portfolio, and prefer to make investment decisions yourself. You are likely to be wary of advice, and possibly somewhat skeptical that investment managers will make decisions on your behalf that are in your best interests.

Your Belief in Skill: Low

You have a low belief in investment skill. You feel professional investors are unable to consistently beat the market average and are wary of active portfolio management and sophisticated investment techniques. You may feel you can make investment decisions adequately yourself. or paying for professional investment management does not add sufficient value relative to tracking market indices.

Your Financial Personality Summary

The blue [light gray] markers on the graph [not shown] show where you lie on each scale, relative to the population as a whole. Your unique pattern has been used to provide guidance on the type of portfolio most suitable for you. Your Investment Representative will use this information, in the context of your existing portfolio and discussed investment objectives to deliver a detailed portfolio allocation.

Distinctive Features of Your Financial Personality

You find uncertainty unsettling and you have a particular desire to shelter yourself from large fluctuations in the value of your wealth. This is linked to your relatively low risk tolerance which suggests you are more comfortable with limiting your potential gains from investing if you can limit the potential losses. These features of your personality are unusual when considered alongside your relatively high perception of your financial expertise and your willingness to invest in financial markets. Your higher levels of perceived financial expertise indicates you understand the risks involved with investing and are happy with the trade-off implied by your low risk tolerance. When individuals are profiled, the two strongest differentiating factors are risk tolerance and delegation. Your combination of low risk tolerance and low delegation suggests you are willing to take on a low degree of risk and but at the same time want to retain overall control of your financial arrangements. Many individuals find that the types of investments classified as low-risk are often more familiar to them. This means they can be confident their decisions are at least as good as those of investment professionals, and they can retain control of their portfolio.

Advice Based on Your Financial Personality

Barclays Wealth believes that the most successful and satisfied investors are those whose portfolios are aligned with their financial goals ad financial personality. For this reason, we ask our clients to provide detailed information about their current financial circumstances and long term goals, and to complete our Financial Personality Assessment. We use this information in two broad ways: to recommend a general Structure of Wealth and specific investments.

The Structure of Wealth

We advise our clients to divide their wealth into three broad categories: Cash, an Allocated Portfolio, and a Guided Portfolio.

The cash portfolio provides a protective buffer, and meets routine and unexpected spending needs.

The allocated portfolio should be viewed as a core, diversified long-term holding. Therefore, an investor's “strategic” mix of assets in this portfolio should be stable over time, governed in large part by the particular investor's risk tolerance. Occasional “tactical” shifts among the asset classes in the portfolio aimed at taking advantage of market opportunities or defending against unusual near-term risks may improve this portfolio's performance.

The guided portfolio includes two types of investments: individual transactions aimed at expressing a specific investment idea and longer-term, usually illiquid investments or strategies that Barclays Wealth recommends and that the client agrees are attractive.

The relative sizes of the cash, allocated, and guided portfolios reflect your financial situation and personality. For example:
Clients whose Market Engagement is lower will feel more comfortable maintaining a more substantial buffer in the cash pot.
An investor with low Delegation and sufficient Perceived Financial Expertise will want to take active investment decisions and should maintain a relatively large guided portfolio with most of the assets dedicated to individual transactions.
A highly composed, risk-tolerant investor with limited liquidity needs and a strong belief in skill might also have a large guided portfolio, but one allocated mostly to private equity.

Investment Selection

Any specific investment—a particular equity portfolio manager, structured note, equity market neutral hedge fund, real estate partnership, or so on—can be viewed as a bundle of characteristics (e.g., volatility, liquidity, transparency, etc.). Any given combination of characteristics might be very attractive to one investor but inappropriate for another. What will serve any investor best over time depends on his or her financial personality.

Within your Allocated and Guided portfolios there are four distinct dimensions we consider when pulling together your portfolio:

1. Performance Focus: Are you more focused on how well your portfolio performs relative to cash, or relative to how well the market is performing? Those with a market benchmark focus may be happy with a small decline in their portfolio value if the market is down further. Those with a cash benchmark will be upset whenever they lose money and should be willing to accept poor relative performance when markets are up.

2. Composure: If you have lower Composure it makes sense to build your portfolio using components that provide a smoother journey over time, have a smaller chance of any big short term drops, and also have greater liquidity to give you comfort that investment decisions can be reversed quickly. The higher your Composure the less we constrain the range of your investments and the more we concentrate on the long-term. We may also take on some less liquid investments to enhance long-term prospects.

3. Belief in Skill: If you have higher Belief in Skill we will recommend active managers and strategies in whom we have confidence. If you have lower Belief in Skill you will prefer lower cost index type investments, even though these will not outperform the market in the long term.

4. Market Engagement: Finally, if you have lower willingness to engage with financial market risks then you may be particularly concerned about the chance of extremely bad events dramatically affecting the value of your portfolio. In addition to increasing the size of the Cash Portfolio we may also suggest that you ‘buy’ some form of portfolio insurance.

Matching each client with the appropriate combination of investments is and always has been an art. We believe that by thinking more systematically about each investor's financial personality we can enhance our art with psychological science and serve our clients better than we have been able to in the past.

Risk Profile Definitions

These are the definitions of our five risk profiles.

Low (Profile 1): You are uncomfortable with investments which may put you at risk of losing money and spending power, and will accept a lower return over the long-term in exchange for minimizing the chance of negative outcomes. This does not mean you wish to stay away from market investments altogether or to hold your wealth solely in cash deposits. You may be happy to participate in the financial markets (see your score on the market engagement scale) but you have a strong preference for these investments to be carefully controlled with fairly certain future outcomes. You evaluate investments largely by how safe your money is and by the predictability of future returns. in particular you are keen to avoid any possibility of significant losses to the spending power of your capital and are comfortable this means your long-term level of return is unlikely to be very much higher than that offered by a bank savings account But with rates of return this low there is a possibility that your wealth may not maintain its spending power due to inflation.

Medium-Low (Profile 2): You are likely to be comfortable with making investments which may have limited potential for losses in exchange for higher returns. You want better returns than those offered by a bank or building society savings account and are prepared to put a part of your money in market investments to achieve this. While the possibility of small fluctuations in your wealth does not bother you, you are averse to investments with a possibility of falling substantially in value by the end of your intended investment period. You would be happier with a steadier but lower rate of growth than a higher but more volatile one. You accept this limits the potential for your money to grow, and there is a possibility your wealth may not maintain its spending power.

Moderate (Profile 3): You are comfortable with investments which may lead to some fluctuations in the value of your portfolio in exchange for the opportunity to achieve above average increases in your wealth in the medium to long run. You want the real value of your investments to increase, or your income to maintain its spending power over time. You are happy to put some of your money into market investments with the aim of getting a better return, and accept you could make a loss on the money you invest.

Medium-High (Profile 4): You are prepared to accept regular fluctuations in the value of your portfolio and are willing to take on higher risk than other people in exchange for the opportunity to increase your wealth in the long run. You are aware that to achieve higher returns you will need to put a significant part of your portfolio in market investments. Your money could be subject to significant short-term fluctuations in value, and the potential for long-term gain and loss are both greater.

High (Profile 5): You are comfortable with significant short-term fluctuations in the value of your investments in exchange for superior returns over the long-term. You recognize your investments will be linked to various markets, possibly with some exposure to high risk/high returns markets (e.g., emerging economies). There is a possibility you may not get back as much money as you put in, but also a possibility that your wealth will increase substantially. This is a trade-off you accept and welcome.

[Exemplary] Legal Section

The services mentioned in this document may not be suitable for all investors. Investors are urged to consult their own tax or legal advisors with respect to the impact on their personal situation of any potential strategy or investment. This document does not purport to identify or suggest all the risks direct or indirect that may be associated with any financial instruments discussed in this document.

Although information in this document has been prepared from sources believed to be reliable, we do not represent or warrant its accuracy, and such information may be incomplete or condensed. This document does not constitute a prospectus, offer, invitation or solicitation to buy or sell securities and is not intended to provide the sole basis for any evaluation of the securities or any other instrument, which may be discussed in it. All estimates and opinions included in this document constitute our judgment as of the date of the document based on, among other sources, your responses to our financial personality questionnaire and may be subject to change without notice and on the basis of any other information you provide to us. This document is not a personal recommendation and you should consider whether you can rely upon any opinion or statement contained herein without seeking further advice tailored for your own circumstances. Neither Barclays Wealth nor any officers, directors, partners or employees of any of the entities trading as Barclays Wealth accept any liability whatsoever for any direct or consequential loss arising from use by you of this document or its contents.

This document is confidential and is intended solely for the addressee(s). If you are not an addressee, or have received this document in error, please notify the sender immediately, destroy it or delete it from your system and do not copy, disclose or otherwise act upon any part of it or its attachments. It may not be reproduced or disclosed (in whole or in part) to any other person without our prior written permission. Law or regulation in certain countries may restrict the manner of distribution of this document and persons who come into possession of this document are required to inform themselves of and observe such restrictions. We or our affiliates may have acted upon or have made use of material in this document prior to its publication. Not all products and services are available in all locations and there may be restrictions on dealing with residents and nationals of some countries.

IRS Circular 230 Disclosure: Barclays Capital Inc. and its affiliates do not provide tax advice. Please note that (i) any discussion of US tax matters contained in this communication (including any attachments) cannot be used by you for the purpose of avoiding tax penalties; (ii) this communication was written to support the promotion or marketing of the matters addressed herein; and (iii) you should seek advice based on your particular circumstances from an independent tax advisor.

The Financial Personality Assessment assists our investment representatives in providing a portfolio allocation to our clients. This financial tool is offered to clients or prospective clients as a brokerage service, and mayor may not be a part of a comprehensive financial plan. In providing this tool, Barclays Capital Inc. is acting as a broker/dealer.

Thereafter, if clients choose to implement these portfolio allocations, Barclays Capital Inc. will be acting solely as a broker-dealer, not as an investment adviser (unless otherwise agreed in writing). In executing transactions for client accounts in accordance with client instructions, Barclays Capital Inc., as a broker-dealer, may act as agent or as principal for its own account.

Barclays Capital Inc. is both a broker-dealer and an investment adviser, and it offers both brokerage and investment advisory services. There are important differences between brokerage and investment advisory services, including the type of advice and assistance provided, the fees charged, and the rights and obligations of the parties. Brokerage services are regulated under different laws and rules than advisory services. It is important for clients to understand these differences, particularly when determining which service(s) they might select. For additional information, please contact your investment representative.

Based on your recommended portfolio allocation, your Barclays Wealth Investment Representative may recommend that you become a client of the Barclays Wealth or one of its affiliated entities. Your Barclays Wealth Investment Representative will receive additional compensation in consideration for referring you to a Barclays Wealth affiliate.

End of Appendix B

### Appendix C

### Exemplary Investment Process and Portfolio Recommendations [For Client]

### Wealth Management Process

A disciplined wealth management process maximizes the probability of achieving both short and long-term objectives:

TABLE 25

| You and Your | Advice with a | Tailored Portfolio | Customized |
|---|---|---|---|
| Wealth | Global Perspective | construction | Account |
| TOTAL WEALTH | RESEARCH AND | IDENTIFYING THE | REBALANCING |
| REVIEW | STRATEGY | RIGHT ASSET | Adapting your |
| Understanding you | Understanding the | ALLOCATION FOR | portfolio to the |
| overall financial | global economy | YOU Using your | changing |
| situation and how | and financial | unique financial | environment |
| you intuitively | markets from a | personality to | |
| group your wealth | private client | determine the asset | |
| | perspective | allocation that best | |
| | | suits your long-term | |
| | | risk tolerance | |
| FINANCIAL | ASSET | FINE-TUNING: | MONITORING |
| PERSONALITY | ALLOCATION | SELECTING THE | AND REPORTING |
| ASSESSMENT | Creating optimal, | RIGHT | Evaluating the |
| Understanding how | diversified modest | IMPLEMENTATION | performance of all |
| you are unique | portfolios that | Implementing | of your investments |
| | guide customized | personalized | in the context of |
| | asset allocation | investment selections | your situation |
| | | to align your asset | |
| | | allocation to other | |
| | | facets of your | |
| | | financial personality | |
| Consult → | Advise→ | Implement→ | Review→ |

Asset Allocation Modeling Process

Our strategic and tactical asset allocation combines advanced financial modeling with the experience of our Investment Committee.

Black-Litterman methodology was first developed in the 1990s. It addresses weaknesses of traditional optimization such as over-reliance on subjective views and the need for excessive constraints in modeling.

The strategic asset allocation is a reference portfolio, comprised of our universe of asset classes weighted by each asset class's global market capitalization.

Investment Committee members from the Barclays Group express their qualitative views based on Barclays proprietary research. The Committee's views are applied to the strategic asset allocation to determine how the current market environment may affect asset classes over the next year.

The portfolio is optimized according to the views of the Committee with respect to risk, return and correlation of asset classes.

This results in larger/smaller positions in each asset class, market or region (compared to the initial benchmark allocation).

### Model Portfolios: A Starting Point

TABLE 26
Overweights/Underweights

| Q1 2010 | | Moderately | Aggressive | Overweight/ |
|---|---|---|---|---|
| Asset Class | Benchmark | Baseline | Tactical | Underweight |
| Cash | | 0.0% | 0.0% | 0.0% |
| Cash | Barclays Capital US Short Treasury | 0.0% | 0.0 | 0.0% |
| | 3-6 month | | | |
| Leverage | 1-month LIBOR plus spread | 0.0% | 0.0% | 0.0% |
| Currency | Inverse FRB Trade Weighted Dollar | 0.0% | 0.0% | 0.0% |
| | TR | | | |
| Fixed Income | | 10.0% | 4.0% | −6.0% |
| Short Government | Barclays Capital 1-5 year | 6.5% | 2.0% | −4.5% |
| | government index | | | |
| Long government | Barclays Capital 10-20 year | 1.5% | 0.0% | −1.5% |
| | government index | | | |
| US TIPS | Barclays Capital US TIPS index | 0.0% | 0.0% | 0.0% |
| US CREDIT | Barclays Wealth Custom US Credit | 2.0% | 2.0% | 0.0% |
| | Index | | | |
| Equity | | 53.0% | 62.5% | 9.5% |
| US Lg. Cap | Russell 1000 Total Return | 18.0% | 20.5% | 2.5% |
| Equity | | | | |
| US Smid Cap | Russell 2500 total return | 10.0% | 14.5% | 4.5% |
| Equity | | | | |
| MLPs | Alerian MLP Index | 0.0% | 0.0% | 0.0% |
| Non-US | MSCI EAFE ex Japan Total Return | 16.5% | 20.0% | 3.5% |
| Developed Equity | | | | |
| ex Japan | | | | |
| Japan Equity | MSCI Japan Total Return | 5.5% | 5.5% | 0.0% |
| Emerging Equity | MSCI Emerging Markets ex Asia | 1.5% | 1.0% | −0.5% |
| ex Asia | total Return | | | |
| Emerging Equity | MSCI Emerging Markets Asia total | 1.5% | 1.0% | −0.5% |
| Asia | Return | | | |
| Alternatives | | 27.0% | 26.0% | −1.0% |
| Multi-market | HFRI Global Macro | 9.0% | 9.0% | 0.0% |
| Directional | | | | |
| Market Neutral | HFRI Custom Index | 6.0% | 5.0% | −1.0% |
| Arbitrage | | | | |
| Private Equity | Thomson PE Index | 12.0% | 12.0% | 0.0% |
| Commodity | | 5.0% | 5.0% | 0.0% |
| Commodities | DJ UBS Commodities Index | 5.0% | 5.0% | 0.0% |
| Real Estate | | 5.0% | 2.5% | −2.5% |
| Public Real Estate | NAREIT | 5.0% | 2.5% | −2.5% |
| Private Real Estate | MIT Transactions-based RE Index | 0.0% | 0.0% | 0.0% |
| | | 100.0% | 100.0% | 0.0% |

Note:
These are asset allocation recommendations for a Moderately Aggressive portfolio based on the views of the Barclays Wealth Global Investment Advisory Committee; these views. by their nature, are subject to change without notice.

### Tactical Asset Allocation Performance

### Notes:

Data as of Sep. 30, 2009.
*Inception date of all portfolios is Sep. 7, 2004
**These portfolios consist of global equities (50% US and 50% International) and US Investment Grade Fixed Income in the proportion given. For instance, the 65/35 portfolio is made up of 65% equities and 35% fixed income.
Tactical portfolios are constructed based on the views of the Global Investment Advisory Committee; these views are subject to change without notice.
Historical performance for each portfolio is calculated monthly as the weighted average of the respective portfolio weights and benchmark returns.
The historical performance of the asset class benchmark indices is for illustrative purposes and is not meant to forecast, imply, or guarantee performance. Indices are unmanaged and cannot accommodate direct investments.
Cumulative & Annualized Return—Calculated as product of a series of compound returns to arrive at a cumulative compound return.

### Investment Proposal and Analysis

### Your Financial Personality Profile

Profile Summary

Your financial personality profile has produced scores that are generally moderate to high on each scale. However, distinguishing features of your financial personality are your willingness to take on some risk, your perception of your financial expertise, and your desire to delegate financial decision making. You are likely to have a rational approach to investing and are able to limit the emotional influences on your investment decisions. Because of this you are comfortable taking on risks you understand. It is likely you will consider investments in financial markets because you understand that by participating in financial markets you have the potential to achieve greater returns. Your familiarity with finance will increase the range of investments you understand and would be comfortable investing in, giving you greater scope to invest in products that are appropriate for your risk tolerance. Lastly, despite your comfort with investing you have the desire for professional management and for the day-to-day decision making to be given to a full-time manager.

Investment Portfolio composition

The proposed allocation has been customized with your specific financial situation and investment objectives in mind and therefore is likely to differ from any of our “model” portfolios.

The estimated calculations for this allocation reflect the blended performance of the associated benchmarks for each included asset class.

The estimated returns generated by this asset allocation analysis are hypothetical in nature, do not reflect actual investment results and are not guarantees of future results. The hypothetical risk and return figures presented are a result of blending asset class level estimated assumptions and are exclusive of inflation. Asset class benchmark performance does not reflect the payment of any fees or commissions. * “Other” includes but is not limited to Commodities, Currency and Real Estate.

Investment Portfolio Composition and Strategy

Key Investment Themes:

1. Move portfolios to mid cycle mode

2. Seek outperformance through active management

3. Maintain selective and indirect exposure to Asian economic growth

Notes:
Central Bank rates in the developed world are close to 0%, and we expect them to stay low for the foreseeable future. Use low risk, high quality, short-duration alternatives to cash (Le. high quality corporate bonds, government guaranteed debt, or short duration municipals).
We recommend an overweight to U.S. Small Cap equities. U.S. Small Cap equities have not performed in line with expectations given data from past recoveries and the performance of equivalent securities in the UK and Europe.
One goal of the portfolio is to maintain global purchasing power. This can be achieved by holding a portion of assets denominated in foreign currencies (i.e., international equities, sovereign bonds of foreign countries, currencies, and commodities).
A diversified portfolio of commodities has historically performed well throughout recoveries as demand for raw materials increases. Strong growth in commodities-intensive Asian economies should also support continued price gains.

Manager's Portfolio Guidelines

This is not an offer, invitation or solicitation to buy or sell securities and is not intended to provide the sole basis for any evaluation of the securities or any other instrument. Any offer or sale of interests in any fund mentioned will be made only pursuant to a final offering memorandum for such fund, which will qualify in its entirety the information set forth herein.

This Implementation may not reflect the top performing managers in the future. Past performance is not indicative of future results. Asset class benchmark performance does not reflect the payment of any fees or commissions.

* “Other” includes but is not limited to Commodities, Currency and Real Estate.

Historical Performance vs. Benchmarks

Notes:

(1) Performance data shown for mutual funds, exchange-traded funds (ETFs), and exchange-traded notes (ETNs) represents past performance, net of fees and expenses, and is no guarantee of future results. Investment return and principal value fluctuate so your shares, when sold, may be worth more or less than the original cost; current performance may be lower or higher than quoted. For mutual funds, there are other share classes available; these share classes have different fees and charges and therefore different performance. Before investing, consider the fund's investment objectives, risks, charges, and expenses. For fund information, including most recent month end performance, share class information and a prospectus, please contact your Investment Representative. Please read the prospectus carefully before investing.

(2) Specific investments to be chosen and customized based on further discussion with client.

(3) Barclays Wealth's commodity offering is the Strategic Commodities Fund (LP) (“SCF”). SCF will be managed by a sub-advisor, Gresham Investment Management LLC, and will employ the Tangible Asset Program (TAP) methodology. Performance data prior to 2005 represents the largest and longest-standing Gresham account following the TAP methodology. From 2005 to fund inception, performance represents a composite of all Gresham client accounts. All data are based on gross results and do not reflect the impact of any management fees, commissions, and direct expenses associated with a commingled fund structure. These additional fees would result in lower performance results.

This is not an offer, invitation or solicitation to buy or sell securities and is not intended to provide the sole basis for any evaluation of the securities or any other instrument. Any offer or sale of interests in any fund mentioned will be made only pursuant to a final offering memorandum for such fund, which will quality in its entirety the information set forth herein.

This Implementation may not reflect the top performing managers in the future. Past performance is not indicative of future results. Asset class benchmark performance does not reflect the payment of any fees or commissions. * “Other” includes but is not limited to Commodities, Currency and Real Estate.

### Frequently Used Terminology

TABLE 27

| | |
|---|---|
| Alpha: | A manager's contribution to return performance that cannot be |
| | attributed to market performance. How the manager performed if |
| | the market has no gain or loss. |
| Annualized Return: | The average yearly return over the stated period of time. |
| Annualized Risk: | The average yearly standard deviation over the stated period of |
| | time. |
| Asset Classes: | Categories of assets - such as equities, fixed income, real estate, |
| | commodities, or alternative investments. Those within the same |
| | asset class usually perform similarly in the marketplace and are |
| | subject to similar laws and regulations. |
| Best/Worst 12 | The best/worst 12 month period of index returns over the |
| Months: | previous 10 years. |
| Beta: | A measure of the volatility, or systematic risk, of a security or a |
| | portfolio relative to the market as a whole. A beta of one is |
| | considered as risky as the benchmark and would therefore |
| | provide expected returns equal to those of the market during both |
| | up and down periods. A portfolio with a beta of two would move |
| | approximately twice as much as the benchmark. |
| Consistency: | How frequently the fund's information ratio has outperformed its |
| | peer group median - the higher the better. Calculated by dividing |
| | the number of outperforming information ratio periods by the |
| | total number of periods. |
| Up Capture: | A statistical measure used to evaluate how well an investment |
| | manager performed relative to an index during periods when that |
| | index has risen. If the index is up 10% and the manager is up |
| | 12%, the up capture would be 120%. An up capture of over |
| | 100% represents manager outperformance. |
| Down Capture: | A statistical measure used to evaluate how well an investment |
| | manager performed relative to an index during periods when that |
| | index has dropped. If the index is down 10% and the manager is |
| | down 8%, the down capture is 80%. A down capture of less than |
| | 100% represents manager outperformance. |
| Estimated Median | The predicted average return for a given period. |
| Return: | |
| Estimated Return | The range of returns expected with 68% probability given the |
| (68% Probability): | estimated median return and risk. |
| Estimated Return | The range of returns expected with 95% probability given the |
| (95% Probability): | estimated median return and risk. |
| Estimated Risk: | The predicted average standard deviation for a given period. |
| Information Ratio: | The ratio of portfolio returns above the returns of a benchmark |
| | (usually an index) to the volatility of those returns - the higher |
| | the better. Used like Sharpe ratio, but compares the manager to |
| | its benchmark instead of the risk free rate. |
| Nominal Yield: | The income return on an investment - paid out as interest or |
| | dividends - as opposed to the capital appreciation of an |
| | investment. |
| Sharpe Ratio: | The return gained per unit of risk taken - the higher the better. |
| | Can be used to compare the performance of managers: the |
| | manager with the higher Sharpe ratio would be considered less |
| | risky for the specified return than the manager with lower Sharpe |
| | ratio. |
| Standard Deviation: | A measure of how far a data set deviates from its mean. |
| Tracking Error: | A measure of how closely a security or fund behaves like its |
| | benchmark. |

### Asset Class Benchmarks and Definitions

TABLE 28

| Asset Class | Benchmark | Definition of Benchmark |
|---|---|---|
| Cash | Barclays Capital | Comprised of all treasuries with 3-6 month maturities |
| | 3-6 Month | purchased at the beginning of each month and held |
| | Treasury Index | for a full month. At the end of the month, issues with |
| | | less than three months to maturity are sold and rolled |
| | | into newly selected issues. |
| Currency | Custom Inverse | Uses 1-month forward FX rates and spot FX rates to |
| | DXY Index | measure the performance of a hypothetical currency |
| | | portfolio in which the weights of the basket of |
| | | currencies correspond to the weights of the DXY |
| | | Index. |
| Currency | Custom Inverse | Measures the approximate return on the Fed's Broad |
| | FRB Trade- | Nominal Dollar Index, a weighted average of the US |
| | Weighted Dollar | dollar against currencies of a large group of |
| | | developed and developing trading partners; |
| | | weightings are time-varying to account for |
| | | intertemporal trade variation with these nations and |
| | | regions. |
| US | Barclays Capital | Represents the portion of the US Aggregate Index |
| Government | US Government | that are US Treasury or Agency securities. Must have |
| | | at least one year to final maturity regardless of call |
| | | features. Must have at least $250 million par amount |
| | | outstanding. Must be rated investment grade |
| | | (Baa3/BBB- or higher) by at least two of the |
| | | following ratings agencies: Moody's, S&P, Fitch. |
| US | BarCap U.S. Int. | Represents the portion of the US Aggregate Index |
| Government | Gov/Credit | that includes securities in the Government and Credit |
| | | Indices. The Government Index includes treasuries |
| | | and agencies and the Credit Index includes publicly |
| | | issued US corporate and foreign debentures and |
| | | secured notes that meet specified maturity, liquidity, |
| | | and quality requirements. Must have at least one year |
| | | to final maturity regardless of call features. Must |
| | | have at least $250 million par amount outstanding. |
| | | Must be rated investment grade (Baa3/BBB- or |
| | | higher) by at least two of the following ratings |
| | | agencies: Moody's, S&P, Fitch. |
| Short- | 1-3 Yr. Treasury | Represents the 1-3 Yr component of the US Treasury |
| Duration | | index. Must have at least one year to final maturity |
| | | regardless of call features. Must have at least $250 |
| | | million par amount outstanding. Must be rated |
| | | investment grade (Baa3/BBB- or higher) by at least |
| | | two of the following ratings agencies: Moody's, S&P, |
| | | Fitch. Must have a maturity from 1 up to (but not |
| | | including) 3 years. |
| Short- | BarCap 1-Year | Represents the 1 year (1-2) component of the |
| Duration | Muni | Municipal Bond index. Rules-based, market-value- |
| | | weighted index engineered for the long-term tax- |
| | | exempt bond market. To be included in the index, |
| | | bonds must be rated investment-grade (Baa3/BBB- or |
| | | higher) by at least two of the following ratings |
| | | agencies: Moody's, S&P, Fitch. The index has four |
| | | main sectors: general obligation bonds, revenue |
| | | bonds, insured bonds (including all insured bonds |
| | | with a Aaa/AAA rating), and prerefunded bonds. |
| US | Barclays Capital | Represents securities that are US domestic, taxable, |
| Investment | US Aggregate | and dollar denominated. The index covers the US |
| Grade Fixed | | investment grade fixed rate bond market, with index |
| Income | | components for government and corporate securities, |
| | | mortgage pass-through securities, and asset-backed |
| | | securities. |
| US TIPS | Barclays Capital | This index consists of Inflation-Protection securities |
| | US TIPS | issued by the US Treasury. They must have at least |
| | | one year until final maturity and at least $250 million |
| | | par amount outstanding. They are rated investment |
| | | grade by at least two of the following ratings |
| | | agencies: Moody's, S&P, Fitch. They must be a fixed |
| | | rate, dollar denominated and non convertible. |
| US Non- | Barclays Capital | Rules-based, market-value-weighted index |
| Taxable | US Municipal | engineered for the tax-exempt bond market. To be |
| Fixed | Managed Money | included in the index, bonds must be rated Aa3/AA- |
| Income | | or higher by at least two of the following ratings |
| | | agencies: Moody's, S&P, Fitch. |
| US Non- | BarCap U.S. | Represents the 1-17 year component of the Municipal |
| Taxable | Muni (1-17) | Bond index. Rules-based, market-value-weighted |
| Fixed | | index engineered for the long-term tax-exempt bond |
| Income | | market. To be included in the index, bonds must be |
| | | rated investment-grade (Baa3/BBB- or higher) by at |
| | | least two of the following ratings agencies: Moody's, |
| | | S&P, Fitch. The index has four main sectors: general |
| | | obligation bonds, revenue bonds, insured bonds |
| | | (including all insured bonds with a Aaa/AAA rating), |
| | | and pre-refunded bonds. |
| US Non- | BarCap U.S. | Represents the 5 year (4-6) component of the |
| Taxable | Muni (4-6) | Municipal Bond index. Rules-based, market-value- |
| Fixed | | weighted index engineered for the long-term tax- |
| Income | | exempt bond market. To be included in the index, |
| | | bonds must be rated investment-grade (Baa3/BBB- or |
| | | higher) by at least two of the following ratings |
| | | agencies: Moody's, S&P, Fitch. The index has four |
| | | main sectors: general obligation bonds, revenue |
| | | bonds, insured bonds (including all insured bonds |
| | | with a Aaa/AAA rating), and pre-refunded bonds. |
| US Credit | Barclays Wealth | The Custom US Credit Index uses a blend of returns |
| | Custom US | on US Investment Grade Credit, High Yield, |
| | Credit | Converts and Preferreds, with the weights reflecting |
| | | the average relative market sizes of each asset class |
| | | over the past five years. |
| US Credit | Barclays Capital | Publicly issued US corporate and specified foreign |
| | US Credit | debentures and secured notes that meet the specified |
| | | maturity, liquidity, and quality requirements. To |
| | | qualify, bonds must be SEC-registered. The index |
| | | includes both corporate and non-corporate sectors. |
| | | The corporate sectors are Industrial, Utility, and |
| | | Finance, which include both US and non-US |
| | | corporations. The non-corporate sectors are |
| | | Sovereign, Supranational, Foreign Agency, and |
| | | Foreign Local Government. |
| Non-US | Barclays Capital | The Barclays Capital Global Aggregate Index |
| Credit | Global | provides a broad-based measure of the global |
| | Aggregate ex | investment-grade fixed income markets. The three |
| | USD | major components of this index are the U.S. |
| | | Aggregate, the Pan-European Aggregate, and the |
| | | Asian-Pacific Aggregate Indices. The index also |
| | | includes Eurodollar and Euro-Yen corporate bonds, |
| | | Canadian government, agency and corporate |
| | | securities, and USD investment grade 144A |
| | | securities. The Global Aggregate ex USD Index |
| | | includes the same constituents, excluding the US |
| | | dollar - denominated components. |
| US | ML All US Ex- | A market capitalization-weighted index of domestic |
| Convertibles | Mandatory | corporate convertible securities. To be included in the |
| | Convertibles | Index, bonds and preferred stocks must be |
| | Index | convertible only to common stock and have a market |
| | | value or original par value of at least $50 million. |
| US High | Barclays Capital | Fixed rate, non-investment grade debt. Pay-in-kind |
| Yield Fixed | US High Yield | (PIK) bonds, Eurobonds, and debt issues from |
| Income | | countries designated as emerging markets (e.g., |
| | | Argentina, Brazil, Venezuela, etc.) are excluded, but |
| | | Canadian and global bonds (SEC registered) of |
| | | issuers in non-EMG countries are included. Original |
| | | issue zeroes, step-up coupon structures, and 144As |
| | | are also included. Excluded are structured notes with |
| | | embedded swaps or other special features, private |
| | | placements, floating rate securities, and Eurobonds. |
| US Preferred | Barclays Capital - | To be included, a security must generally be viewed |
| Stock | Capital Credit | as a hybrid fixed income security that either receives |
| | | regulatory capital treatment or a degree of “equity |
| | | credit” from the rating agencies. This generally |
| | | includes Tier 2/Lower Tier 2 bonds, perpetual step-up |
| | | debt, step-up preferred securities, and term preferred |
| | | securities. |
| Global | EM Sovereign | The EMBI Global is a traditional, market |
| Bonds | Debt Index | capitalization-weighted index that is composed of US |
| | | dollar denominated Brady bonds, Eurobonds, traded |
| | | loans, and local market debt instruments issued by |
| | | sovereign and quasi-sovereign entities with a |
| | | minimum current face outstanding or US$500 million |
| | | and at least 2.5 years to maturity. This index defines |
| | | emerging markets countries with a combination of |
| | | World Bank-defined per capita income brackets and |
| | | each country's debt-restructuring history. |
| US Large | Russell 1000 | Russell 1000 Index measures the performance of the |
| Cap Equity | Total Return | 1,000 largest companies in the Russell 3000 Index, |
| | | which represents approximately 92% of the total |
| | | market capitalization of the Russell 3000 Index. As of |
| | | the latest reconstitution, the average market |
| | | capitalization was approximately $13.0 billion; the |
| | | median market capitalization was approximately $4.6 |
| | | billion. The smallest company in the index had an |
| | | approximate market capitalization of $1.8 billion. |
| US Large | NASDAQ | Measures the performance of all NASDAQ domestic |
| Cap Equity | | and international based common type stocks listed on |
| | | The Nasdaq Stock Market. Calculated under a market |
| | | capitalization weighted methodology index. To be |
| | | eligible for inclusion in the Composite the security's |
| | | U.S. listing must be exclusively on the Nasdaq Stock |
| | | Market. |
| US Large | DJIA | Price-weighted index composed of 30 blue-chip US |
| Cap Equity | | companies selected and maintained by editors of the |
| | | Wall Street Journal. As of Oct. 30, 2009, the average |
| | | market capitalization was approximately $104.2 |
| | | billion; the median market capitalization was |
| | | approximately $107.5 billion. The smallest company |
| | | in the index had an approximate market capitalization |
| | | of $12.1 billion. |
| US Large | Russell 3000 | The Russell 3000 Index measures the performance of |
| Cap Equity | Total Return | the largest 3000 U.S. companies representing |
| | | approximately 98% of the investable U.S. equity |
| | | market. As of the latest reconstitution, the dollar |
| | | weighted average market capitalization was $58.2 |
| | | billion; the median market capitalization was $589 |
| | | million. |
| US Large | Russell 3000 | Measures the performance of those Russell 3000 |
| Cap Equity | Growth Total | Index companies with higher price-to-book ratios and |
| | Return | higher forecasted growth values. The index is market |
| | | cap-weighted and includes only common stocks |
| | | incorporated in the United States and its territories. |
| US Large | Russell 3000 | Measures the performance of those Russell 3000 |
| Cap Equity | Value Total | Index companies with lower price-to-book ratios and |
| | Return | lower forecasted growth values. The index is market |
| | | cap-weighted and includes only common stocks |
| | | incorporated in the United States and its territories. |
| US Large | S&P 500 Total | The S&P 500 is a free-float capitalization-weighted |
| Cap Equity | Return | index published since 1957 of the prices of 500 large- |
| | | cap common stocks actively traded in the United |
| | | States. The stocks included in the S&P 500 are those |
| | | of large publicly held companies that trade on either |
| | | of the two largest American stock market companies; |
| | | the NYSE Euronext and the NASDAQ OMX. A |
| | | selection committee selects the companies in the S&P |
| | | 500 so they are representative of the industries in the |
| | | United States economy. |
| US Large | Russell 1000 | Measures the performance of those Russell 1000 |
| Cap Growth | Growth Total | Index companies with higher price-to-book ratios and |
| | Return | higher forecasted growth values. The index is market |
| | | cap-weighted and includes only common stocks |
| | | incorporated in the United States and its territories. |
| US Large | Russell 1000 | Measures the performance of those Russell 1000 |
| Cap Value | Value Total | Index companies with lower price-to-book ratios and |
| | Return | lower forecasted growth values. The index is market |
| | | cap-weighted and includes only common stocks |
| | | incorporated in the United States and its territories. |
| US Large | DJ Select | Measures the performance of all dividend-paying |
| Cap Value | Dividend | companies in the Dow Jones U.S. Index that have a |
| | | nonnegative historical five-year dividend-per-share |
| | | growth rate, a five-year average dividend to earnings- |
| | | per-share ratio of less than or equal to 60%, paid |
| | | dividends in each of the previous five years, and a |
| | | three-month average daily trading volume of 200,000 |
| | | shares. Current index components are included in the |
| | | universe regardless of their dividend payout ratio or |
| | | trading volume. |
| US Mid Cap | Russell Mid Cap | Russell Midcap Index measures the performance of |
| Equity | Total Return | the 800 smallest companies in the Russell 1000 |
| | | Index, which represent approximately 25% of the |
| | | total market capitalization of the Russell 1000 Index. |
| | | As of the latest reconstitution, the average market |
| | | capitalization was approximately $4.7 billion; the |
| | | median market capitalization was approximately $3.6 |
| | | billion. The largest company in the index had an |
| | | approximate market capitalization of $13.7 billion |
| US Mid Cap | Russell Mid Cap | Russell Midcap Value Index measures the |
| Value | Value Total | performance of those Russell Midcap companies with |
| | Return | lower price-to-book ratios and lower forecasted |
| | | growth values. The stocks are also members of the |
| | | Russell 1000 Value index. |
| US Mid Cap | Russell Mid Cap | Russell Midcap Growth Index measures the |
| Growth | Growth Total | performance of those Russell Midcap companies with |
| | Return | higher price-to-book ratios and higher forecasted |
| | | growth values. The stocks are also members of the |
| | | Russell 1000 Growth index. |
| US Small | Russell 2000 | Measures the performance of the 2,000 smallest |
| Cap Equity | Total Return | companies in the Russell 3000 Index, which |
| | | represents approximately 8% of the total market |
| | | capitalization of the Russell 3000 Index. The index is |
| | | market cap-weighted and includes only common |
| | | stocks incorporated in the United States and its |
| | | territories. |
| US Small | Russell 2000 | Measures the performance of those Russell 2000 |
| Cap Growth | Growth Total | Index companies with higher price-to-book ratios and |
| | Return | higher forecasted growth values. The index is market |
| | | cap-weighted and includes only common stocks |
| | | incorporated in the United States and its territories. |
| US Small | Russell 2000 | Measures the performance of those Russell 2000 |
| Cap Value | Value Total | Index companies with lower price-to-book ratios and |
| | Return | lower forecasted growth values. The index is market |
| | | cap-weighted and includes only common stocks |
| | | incorporated in the United States and its territories. |
| US Small- | Russell 2500 | Measures the performance of the 2,500 smallest |
| Mid Cap | Total Return | companies in the Russell 3000 Index. The index is |
| Equity | | market cap-weighted and includes only common |
| | | stocks incorporated in the United States and its |
| | | territories. |
| US Small- | Russell 2500 | Measures the performance of those Russell 2500 |
| Mid Cap | Growth Total | Index companies with higher price-to-book ratios and |
| Growth | Return | higher forecasted growth values. The index is market |
| | | cap-weighted and includes only common stocks |
| | | incorporated in the United States and its territories. |
| US Small- | Russell 2500 | Measures the performance of those Russell 2500 |
| Mid Cap | Value Total | Index companies with lower price-to-book ratios and |
| Value | Return | lower forecasted growth values. The index is market |
| | | cap-weighted and includes only common stocks |
| | | incorporated in the United States and its territories. |
| Non-US | MSCI-EAFE | A free float-adjusted market capitalization index that |
| Developed | Total Return | is designed to measure developed market equity |
| Equity | (Europe, | performance, excluding the US & Canada. As of |
| | Australia, Far | April 2002 the MSCI EAFE Index consisted of the |
| | East) | following 21 developed market country indices: |
| | | Australia, Austria, Belgium, Denmark, Finland, |
| | | France, Germany, Greece, Hong Kong, Ireland, Italy, |
| | | Japan, the Netherlands, New Zealand, Norway, |
| | | Portugal, Singapore, Spain, Sweden, Switzerland and |
| | | the United Kingdom. The index is translated into U.S. |
| | | dollars. |
| Non-US | MSCI Germany | Every listed security in the German market. |
| Developed | | Securities are free float adjusted, classified in |
| Equity | | accordance with the Global Industry Classification |
| | | Standard (GICS ®), and screened by size, liquidity |
| | | and minimum free float. |
| Non-US | MSCI AC World | The MSCI ACWI (All Country World Index) Index |
| Developed | | is a free float-adjusted market capitalization weighted |
| Equity | | index that is designed to measure the equity market |
| | | performance of developed and emerging markets. As |
| | | of June 2009 the MSCI ACWI consisted of 45 |
| | | country indices comprising 23 developed and 22 |
| | | emerging market country indices. The developed |
| | | market country indices included are: Australia, |
| | | Austria, Belgium, Canada, Denmark, Finland, France, |
| | | Germany, Greece, Hong Kong, Ireland, Italy, Japan, |
| | | Netherlands, New Zealand, Norway, Portugal, |
| | | Singapore, Spain, Sweden, Switzerland, the United |
| | | Kingdom and the United States. The emerging |
| | | market country indices included are: Brazil, Chile, |
| | | China, Colombia, Czech Republic, Egypt, Hungary, |
| | | India, Indonesia, Israel, Korea, Malaysia, Mexico, |
| | | Morocco, Peru, Philippines, Poland, Russia, South |
| | | Africa, Taiwan, Thailand, and Turkey. |
| Non-US | MSCI-EAFE | Price/Book Value ratios divide the MSCI country |
| Developed | Growth Total | indices into two sub-indices: value and growth. All |
| Equity | Return (Europe, | securities are classified as either “value” (low P/BV) |
| Growth | Australia, Far | or “growth” (high P/BV) relative to each MSCI |
| | East) | country index. In this manner, the definition of |
| | | growth is relative to each individual market as |
| | | represented by the MSCI index. Country growth |
| | | indices are aggregated into regional growth indices. |
| Non-US | MSCI-EAFE | Price/Book Value ratios divide the MSCI country |
| Developed | Value Total | indices into two sub-indices: value and growth. All |
| Equity Value | Return (Europe, | securities are classified as either “value” (low P/BV) |
| | Australia, Far | or “growth” (high P/BV) relative to each MSCI |
| | East) | country index. In this manner, the definition of value |
| | | is relative to each individual market as represented by |
| | | the MSCI index. Country value indices are |
| | | aggregated into regional value indices. |
| Non-US | MSCI-EASEA | The MSCI EASEA is a capitalization weighted index |
| Developed | | that monitors the performance of stocks from the |
| Equity ex | | countries that make up the EAFE excluding the |
| Japan | | country of Japan. |
| Japanese | MSCI-Japan | The MSCI Japan Index is a capitalization weighted |
| Equity | | index that monitors the performance of stocks from |
| | | the country of Japan. |
| Emerging | MSCI Emerging | This index is a free float-adjusted market |
| Market | Markets | capitalization index that is designed to measure |
| Equity | | equity market performance of emerging markets. As |
| | | of January 2009 the MSCI Emerging Markets Index |
| | | consisted of the following 23 emerging market |
| | | country indices: Argentina, Brazil, Chile, China, |
| | | Colombia, Czech Republic, Egypt, Hungary, India, |
| | | Indonesia, Israel, Korea, Malaysia, Mexico, Morocco, |
| | | Peru, Philippines, Poland, Russia, South Africa, |
| | | Taiwan, Thailand, and Turkey. |
| Emerging | MSCI Emerging | This index is the Asian sub-set of the MSCI |
| Market Asia | Markets Asia | Emerging Markets index. It includes the following 8 |
| Equity | | countries: China, India, Indonesia, Korea, Malaysia, |
| | | Philippines, Taiwan and Thailand. |
| Emerging | MSCI AC Asia | The MSCI AC (All Country) Asia ex Japan Index is a |
| Market Asia | ex-Japan | free float-adjusted market capitalization weighted |
| Equity | | index that is designed to measure the equity market |
| | | performance of Asia, excluding Japan. As of January |
| | | 2009 the MSCI AC Asia ex Japan Index consisted of |
| | | the following 10 developed and emerging market |
| | | country indices: China, Hong Kong, India, Indonesia, |
| | | Korea, Malaysia, Philippines, Singapore, Taiwan, and |
| | | Thailand. |
| Emerging | MSCI Emerging | This index is the Asian sub-set of the MSCI |
| Market ex- | Markets Ex Asia | Emerging Markets index. It includes the following 15 |
| Asia Equity | | countries: Argentina, Brazil, Chile, Colombia, Czech |
| | | Republic, Egypt, Hungary, Israel, Mexico, Morocco, |
| | | Peru, Poland, Russia, South Africa, and Turkey. |
| Multi-Market | HFRI Macro | Macro funds make leveraged bets on anticipated price |
| Directional | Index | movements of stock markets, interest rates, foreign |
| Hedge Funds | | exchange and physical commodities. They employ a |
| | | “top-down” global approach, and may invest in any |
| | | markets using any instruments to participate in |
| | | expected market movements. Exchange-traded and |
| | | over-the-counter derivatives are often used to |
| | | magnify these price movements. |
| Market | Average of HFRI | Equity Market Neutral investing seeks to profit by |
| Neutral | Equity Market | exploiting pricing inefficiencies between related |
| Arbitrage | Neutral, Fixed- | equity securities, neutralizing exposure to market risk |
| Hedge Funds | Income | by combining long and short positions. Fixed Income |
| | Corporate, and | Corporate Arbitrage is a market neutral hedging |
| | Convertible | strategy that seeks to profit by exploiting pricing |
| | Arbitrage | inefficiencies between related fixed income securities |
| | indexes. | while neutralizing exposure to interest rate risk. Fixed |
| | | Income Corporate Arbitrage is a generic description |
| | | of a variety of strategies involving investment in |
| | | fixed income instruments, and weighted in an attempt |
| | | to eliminate or reduce exposure to changes in the |
| | | yield curve. Convertible Arbitrage involves |
| | | purchasing a portfolio of convertible securities, |
| | | generally convertible bonds, and hedging a portion of |
| | | the equity risk by selling short the underlying |
| | | common stock. |
| Private | Thomson PE | The Thomson private equity benchmark formulates |
| Equity | Index | an internal rate of return based upon an aggregation |
| | | of all cash flows of the buyout, venture, and special |
| | | situations fund performances reported to the |
| | | Thomson Corporation; all historical internal rates of |
| | | return are subject to, and regularly undergo, revision. |
| Private Real | MIT NCREIF | The NCREIF Property Index is a quarterly time series |
| Estate | Total Return | composite total rate of return measure of investment |
| | | performance of a very large pool of individual |
| | | commercial real estate properties acquired in the |
| | | private market for investment purposes only. All |
| | | properties in the NPI have been acquired, at least in |
| | | part, on behalf of tax-exempt institutional investors - |
| | | the great majority being pension funds. As such, all |
| | | properties are held in a fiduciary environment. The |
| | | composition of the NPI can change over time. The |
| | | numbers of properties changes as Data Contributing |
| | | Members buy and sell properties and new Data |
| | | Contributing Members are added. Properties exit the |
| | | NPI when assets are sold or otherwise leave the |
| | | database. All historical data remains in the database |
| | | and in the Index. |
| Real Estate | NAREIT Equity | An index that consists of all Real Estate Investment |
| | Index | Trusts that currently trade on the New York Stock |
| | | Exchange, the NASDAQ National Market System |
| | | and the American Stock Exchange. |
| Real Estate | NAREIT Global | Diverse representation of publicly traded equity |
| | RE | REITs and listed property companies globally. Stocks |
| | | are free-float weighted and screened for minimum |
| | | liquidity. |
| Commodities | Dow Jones - | Composed of futures contracts on 20 physical |
| | UBS Commodity | commodities. Must be traded on US exchanges, with |
| | Index | the exception of aluminum, nickel and zinc, which |
| | | trade on the London Metal Exchange (LME). To |
| | | determine its component weightings, the it relies |
| | | primarily on liquidity data, or the relative amount of |
| | | trading activity of a particular commodity. All data |
| | | used in both the liquidity and production calculations |
| | | is averaged over a five-year period. |
| MLPs | Alerian MLP | The Alerian MLP Index is a composite of the 50 most |
| | Index | prominent energy master limited partnerships |
| | | calculated by Standard & Poor's using a float- |
| | | adjusted market capitalization methodology. |

### Asset Risk Class Considerations

TABLE 29

| | |
|---|---|
| Arbitrage - | The simultaneous purchase and selling of a security in order to |
| | profit from a differential in the price. Investors should be aware of |
| | the inherent risks of arbitrage strategies before making an |
| | investment. |
| Cash | Portfolios that invest in very short-term securities provide taxable |
| Equivalents - | or tax-advantaged current income, pose little risk to principal and |
| | offer the ability to convert the investment into cash quickly. These |
| | investments may result in a lower yield than would be available |
| | from investments with a lower quality or longer term. Investments |
| | in currency options and futures, on the other hand, carry inherent |
| | risks that investors should consider before investing. Options are |
| | not suitable for all investors. Options trading can be speculative in |
| | nature and carry substantial risk of loss. |
| Commodities - | Commodities are assets that have tangible properties, such as oil, |
| | metals, and agricultural products. Overall market movements and |
| | other factors affecting the value of a particular industry or |
| | commodity, such as weather, disease, embargoes, or political and |
| | regulatory developments, may affect the value of commodity- |
| | linked derivative instruments. |
| Equilibrium | The levels that would induce the average, or moderately risk- |
| Returns - | averse, investor to hold percentages of various asset classes equal |
| | to the proportionate shares of total global market capitalization. |
| Equity Hedged - | An investment in hedge funds is speculative and involves a high |
| | degree of risk. Hedge fund performance can be volatile. While an |
| | investment in hedge funds may result in profits, it may also result |
| | in losses - investors may lose all or a substantial amount of their |
| | investment. |
| High Yield | Portfolios that invest in bonds and other fixed income securities |
| Bonds - | provide regular income and have historically been less volatile than |
| | stock funds. However, they are subject to risks including credit |
| | risk, default on principal or interest payments and interest rate |
| | fluctuations. High yield bonds, also known as ‘junk bonds’ are |
| | subject to additional risks such as the increased risk of default. |
| International | Portfolios that invest in companies outside of the United States |
| Bonds - | provide long-term growth potential and can be used to balance a |
| | primarily domestic portfolio, but are subject to additional risks, |
| | including currency, economic and political developments abroad. |
| | Portfolios that invest in bonds and other fixed income securities |
| | provide regular income and have historically been less volatile than |
| | stock funds. However, they are subject to risks including credit |
| | risk, default on principal or interest payments and interest rate |
| | fluctuations. |
| International | Portfolios that invest in companies outside of the United States |
| Stocks - | provide long-term growth potential and can be used to balance a |
| | primarily domestic portfolio, but are subject to additional risks, |
| | including currency, economic and political developments abroad. |
| Large Growth and | Portfolios that emphasize large and established US companies offer |
| Value Stocks - | excellent long-term growth potential but may involve price |
| | fluctuations as stock market conditions change. |
| Mid-Cap Stocks - | This group of companies is considered to be more volatile than the |
| | large and mega-cap companies. Growth stocks represent a |
| | significant portion of the mid caps. |
| Municipal | Some of the income from Municipal Bonds may be subject to state |
| Bonds - | and local taxes, or the Federal Alternative Minimum Tax. Consult |
| | with your tax advisor before investing. Portfolios that invest in |
| | bonds and other fixed income securities provide regular income and |
| | have historically been less volatile than stock funds. However, they |
| | are subject to risks including credit risk, default on principal or |
| | interest payments and interest rate fluctuations. |
| Private Equity - | When equity capital is made available to companies or investors, |
| | but not quoted on a stock market. The funds raised through private |
| | equity can be used to develop new products and technologies, to |
| | expand working capital, to make acquisitions, or to strengthen a |
| | company's balance sheet. The investments to be made by the Fund |
| | are speculative in nature and the possibility of partial or total loss of |
| | capital will exist. |
| Real Estate | The properties held by REITs could fall in value for a variety of |
| Investment Trusts | reasons, such as declines in rental income, poor property |
| (REITs) - | management, environmental liabilities, uninsured damage, |
| | increased competition, or changes in real estate tax laws. There is a |
| | risk that REIT stock prices overall will decline over short or even |
| | long periods because of rising interest rates. |
| Small Cap Stocks - | Investments in fast-growing U.S. smaller company stocks have |
| | historically provided strong long-term growth potential; however, |
| | investments in these stocks may involve a higher degree of risk and |
| | volatility than investments in larger companies. |
| Taxable Bonds - | Portfolios that invest in bonds and other fixed income securities |
| | provide regular income and have historically been less volatile than |
| | stock funds. However, they are subject to risks including credit |
| | risk, default on principal or interest payments and interest rate |
| | fluctuations. |

Investors should fully understand and appreciate all the material differences between an asset class benchmark and the suggested allocation before making any investment decisions. The suggestions in this presentation represent the good faith opinions of the Portfolio Advisory Group. A full discussion of all relevant factors would not be feasible in this presentation so investors should pursue further discussions with their advisor prior to making any investment decision.

Equity and Fixed Income asset class benchmark indices represent buy and hold strategies, while managers can actively adjust risk levels and exposures, as well as holdings. Furthermore, benchmark indices generally represent broadly diversified holdings, but manager portfolios may be significantly more concentrated or weighted differently.

Hedge fund indices represent the returns of a diversified set of actively managed trading strategies and may be subject to upward biases. Investors should be aware that a single manager is not a substitutable representation of and bears significantly more risk of loss than the index.

REIT indices may have some correlation with equity returns and may behave significantly different than direct investments in real estate. Actively managed commodities pools can differ significantly from the index in both composition and risk exposure. There are significant differences in performance between publicly available and privately available commodities pools.

[Exemplary] Legal Disclaimer

This document has been prepared by Barclays Wealth, the wealth management division of Barclays Bank PLC (“Barclays”), for information purposes only. This document is an indicative summary of the terms and conditions of the securities/transaction described herein and may be amended, superseded or replaced by subsequent summaries. The final terms and conditions of the securities/transaction will be set out in full in the applicable offering document(s) or binding transaction document(s).

The products mentioned in this document may not be eligible for sale in some states or countries, nor suitable for all types of investors. This document shall not constitute an underwriting commitment, an offer of financing, an offer to sell, or the solicitation of an offer to buy any securities described herein, which shall be subject to Barclays' internal approvals. No transaction or services related thereto is contemplated without Barclays' subsequent formal agreement. Barclays accepts no liability whatsoever for any consequential losses arising from the use of this document or reliance on the information contained herein.

Barclays does not guarantee the accuracy or completeness of information which is contained in this document and which is stated to have been obtained from or is based upon trade and statistical services or other third party sources. Any data on past performance, modeling or back-testing contained herein is no indication as to future performance. No representation is made as to the reasonableness of the assumptions made within or the accuracy or completeness of any modeling or back-testing. All opinions and estimates are given as of the date hereof and are subject to change. The value of any investment may fluctuate as a result of market changes. The information in this document is not intended to predict actual results and no assurances are given with respect thereto.

Barclays Capital Inc. and/or its affiliated companies may make a market or deal as principal in the securities mentioned in this document or in options or other derivatives based thereon. Barclays, its affiliates and the individuals associated therewith may (in various capacities) have positions or deal in transactions or securities (or related derivatives) identical or similar to those described herein. One or more directors, officers, and/or employees of Barclays Capital Inc. or its affiliated companies may be a director of the issuer of the securities mentioned in this document. Barclays Capital Inc. or its affiliated companies may have managed or co-managed a public offering of securities for any issuer mentioned in this document within the last three years.

IRS Circular 230 Disclosure: Barclays Capital and its affiliates do not provide tax advice. Please note that (i) any discussion of US tax matters contained in this communication (including any attachments) cannot be used by you for the purpose of avoiding tax penalties; (ii) this communication was written to support the promotion or marketing of the matters addressed herein; and (iii) you should seek advice based on your particular circumstances from an independent tax advisor.

If clients choose to implement these portfolio allocations, Barclays Capital Inc. will be acting solely as a broker-dealer, not as an investment adviser (unless otherwise agreed in writing). In executing transactions for client accounts in accordance with client instructions, Barclays Capital Inc., as a broker-dealer, may act as agent or as principal for its own account.

Barclays Capital Inc. is both a broker-dealer and an investment adviser, and it offers both brokerage and investment advisory services. There are important differences between brokerage and investment advisory services, including the type of advice and assistance provided, the fees charged, and the rights and obligations of the parties. Brokerage services are regulated under different laws and rules than advisory services. It is important for clients to understand these differences, particularly when determining which service(s) they might select. For additional information, please contact your investment representative.

BARCLAYS WEALTH, THE WEALTH MANAGEMENT DIVISION OF BARCLAYS BANK PLC (INCLUDING BARCLAYS CAPITAL INC. IN THE UNITED STATES) ACCEPTS RESPONSIBILITY FOR THE DISTRIBUTION OF THIS DOCUMENT IN THE UNITED STATES. ANY TRANSACTIONS BY US PERSONS IN ANY SECURITY DISCUSSED HEREIN MUST ONLY BE CARRIED OUT THROUGH BARCLAYS CAPITAL INC., 200 PARK AVENUE, NEW YORK, N.Y. 10166. Member SIPC.

THIS DOCUMENT DOES NOT DISCLOSE ALL THE RISKS AND OTHER SIGNIFICANT ISSUES RELATED TO AN INVESTMENT IN THE SECURITIES/TRANSACTION. PRIOR TO TRANSACTING, POTENTIAL INVESTORS SHOULD ENSURE THAT THEY FULLY UNDERSTAND THE TERMS OF THE SECURITIES/TRANSACTION AND ANY APPLICABLE RISKS.

Barclays Bank PLC is registered in England NO. 1 026167. Registered Office: 1 Churchill Place, London E14 5HP. Copyright Barclays Bank PLC, 2010 (all rights reserved). This document is confidential, and no part of it may be reproduced, distributed or transmitted without the prior written permission of Barclays.

End of Appendix C

### Appendix D

### Exemplary Financial Personality and Recommended Portfolio Characteristic Report

The Structure of Wealth

We want to see your wealth as you see it. At Barclays Wealth, we've found that clients intuitively group their assets into three general categories to reflect their emotional and financial needs: Personal Holdings, Investment Portfolio and Opportunistic Investments. For each category, there are different characteristics and objectives. Research and practical experience have taught us that many clients expose themselves to unnecessary or excessive risk by over-allocating resources to Personal Holdings and Opportunistic Investments, based on emotions. We help you to understand how your wealth is divided across the three categories and how to rebalance* assets across them to ensure efficiency of overall wealth. As we do this, we take into account your emotional objectives as well as your financial aims.

Investment Portfolio

Your Investment Portfolio is the core of your wealth. It consists of assets chosen for long term diversified investment and deployed to achieve sustainable growth in wealth, while taking an appropriate degree of risk. It can include both Barclays-managed and external investment holdings. Appropriate diversification** for your risk level is the most efficient way to use your risk budget.

We will work with you to ensure your Investment Portfolio is tailored to your Financial Personality and investment objectives. More detail is provided on the following pages.

Personal Holdings

Your Personal Holdings include assets held for consumption and emotional reasons. Some examples are personal real estate, art and wine collections, yachts, and cash needed for near term expenditures or held as a liquidity buffer.

Holding large portions of unused cash in Personal Holdings can reduce the efficiency of your overall wealth. They can be much more effectively deployed in the Investment Portfolio.

Opportunistic Investments

Your Opportunistic Investments are highly concentrated holdings used for their potential to achieve substantial increases in wealth. They should be comprised of assets in which you have high degree of expertise and conviction. Examples include one's own business, and concentrated holdings for which there are specific reasons to hold as stand-alone investments.

You may want to hold high-conviction assets where you have personal expertise or exercise direct control. Without expertise or control, your conviction could lead to a poor use of your risk budget, reducing the efficiency of your overall wealth.

* Rebalancing does not guarantee an investor's goals and objectives will be met. ** Diversification does not protect against loss.

Tailoring Your Investment Portfolio

Step 1: Understanding and Using Your Financial Personality

By understanding and accepting your unique financial personality, we can help you deploy more of your assets in an optimized Investment Portfolio, while addressing the emotional needs that would otherwise lead to over-allocations to Personal Holdings or Opportunistic Investments.

The six financial personality dimensions below are important for understanding how to best manage your wealth. We all have our own goals and preferences, and these will assist us in crafting a truly personalized investment strategy.

Determinants of Risk Attitudes

Risk Tolerance

Our psychological risk tolerance measure is an expression of the long term trade-off between risk and return in your portfolio. Higher risk tolerance indicates a higher risk, higher return portfolio, circumstances, and how confident you feel in your own financial while low risk tolerance leads to a lower risk, lower return solution.

Composure

The composure scale measures how emotionally engaged you tend to be with the investment journey—how much you feel and respond to short term month by month gains and losses.

Market Management

Market engagement measures the degree to which you are inclined to avoid or engage in financial markets. This scale acts as paying for an indicator of whether you have a mental hurdle to investing in markets, usually due to a fear of the unknown or wrong timing.

Determinants of Decision Style

Perceived Financial Expertise

The perceived financial expertise dimension assesses how familiar and informed you feel you are with current financial circumstances, and how confident you feel in your own financial knowledge and decision-making.

Delegation

The delegation scale assesses how much you believe you can benefit from delegating day-to-day portfolio management decisions to someone. The higher your delegation, the greater will be your desire for advice and for someone to assume the effort of portfolio management.

Belief in Skill

The belief in skill scale assesses how much you believe it is worth paying for an investment professional's potential to achieve above-market returns.

Step 2: Finding Your Appropriate Investment Strategy

How Much Long-Term Risk?

The most appropriate long-term investment strategy involves maximizing your potential return subject to the level of risk you are willing to accept.

We use your level of Risk Tolerance to determine the appropriate mix of assets for you.

Step 3: Fine-Tuning Your Investment Portfolio Characteristics

Liquidity

The correct liquidity allows you to take advantage of possible higher returns available in less liquid products, while remaining comfortable about ability to access your wealth. We can adjust the percentage of your wealth in high and low liquidity products to ensure you are taking advantage of the illiquidity premium, while remaining comfortable with your ability to access your wealth.

Smoothing

Some clients may benefit from month-by-month smoothing of returns. For these clients, we would suggest smoothing returns from intelligent product choice.

Downside Protection

Individuals often fear the large losses they periodically see, and so avoid investing altogether. Over the long run this is extremely costly. If suitable, we may advise products or strategies which limit the extent of potential losses to overcome this fear and attain the maximum performance over the long term.

Active Management

Belief in investment skill varies by individual, and we aim to implement a portfolio in a manner which reflects your personal belief in active management. Clients with high belief in investment skill may benefit from our research into fund managers and active solutions. Clients with low belief in investment skill can have their portfolio implemented passively through index-tracking products and structured notes.***

*** Strategies or investments of the type described herein may involve a high degree of risk and the value of such strategies or investments may be highly volatile

Step 4: Customized Investment Implementation and Ongoing Management Phased Investment

As some clients are uncomfortable investing all of their wealth into their ideal asset allocation immediately, we may recommend tailoring the speed with which we implement your optimal portfolio such that you are not overly worried about making mistakes in timing the market.

Comfort

Clients differ in terms of how comfortable they are with making investment decisions, or with technical or complicated products and investment strategies. We strive to make you feel comfortable when making your investment decisions.

Involvement

Your involvement with your portfolio—how often we contact you, how much you want to delegate or take responsibility for investment decisions and how much information you want with what frequency—can be tailored to your personality.

Tactical Updating

Whether you wish to continually update your portfolio to meet the latest tactical asset allocation calls, or steer a steady path with a stable, long-term allocation should relate to your belief in the value of investment manager skill.

What is Risk Tolerance?

Everyday definitions of risk define it as the possibility of suffering a loss or as the chance of something bad happening. In finance there are many different technical definitions of risk, none of them easily expressed by non-experts.

In building your portfolio we try to think about risk in the way it is meaningful to you. Our psychological risk tolerance measure is an expression of the average level of returns required to make you comfortable with taking on the chance of future losses in your portfolio. Whilst it is a natural instinct to avoid the possibility of something bad happening, you might be willing to take on more risk if the expected gains are higher. It is how you reconcile these two desires—your desire to avoid losses and your desire for gains—and how you trade them off that we measure by assessing your risk tolerance.

Individuals with high risk tolerance are more likely to accept the possibility of losing some of their wealth so that they can access the types of investments which might also achieve very high returns. People with a low score on this scale are much more likely to be conservative in their trade-off between potential gains and losses. They will accept smaller potential gains so they can be confident of not losing a significant portion of their wealth—they sacrifice the chance of extremely high returns in exchange for secure and stable returns.

Your risk tolerance score indicates which goal it is rational for you to pursue for the long-run optimization of your Investment Portfolio. This guides us on how to construct a portfolio of assets on your behalf that, at the end of your investment horizon, will deliver to you the best possible expected returns, subject to the amount of psychological risk you are naturally comfortable with taking on.

It is important to note that your risk tolerance score describes your overall psychological tolerance to risk and is not specific to the assets you hold or plan to hold with Barclays Wealth. You may hold assets elsewhere which are more risky than your risk tolerance profile, or you may already be taking on financial risk in your day-to-day business or entrepreneurial activities. Conversely you may already be holding a large portion of your wealth in very safe assets and intend to keep it there, or you may have a very stable business income or salary for many years to come. When we optimize your investments, we will consider the risk characteristics of the assets you hold with Barclays Wealth and those you tell us you hold elsewhere, as well as your income stability. This means when we invest for you, we may need to place some assets above or below your risk tolerance. This is appropriate in creating an overall portfolio to deliver the maximum potential returns for your returns for your tolerance to risk.

Results of Your Financial Personality Assessment

Your Risk Tolerance: Moderate

You are comfortable with investments which may lead to fluctuations in the value of your portfolio in exchange for the opportunity to achieve above average increases in your wealth in the medium to long run. You want the real value of your investments to increase, or your income to maintain its spending power over time. You are happy to put some of your money into riskier investments with the aim of getting a better return and accept you could make a loss on the wealth you invest.

What is Composure?

The composure scale measures how you as an individual feel about, react to, and cope with short-term financial situations.

Individuals with lower scores on this dimension will be more emotionally engaged with the short term performance of their portfolio. They will appreciate more stable returns, as they place higher value on the emotional stability they get from certainty. Composure differs from risk tolerance in that it refers more to your short term and emotional reactions to uncertainty. Your risk tolerance score gives an indication of your rational willingness to trade off an increased chance of losses for better possible returns in the long term. Composure, on the other hand, gives an indication of how you will feel about these fluctuations in the short term as the portfolio goes up or down.

Those with low composure are likely to experience more emotional stress from uncertainty, and also to worry more about short-term decreases in the value of their portfolio. They are likely to monitor their portfolio more frequently and thus perceive portfolio outcomes on an artificially short timeframe, which exaggerates the proportion of losses relative to what they would see if focused rationally on a longer-term time horizon. It is quite possible for two investors to have the same degree of risk tolerance for long-run portfolio outcomes, but that one feels far more day-to-day concern than the other in the interim periods. Some investors may therefore become stressed or anxious about the day to day fluctuations in the value of their portfolio despite being happy with the potential risk and return trade-off over their investment time horizon.

Another common tendency is for investors to focus quite narrowly on individual components of their portfolios, rather than monitoring the overall performance. This can lead one to focus on losses in parts of the portfolio even while the overall portfolio is going up in value. Investors with lower composure are more likely to observe and worry about these component losses—again the proportion of losses is exaggerated, which leads to dissatisfaction with the performance of the portfolio as a whole, even if it is ideally suited to reaching your long-term objectives.

Keeping your investment focus on the long term or overall portfolio can help to overcome the stress often associated with low composure. On the other hand if you monitor your portfolio too frequently, expect results over too short a time horizon, or if you focus very narrowly on individual components of your portfolio you will be likely to observe a higher proportion of short-term losses than you would if you frame your investment focus more broadly.

Results of Your Financial Personality Assessment

Your Composure: High

While major or important issues may cause you some anxiety, you are not unduly concerned by situations where the outcome is out of your control. You are less likely to worry about decisions once they have been made and consequently can commit to long-term strategies more productively.

It is unlikely you will over-monitor or worry about your portfolio's performance. This is a benefit to you if your portfolio is constructed appropriately for your risk attitudes and investment time horizon. Many people over-monitor the performance of their portfolio, and as a result perceive a high number of short-term fluctuations which may be irrelevant for their investment performance in the long run. This encourages them to take on less risk than is optimal for their time horizon, and their final portfolio values reflect this.

You are also more likely to cope with taking on differing levels of risk in different components of your wealth, as long as the resulting overall risk is appropriate to your risk tolerance. This is beneficial because people do not naturally aggregate all their individual wealth components and make good ‘big picture’ investment decisions. For example, if one investment is riskier than other parts of the portfolio, people will tend to react disproportionately to losses on it in isolation, rather than seeing that these losses are offset by gains in other parts of the portfolio. Fortunately you are unlikely to react adversely to interim fluctuations or to isolated losses and will keep a broader and more long-term perspective which allows greater flexibility in the design of your optimal portfolio.

What is Market Engagement?

Market engagement measures the degree to which an individual is inclined to avoid or engage in financial markets. This scale acts as an indicator of whether an individual has a mental hurdle to investing in markets. Some people have a belief that investing in markets is not an activity for them even though it may be appropriate for their risk tolerance and long-term investment objectives.

Lower scores on this scale suggest higher mental and emotional hurdles to overcome before an individual will consider a market-linked investment. This barrier could arise from a number of sources:

someone could be a risk taker in other aspects of their professional lives, but be uncomfortable with financial markets (e.g., businesspeople or entrepreneurs in the non-financial sectors, investors in property markets, etc.);

people could feel their knowledge of financial instruments is insufficient for them to take on financial decisions with confidence; they could be concerned that, although they are happy to take on known risks, they would be worried that financial investing will expose them to unexpected or hidden risks

others could simply have insufficient time or personal incentives to undertake the effort they feel would be necessary before taking that first step into financial markets;

avoidance of financial markets could also be an indication of a negative outlook for markets in the near term.

Whatever the reason, if you have a low score it is likely you will be avoiding financial markets and will have too large a portion of your wealth in cash or very low risk investments for your level of risk tolerance. If this is the case your long-run returns will not achieve your investment objectives.

Results of Your Financial Personality Assessment

Your Market Engagement: High

Your responses indicate you are very willing to participate in markets, as long as the risk/return features of an investment are appropriate. You recognize that by investing you can put your wealth at risk at the level that is appropriate for your risk tolerance. However, you are comfortable with this because you understand the benefits of accepting market fluctuations in exchange for the opportunity to increase your wealth in the long term. You feel sufficiently comfortable with financial investing to engage with markets without worrying you might be taking on unseen risks beyond your risk tolerance level.

What is Perceived Financial Expertise?

The perceived financial expertise dimension assesses how familiar and informed you feel you are with current financial circumstances, with how financial products work, and how confident you feel in your own financial knowledge and decision-making relative to the average person.

Just as not everyone has been through medical school but most people have a basic knowledge of how to be healthy, our scale is designed to assess how much financial familiarity you perceive yourself to have compared to the general level in the population.

You may:

be more informed than most people on current financial events;

have worked in finance but have not personally traded before;

be very familiar with specific types of investment, such as property, but not familiar with the stock market.

However, in all cases, when it comes to making important decisions about your wealth you may still want some professional guidance.

Individuals who perceive their knowledge to be high are more comfortable expressing their financial preferences and experiences and making financial decisions than those who perceive their level of knowledge to be low. A greater intuitive understanding of risk is often associated with having made and experienced investments previously. On the other hand, low knowledge often means individuals keep their investments very simple.

Luckily, a low perception of your financial knowledge is easy to address. At your discretion we can craft a personalized program to help you gain familiarity and confidence in your financial expertise, leading to a better understanding of investments. This will help you express your preferences with more clarity, which will help us craft a more sophisticated and appropriate wealth solution for you.

Results of Your Financial Personality Assessment

Your Perceived Financial Expertise: High

You feel familiar with financial markets and investments. You are likely either to have already engaged with and experienced a range of market investment instruments or have some knowledge about investing. As your perceived financial expertise is high, your risk tolerance is likely to have already settled to a stable level. You are therefore better able to gauge and make informed decisions regarding the level of risk you are prepared to take on.

What are Desire for Delegation and Belief in Skill?

The delegation and belief in skill scales assess how much an individual believes they can benefit from delegating aspects of their financial management to professionals and how much value they believe those professionals can add.

The two aspects are closely related. We measure them separately, although the majority of people have similar opinions on both of the subscales.

The first aspect is the belief that delegating the day-to-day decisions of managing your portfolio to someone else is beneficial. A high score on this dimension indicates a desire to have the effort of managing your investments taken out of your hands, and also reflects a willingness to trust in your investment manager to do the job effectively. A high scorer is also more likely to value independent investment advice. A low score on the other hand indicates an investor who wishes to take a hands-on role in their investments, and feels less need for investment advice. Interestingly, this scale is relatively unrelated to perceived financial expertise—people who have high perceived financial expertise are just about as likely on average to want to delegate their investment management and seek advice as they are to want to keep hold of the reins themselves.

The second aspect is the degree to which the investor believes it is worth paying for the ability of an investment professional to make above-market returns. People with a low score on this scale will be less interested in their investment manager using sophisticated techniques to try to beat the market and prefer a low-cost diversified basket of investments tracking the overall performance of the market. Their portfolio will therefore merely track the average market performance in either good or bad years. High scorers on the other hand tend to believe that the right investment manager can and will be able to outperform the market average in both good and bad years. They may also be interested in the use of investment skill to smooth market fluctuations throughout the cycle, therefore pursuing positive return goals regardless of how the market is performing. This is the goal of absolute return portfolios—delivering positive returns regardless of market performance.

In most cases an individual's desire to delegate their financial management and their belief in investment skill are closely related to one another—people tend to have similar scores on both. In a few people, however, opinions about these two dimensions differ, indicating the individual has a strong belief about one dimension or the other. We show each of these two closely-related dimensions on their own to aid comparison.

Results of Your Financial Personality Assessment

Your Delegation: High

You have indicated a high desire to delegate responsibility for your financial matters to someone else. You are likely to value independent investment advice and trust a competent investment manager to make effective financial decisions on your behalf. You would prefer the work associated with day-to-day investing to be taken out of your hands so you don't have to spend too much time or effort on your financial management.

Your Belief in Skill: High

You believe it is possible for skilled investors to get better returns than the market on average and it is worthwhile to let a skilled professional guide and seek out high-return investments for you using modern sophisticated techniques. You might also be interested in advice on investing strategies, cutting edge approaches to investment and innovative new financial instruments. You are likely to be willing to alter your portfolio to track the latest research opinions.

Financial Personality Results: Client X

Step 1 Results: Distinctive Features of Your Financial Personality

Your financial personality profile has produced measurements that are generally moderate to high on each scale. However, distinguishing features of your financial personality are your willingness to take on some risk, your perception of your financial expertise and your desire to delegate financial decision making. You are likely to have a rational approach to investing and are able to limit the emotional influences on your investment decisions. Because of this, you are comfortable taking on risks you understand. It is likely you will consider investments in financial markets because you understand that by participating in financial markets, you have the potential to achieve greater returns. Your familiarity with finance will increase the range of investments you understand and would be comfortable investing in, giving you greater scope to invest in products that are appropriate for your risk tolerance. Lastly, despite your comfort with investing, you have the desire for professional management and for the day-to-day decision making to be given to a full-time manager.

Step 2 Results: Your Investment Strategy

The core of your Investment Portfolio is the asset allocation. An appropriate asset allocation tries to ensure you are compensated in expected returns for the amount of risk you take on. Your investment strategy may include measures that aim to produce a smoothed investment journey.

Low Benefit from Smoothing Your Investment Journey

Your profile indicates that you have high composure and thus are unlikely to be unduly stressed by the uncertainty and short-term fluctuations inherent in financial market investing. As a result, you would not benefit as much as others from extra smoothing in your portfolio.

Your Risk Profile: Moderate

Your Risk Tolerance has been assessed as moderate. In constructing an appropriate portfolio for you we will advise taking on appropriate risk considering your whole wealth.

Why We Consider Smoothing

While your Risk Tolerance is used to drive the long-term risk of your portfolio, some individuals focus on short-term fluctuations in markets more than is advisable. As a result they may take on too little risk in the long run, or may increase risk taking at the top of the market and pull out at the bottom—all of these result in poor returns. To help you maintain a steady investment path we may recommend an investment strategy which can produce smoother month-to-month returns. However this adjustment comes at some cost to the long-term return and should only be used when necessary.

Reasons to Adjust Your Risk Profile

The appropriate risk profile of your Investment Portfolio may differ from your Risk Tolerance for a variety of reasons. A significant percentage of your wealth in your low-risk Personal Holdings may increase the risk profile we recommend to achieve appropriate growth. A significant percentage of your wealth in your Opportunistic Investments may decrease the risk profile we recommend to achieve an appropriate level of risk. In addition, if you have loans we may suggest decreasing the risk in your Investment Portfolio.

Your investment representative will provide you with a detailed proposition of the appropriate asset allocation and prospective specific investments for you to consider.

Step 3 Results: Fine-Tuning Your Investment Portfolio Characteristics

Liquidity—Your high Composure implies you have no emotional reason for having greater portfolio liquidity. You might consider investing some portion of your portfolio in illiquid assets as these can sometimes offer greater returns.

Smoothing—Some smoothing of the investment journey can be achieved through product selection. Your high Composure suggests that you would not benefit from using products that offer smoothing to your investment journey.

Downside Protection—Your Market Engagement implies you are comfortable with products or managers who do not limit the maximum potential downside possible.

Active Management—Your Belief in Skill indicates you see significant benefit in using managers who may consistently deliver above-benchmark performance. You are comfortable with implementing your portfolio using active managers.

Step 4 Results: Customized Investment Implementation

Phased Investment—Your Market Engagement will influence the speed with which you will be comfortable implementing your optimal portfolio. Your high Market Engagement indicates you are not unduly concerned about market timing, and you would not gain additional comfort from gradually entering the market over time.

Comfort—Your high Perceived Financial Expertise indicates you are generally comfortable examining more complicated products or technical investment strategies. We will work with you to help you feel comfortable with any investment decisions.

Involvement—Your high Delegation indicates that you prefer a less hands-on portfolio management approach. You will prefer to be less involved and informed about the ongoing investment decisions relating to your portfolio.

Tactical Updating—Your high Belief in Skill indicates you may prefer to make continual adjustments to your portfolio to match the latest research calls and market opinions, perhaps focusing on research ideas in areas you have greater knowledge. However, you should ensure you periodically rebalance your portfolio so it remains appropriate to your requirements.

Your Report Summary: Client X

Investment Portfolio—Choosing Your Investment Strategy

Your portfolio's investment strategy should aim to achieve the following:

Investment Portfolio—Fine-Tuning Your Portfolio Characteristics

Your portfolio should also aim to achieve the following characteristics:

Relationship—Customized Investment Implementation

Your portfolio should also aim to achieve the following characteristics:

Note: Please ensure that your portfolio is updated or redefined when your investment objectives or personal circumstances change.

[Exemplary] Risk Profile Definitions

Low (Profile 1):

You are uncomfortable with investments which may put you at risk of losing money and spending power, and will accept a lower return over the long-term in exchange for minimizing the chance of negative outcomes. This does not mean you wish to stay away from market investments altogether or to hold your wealth solely in cash deposits. You may be happy to participate in the financial markets (see your score on the market engagement scale) but you have a strong preference for these investments to be carefully controlled with fairly certain future outcomes. You evaluate investments largely by how safe your money is and by the predictability of future returns. In particular you are keen to avoid any possibility of significant losses to the spending power of your capital and are comfortable this means your long-term level of return is unlikely to be very much higher than that offered by a bank savings account. But with rates of return this low there is a possibility that your wealth may not maintain its spending power due to inflation.

MediumLow (Profile 2):

You are likely to be comfortable with making investments which may have limited potential for losses in exchange for higher returns. You want better returns than those offered by a bank or building society savings account and are prepared to put a part of your money in market investments to achieve this. While the possibility of small fluctuations in your wealth does not bother you, you are averse to investments with a possibility of falling substantially in value by the end of your intended investment period. You would be happier with a steadier but lower rate of growth than a higher but more volatile one. You accept this limits the potential for your money to grow, and there is a possibility your wealth may not maintain its spending power.

Moderate (Profile 3):

You are comfortable with investments which may lead to some fluctuations in the value of your portfolio in exchange for the opportunity to achieve above average increases in your wealth in the medium to long run. You want the real value of your investments to increase, or your income to maintain its spending power over time. You are happy to put some of your money into market investments with the aim of getting a better return, and accept you could make a loss on the money you invest.

MediumHigh (Profile 4):

You are prepared to accept regular fluctuations in the value of your portfolio and are willing to take on higher risk than other people in exchange for the opportunity to increase your wealth in the long run. You are aware that to achieve higher returns you will need to put a significant part of your portfolio in market investments. Your money could be subject to significant short-term fluctuations in value, and the potential for long-term gain and loss are both greater.

High (Profile 5):

You are comfortable with significant short-term fluctuations in the value of your investments in exchange for superior returns over the long-term. You recognize your investments will be linked to various markets, possibly with some exposure to high risk/high returns markets (e.g., emerging economies). There is a possibility you may not get back as much money as you put in, but also a possibility that your wealth will increase substantially. This is a trade-off you accept and welcome.

[Exemplary] Glossary

Active Management:

An investment fund is said to be actively managed when the securities within the fund are selected using specific investment criteria or investment research. The aim of most actively managed funds is to beat a specified market index or benchmark, such as the S&P 500.

Alternative Trading Strategies:

These are investment approaches which aim to produce returns that are not dependent on broader directional moves in financial markets.

Asset Allocation:

The process of spreading investments across a range of different asset classes in order to increase portfolio returns while reducing risk.

Asset Classes:

The main asset classes are equities, bonds and cash. Other asset classes include hedge funds, commodities, real estate and private equity.

Commodities:

A physical substance—such as grain, oil or metal—which is interchangeable with a product of the same type. In investment markets, gold and oil are perhaps the most familiar commodities.

Index Tracking Products:

An investment that aims to replicate the performance of a particular stock market index, such as the FTSE 100.

Liquid:

An asset is said to be liquid if it is easily converted into cash.

Opportunistic Investments:

These are short-term investments where you have identified a particular opportunity within a specific asset class. Opportunistic Investments are typically those where you have a very high degree of conviction due to specialized knowledge of that investment, e.g. an equity investment in your own business.

Optimal Portfolio/Portfolio Optimization:

An optimal portfolio is one that makes the best use of its available risk budget—in essence, providing the best possible return for a given level of risk (or minimizing risk for a given level of return). The process of creating such portfolios is known as portfolio optimization. In the past, investment managers have built optimized portfolios on the assumption that investors are as indifferent to losses as they are to gains. Unfortunately, most investors feel losses much more keenly than they do gains. Our portfolios aim to provide the best possible expected returns, subject to the amount of psychological risk that you are happy to accept.

Passive Management:

An investment approach that focuses on mirroring the composition of a given market or sector in order to match its risk and return characteristics.

Real Estate:

Real estate can refer to commercial property (e.g. offices, shopping centers) and/or residential property (private dwellings).

Speculative Real Estate:

These are investments in commercial and/or residential real estate where you are not planning to hold the investment for the long term; rather you have identified a specific valuation opportunity and expect it to be realized over a certain time horizon.

Standard Investments:

Equities, bonds and cash. Sometimes called “traditional investments.”

Structured Note:

An investment product designed to produce a known pay-off as long as pre-specified criteria are met.

Tactical Asset Allocation:

Our asset allocation process starts by using a model to deliver an optimum strategic (i.e. long-term) division of investments between asset classes (known as the strategic asset allocation). We then have a formalized discussion process, within Barclays Wealth and elsewhere in Barclays Group, to decide what tactical (i.e. short-term) “tilts” should be applied to this strategic view to maximize returns over the next three months. These “tilts” are known as the tactical asset allocation.

1. A computer system comprising:
one or more servers that:
(a) provide a financial personality assessment questionnaire to a user; and
(b) receive data describing said user's responses to one or more questions in said questionnaire; and
one or more processors in communication with said one or more servers that:
(a) based on said data describing said user's responses, assess said user's investment-related attitudes across a plurality of scales and produce a multi-dimensional financial personality identifier for said user; and
(b) construct a user risk profile for said user derived from said multi-dimensional financial personality identifier.

2. A system as in claim 1, wherein constructing said user risk profile comprises mapping said user to one of a plurality of profiles.

3. A system as in claim 1, wherein said one or more processors further adjust said user risk profile, based on said user's current financial circumstances.

4. A system as in claim 3, wherein said adjusting further comprises analyzing factors comprising one or more of: income, expenditures, externally held wealth, or liabilities.

5. A system as in claim 1, wherein said one or more processors adjust a portfolio risk profile for an investment portfolio of said user, based on said user risk profile.

6. A system as in claim 1, wherein said one or more processors generate a financial personality assessment report based on said user risk profile.

7. A system as in claim 6, wherein said financial personality assessment report comprises one or more single dimension texts and one or more interaction texts.

8. A system as in claim 7, wherein said financial personality assessment report further comprises one or more distinguishing features texts, said one or more distinguishing features texts based on all dimension scores.

9. A system as in claim 1, wherein said plurality of scales comprises risk tolerance and one or more of: composure, market engagement, perceived financial expertise, delegation, or belief in skill.

10. A system as in claim 1, wherein each scale in said plurality of scales is associated with a corresponding subset of said questions.

11. A system comprising:
one or more servers that receive and store data describing responses to a plurality of questionnaire questions related to risk tolerance; and
one or more processors that:
(a) identify, in said data, one or more personality dimensions related to financial personality, said one or more personality dimensions comprising a risk tolerance dimension;
(b) identify a first subset of said plurality of questionnaire questions related to risk tolerance as being associated with said risk tolerance dimension;
(c) identify a second subset of said plurality of questionnaire questions, which is a subset of said first subset, and which has a similar predictive power as said first subset; and
(d) construct, with said processing system, a questionnaire comprising said second subset of said plurality of questionnaire questions.

12. A system as in claim 11, wherein:
said one or more servers:
provide said questionnaire to a user; and
receive data describing said user's responses to one or more questions in said questionnaire; and
said one or more processors:
based on said data describing said user's responses, assess said user's investment-related attitudes across a plurality of scales and produce a multi-dimensional financial personality identifier for said user; and
construct a user risk profile for said user derived from said multi-dimensional financial personality identifier.

13. A system comprising:
one or more servers that:
receive data describing a user risk profile for a user, said user risk profile derived from a multi-dimensional financial personality identifier; and
receive data describing financial circumstances and investment objectives of said user; and
one or more processors that:
calculate a portfolio risk profile for a current investment portfolio of said user;
calculate a recommended risk profile for said portfolio, based at least in part on said financial circumstances and investment objectives and on said user risk profile derived from said multidimensional financial personality identifier; and
construct a portfolio allocation recommendation based on said recommended risk profile for said portfolio.

14. An article of manufacture storing software in a non-transitory computer readable medium, said software configured to direct one or more processors to perform at least the following steps:
providing a financial personality assessment questionnaire to a user;
receiving data describing said user's responses to one or more questions in said questionnaire;
based on said data describing said user's responses, assessing with a processing system said user's investment-related attitudes across a plurality of scales and producing a multi-dimensional financial personality identifier for said user; and
constructing, with said processing system, a user risk profile for said user derived from said multi-dimensional financial personality identifier;
wherein said processing system comprises one or more processors.

15. An article of manufacture as in claim 14, wherein constructing said user risk profile comprises mapping said user to one of a plurality of profiles.

16. An article of manufacture as in claim 14, further comprising software for adjusting said user risk profile, based on said user's current financial circumstances.

17. An article of manufacture as in claim 16, wherein said step of adjusting further comprises analyzing factors comprising one or more of: income, expenditures, externally held wealth, or liabilities.

18. An article of manufacture as in claim 14, further comprising software for adjusting a portfolio risk profile for an investment portfolio of said user, based on said user risk profile.

19. An article of manufacture as in claim 14, further comprising software for generating, with said processing system, a financial personality assessment report based on said user risk profile.

20. An article of manufacture as in claim 19, wherein said financial personality assessment report comprises one or more single dimension texts and one or more interaction texts.

21. An article of manufacture as in claim 20, wherein said financial personality assessment report further comprises one or more distinguishing features texts, said one or more distinguishing features texts based on all dimension scores.

22. An article of manufacture as in claim 14, wherein said plurality of scales comprises risk tolerance and one or more of: composure, market engagement, perceived financial expertise, delegation, or belief in skill.

23. An article of manufacture as in claim 14, wherein each scale in said plurality of scales is associated with a corresponding subset of said questions.

24. An article of manufacture storing software in a non-transitory computer readable medium, said software configured to direct one or more processors to perform at least the following steps:
receiving and storing data describing responses to a plurality of questionnaire questions related to risk tolerance;
identifying, with a processing system, in said data, one or more personality dimensions related to financial personality, said one or more personality dimensions comprising a risk tolerance dimension;
identifying a first subset of said plurality of questionnaire questions related to risk tolerance as being associated with said risk tolerance dimension;
identifying a second subset of said plurality of questionnaire questions, which is a subset of said first subset, and which has a similar predictive power as said first subset; and
constructing, with said processing system, a questionnaire comprising said second subset of said plurality of questionnaire questions.

25. An article of manufacture as in claim 11, further comprising software for:
providing said questionnaire to a user;
receiving data describing said user's responses to one or more questions in said questionnaire;
based on said data describing said user's responses, assessing with a processing system said user's investment-related attitudes across a plurality of scales and producing a multi-dimensional financial personality identifier for said user; and
constructing, with said processing system, a user risk profile for said user derived from said multi-dimensional financial personality identifier.

26. An article of manufacture storing software in a non-transitory computer readable medium, said software configured to direct one or more processors to perform at least the following steps:
receiving data describing a user risk profile for a user, said user risk profile derived from a multi-dimensional financial personality identifier;
receiving data describing financial circumstances and investment objectives of said user;
calculating with a processing system a portfolio risk profile for a current investment portfolio of said user;
calculating with said processing system a recommended risk profile for said portfolio, based at least in part on said financial circumstances and investment objectives and on said user risk profile derived from said multidimensional financial personality identifier; and
constructing a portfolio allocation recommendation based on said recommended risk profile for said portfolio.

27. A method comprising:
providing a financial personality assessment questionnaire to a user;
receiving data describing said user's responses to one or more questions in said questionnaire;
based on said data describing said user's responses, assessing with a processing system said user's investment-related attitudes across a plurality of scales and producing a multi-dimensional financial personality identifier for said user; and
constructing, with said processing system, a user risk profile for said user derived from said multi-dimensional financial personality identifier;
wherein said processing system comprises one or more processors.

28. A method as in claim 27, wherein constructing said user risk profile comprises mapping said user to one of a plurality of profiles.

29. A method as in claim 27, further comprising adjusting said user risk profile, based on said user's current financial circumstances.

30. A method as in claim 29, wherein said step of adjusting further comprises analyzing factors comprising one or more of: income, expenditures, externally held wealth, or liabilities.

31. A method as in claim 27, further comprising adjusting a portfolio risk profile for an investment portfolio of said user, based on said user risk profile.

32. A method as in claim 27, further comprising generating, with said processing system, a financial personality assessment report based on said user risk profile.

33. A method as in claim 32, wherein said financial personality assessment report comprises one or more single dimension texts and one or more interaction texts.

34. A method as in claim 33, wherein said financial personality assessment report further comprises one or more distinguishing features texts, said one or more distinguishing features texts based on all dimension scores.

35. A method as in claim 27, wherein said plurality of scales comprises risk tolerance and one or more of: composure, market engagement, perceived financial expertise, delegation, or belief in skill.

36. A method as in claim 27, wherein each scale in said plurality of scales is associated with a corresponding subset of said questions.

37. A method comprising:
receiving and storing data describing responses to a plurality of questionnaire questions related to risk tolerance;
identifying, with a processing system, in said data, one or more personality dimensions related to financial personality, said one or more personality dimensions comprising a risk tolerance dimension;
identifying a first subset of said plurality of questionnaire questions related to risk tolerance as being associated with said risk tolerance dimension;
identifying a second subset of said plurality of questionnaire questions, which is a subset of said first subset, and which has a similar predictive power as said first subset; and
constructing, with said processing system, a questionnaire comprising said second subset of said plurality of questionnaire questions;
wherein said processing system comprises one or more processors.

38. A method as in claim 37, further comprising:
providing said questionnaire to a user;
receiving data describing said user's responses to one or more questions in said questionnaire;
based on said data describing said user's responses, assessing with a processing system said user's investment-related attitudes across a plurality of scales and producing a multi-dimensional financial personality identifier for said user; and
constructing, with said processing system, a user risk profile for said user derived from said multi-dimensional financial personality identifier.

39. A method comprising:
receiving data describing a user risk profile for a user, said user risk profile derived from a multi-dimensional financial personality identifier;
receiving data describing financial circumstances and investment objectives of said user;
calculating with a processing system a portfolio risk profile for a current investment portfolio of said user;
calculating with said processing system a recommended risk profile for said portfolio, based at least in part on said financial circumstances and investment objectives and on said user risk profile derived from said multidimensional financial personality identifier; and
constructing a portfolio allocation recommendation based on said recommended risk profile for said portfolio;
wherein said processing system comprises one or more processors.
